(19) United States
(12) Patent Application Publication
(10) Pub. No.: US 2023/0126385 A1
(43) Pub. Date: Apr. 27, 2023

(54) Non-programming user interface for computing and graphing input math expressions

(71) Applicant: Deping Li, Pennington, NJ (US)

(72) Inventor: Deping Li, Pennington, NJ (US)

(21) Appl. No.: 17/479,215

(22) Filed: Sep. 20, 2021

(51) Int. Cl. G06T 11/20; G06F 17/11

(52) U.S. Cl. CPC G06T 11/206; G06F 17/11

(57) ABSTRACT

A non-programming user interface consisting of modules (functions) provides a tool for computing and graphing math expressions. By taking user input at interface, each module can be applied separately or along with other non-graphing modules and math functions for calculations from simple to complicated math operations (e.g., differentiation, integration, or their composition), depending on needs and appropriateness of function combination and composition. For an intended operation, users only needs to write a short line of self-explaining input at interface, which include three-character module names, and some necessary math elements such as expressions of functions or equations, variables, choices of values, and optional two-character keywords and related values. This interface enables users to have functionalities in common computer algebra systems, and meanwhile can focus on essential math elements and concepts instead of programming commands and syntax.

### BACKGROUND OF THE INVENTION

User interfaces for symbolic math computing and graphing are established by various computer algebra systems (CAS) that usually require distinct operating systems and programming environments. A few examples of these systems are Sympy, SageMath, Symengine, GiNac, Symbolic C++, Mathematica, Maple, Maxima, and MatLab.

Applying these systems for symbolic computation, users should have some basic programming skills or knowledge of computer languages or some program commands. Users of Sympy, SageMath, and Symengine need to write Python commands in a programming environment like Jupyter. GiNac and Symbolic C++ require users to use their libraries within C++. Some general purpose packages like Mathematica, Maple, Maxima, and MatLab have their own syntax and commands. To graph math functions and equations by a standalone package like Matplotlab or Plotly also requires knowledge to manipulating expressions and data in Python and Numpy.

Some other symbolic algebra systems have a limited number of buttons at interface. These buttons are exclusively used for certain math functions and symbols (e.g., ∞, sin x, π), as well as some particular math operators (e.g., ∫ for integrals). LiveMath and Symbolab are two examples of these systems. Although programming commands are not required, users have to insert functions, symbols and operators displayed on the buttons in a strict format. In addition, function combination and composition are usually not allowed in these systems, which greatly restrict users from combining and composing two or more complex operations and verifying some important mathematical properties and features among these operations.

This invention of symbolic math computing and graphing interface does not require users to have any prior skill or knowledge of computer languages like Python and C++, nor does it require programming environment. Formulating valid math expressions within a module of a three-character name and some other necessary elements suffices for all associated operations. With this interface, users just need to enter a short line of input for interested operations, which also include graphing functions and equations in 3D space, as they write expressions and formulas in standard math texts.

### BRIEF SUMMARY OF THE INVENTION

A non-programming user interface consisting of modules (functions) provides a tool for computing and graphing math expressions. By taking user input at interface, each module can be applied separately or along with other non-graphing modules and math functions for calculations from simple to complicated math operations (e.g., differentiation, integration, or their composition), depending on needs and appropriateness of function combination and composition. For intended operations, users only needs to write a short line of self-explaining input at interface, which include three-character module names, and some necessary math elements such as expressions of functions or equations, variables, choices of values, and optional two-character keywords and related values. This interface enables users to have functionalities in common computer algebra systems, and meanwhile can focus on essential math elements and concepts instead of programming commands and syntax.

### BRIEF DESCRIPTION OF THE DRAWINGS

All graphs from FIG. 1 to FIG. 6 are generated by the operations described in section “(8) Graphs of functions and equations” of “Detailed description of the invention”.

FIG. 1 displays some example graphs for points, lines, polygons, and function curves by “pin” and “plt” operations. There are in all 14 graphs in FIG. 1. The input expression for generating each graph is listed on its top left corner.

FIG. 2 displays some example graphs of curves for implicit and parametric equations by “pc2”, “imf” and “cnt” operations. There are in all 38 graphs in FIG. 2. The input expression for generating each graph is listed at its top left corner.

FIG. 3 shows some example graphs of polar functions by the “poi” operation. There are total 14 polar graphs in FIG. 3. The input expression for each graph is listed at its top left corner.

FIG. 4 displays some example graphs of vectors and vector fields by “vc2” and “vf2” operations. There are total 12 graphs in FIG. 4. The input expression for generating each graph is listed at its top left corner.

FIG. 5 displays some example graphs of 3D parametric equations for space curves by the “pc3” operation. There are total 6 graphs in FIG. 5. The input expression for generating each graph is listed at its top left corner.

FIG. 6 shows some example graphs of functions and 3D parametric equations for space surfaces by “ps3” and “sf3” operations. There are in all 12 graphs in FIG. 6. The input expression for generating each graph is listed at its top left corner.

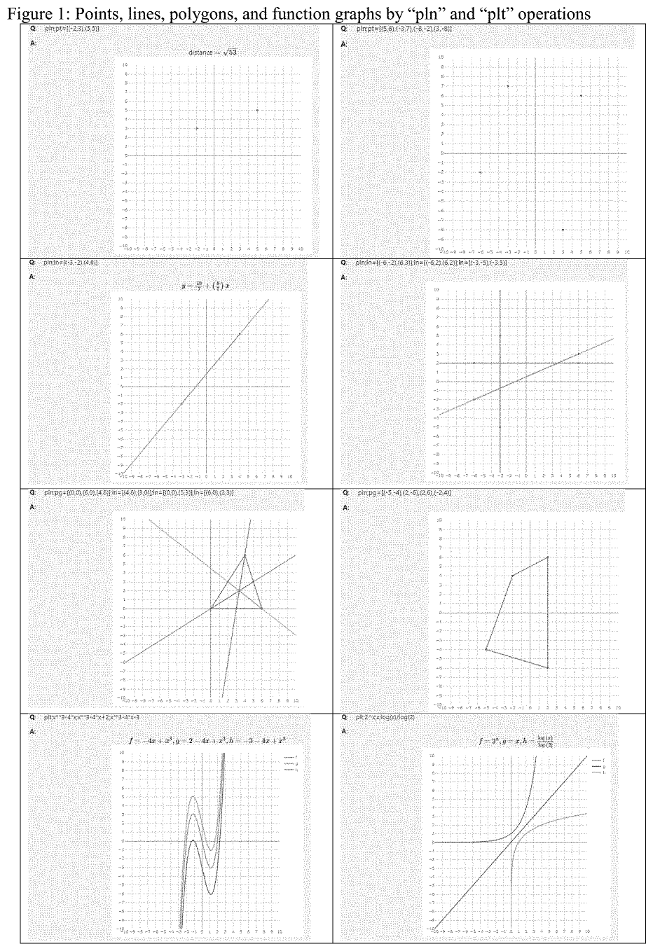

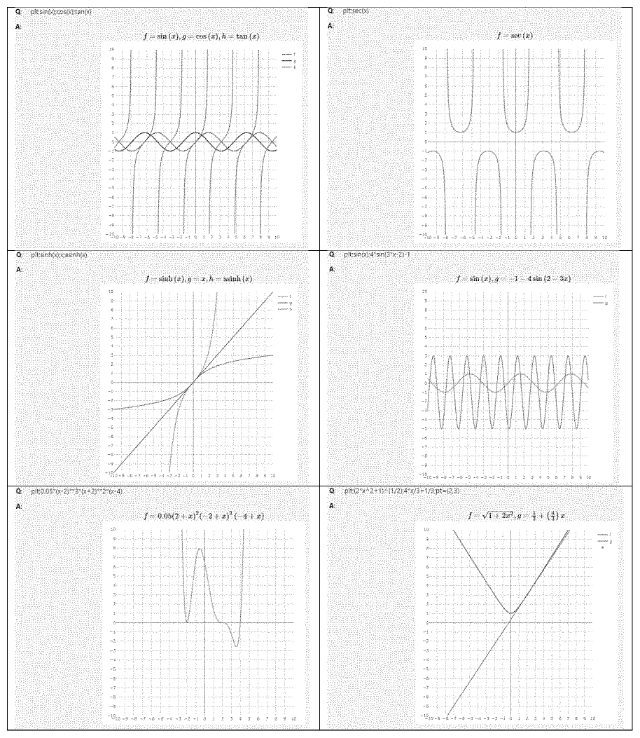

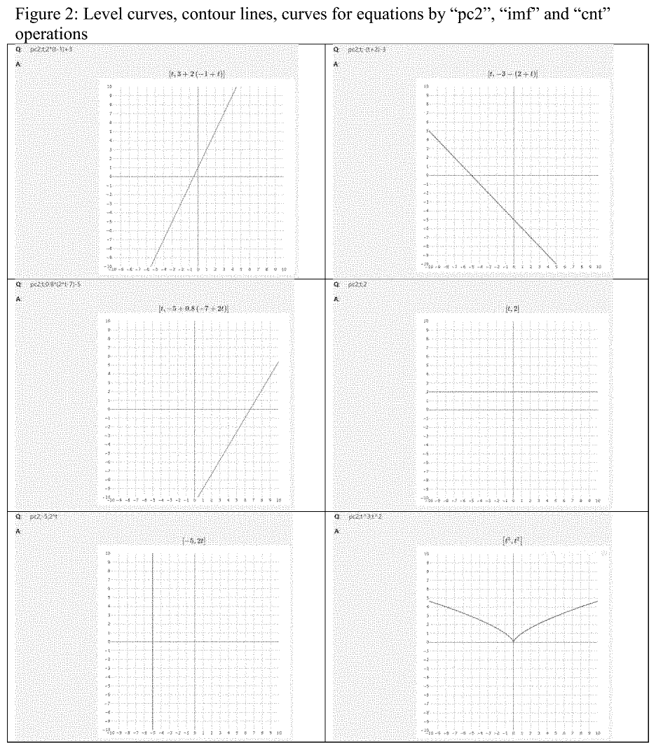

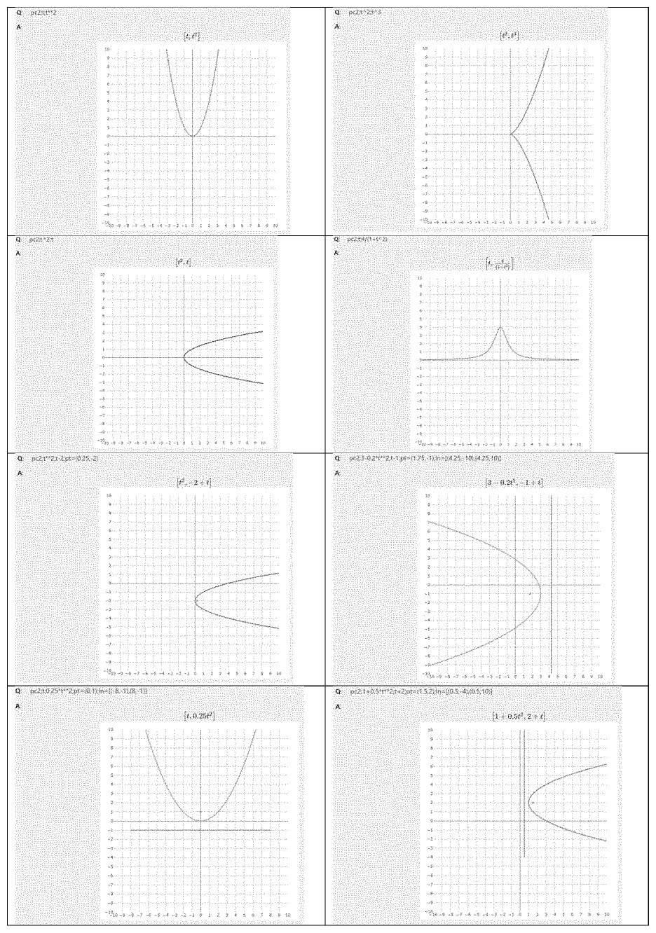

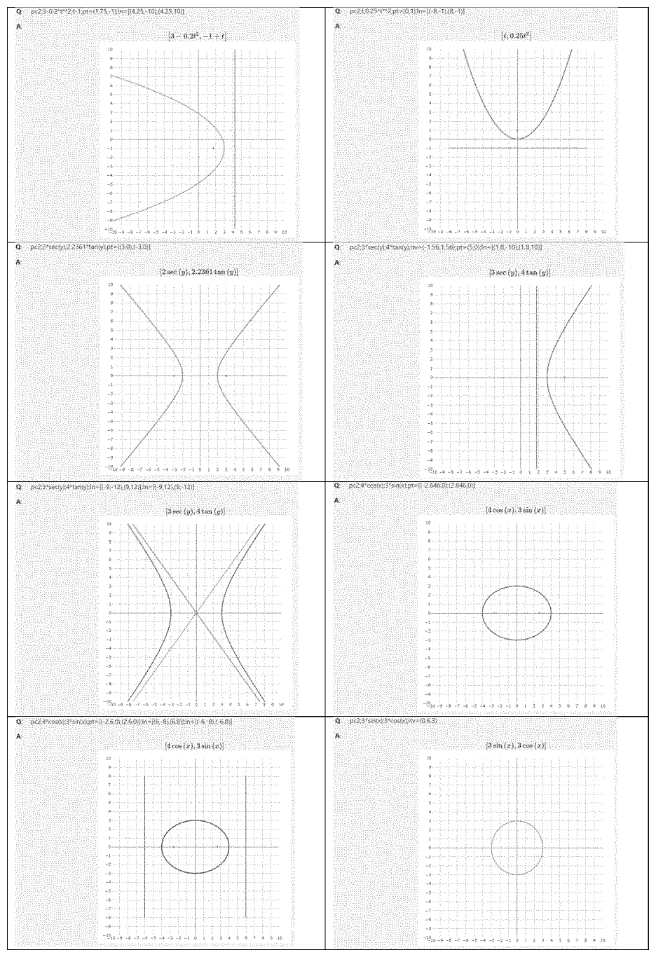

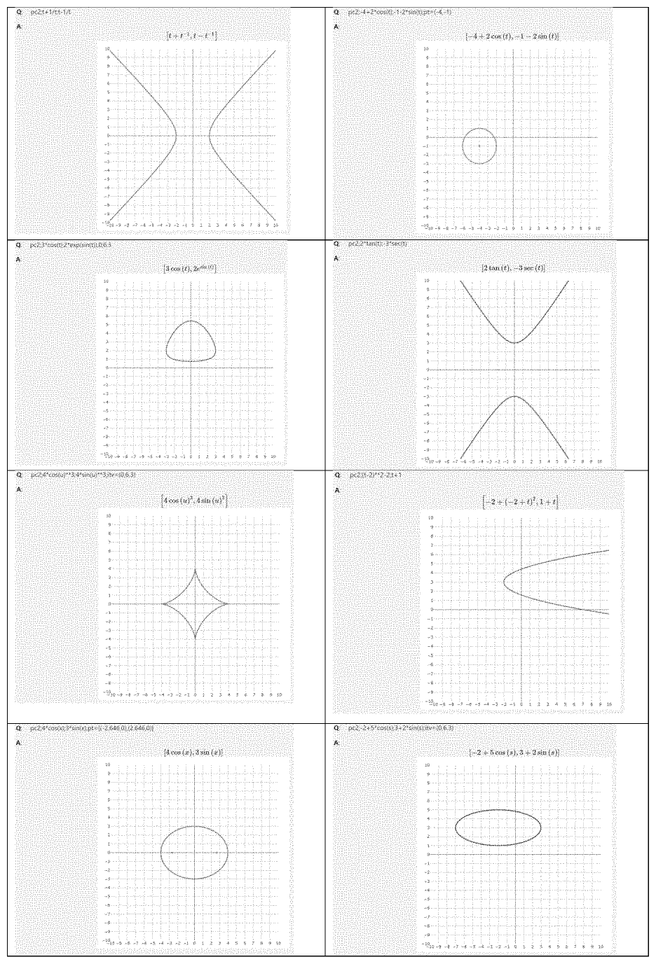

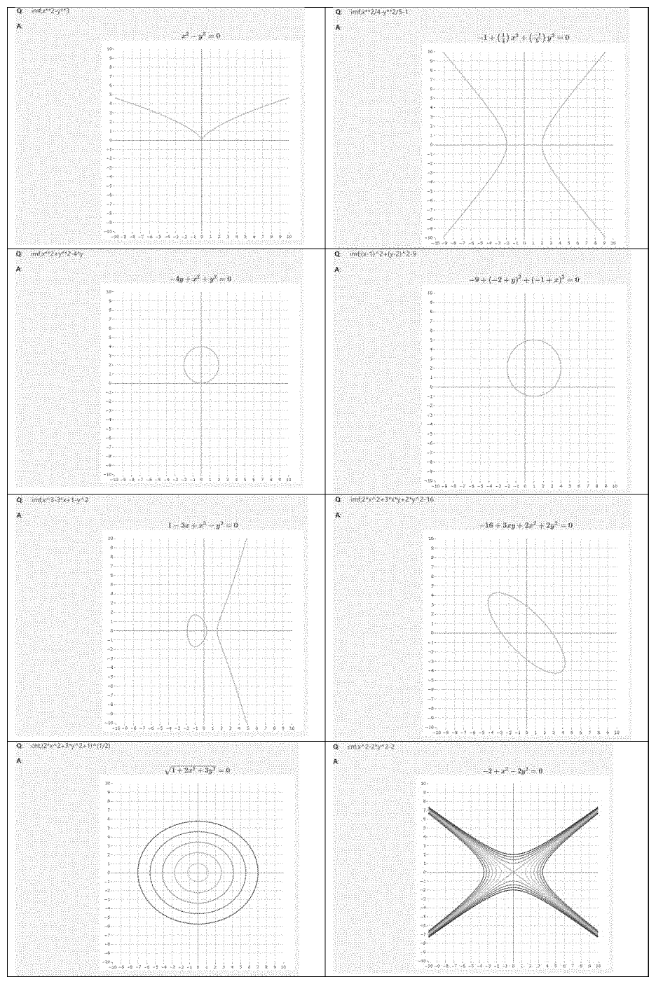

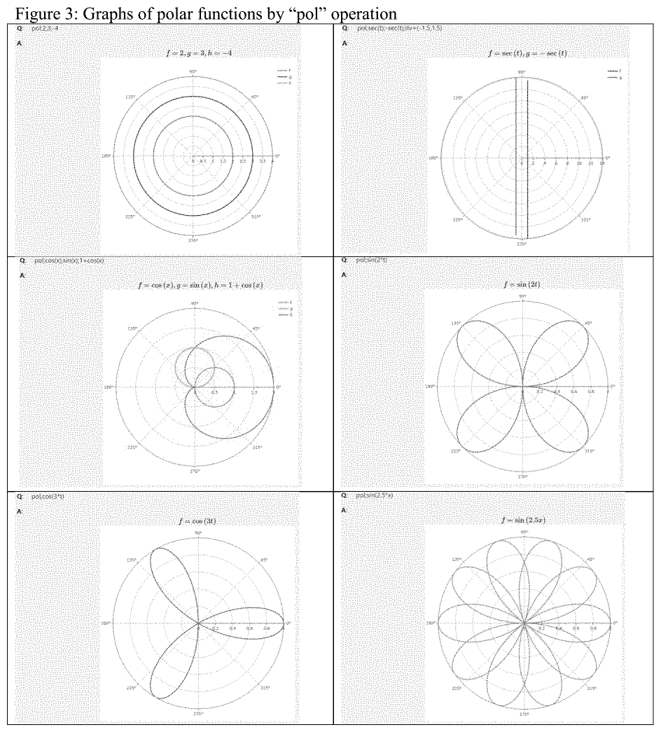

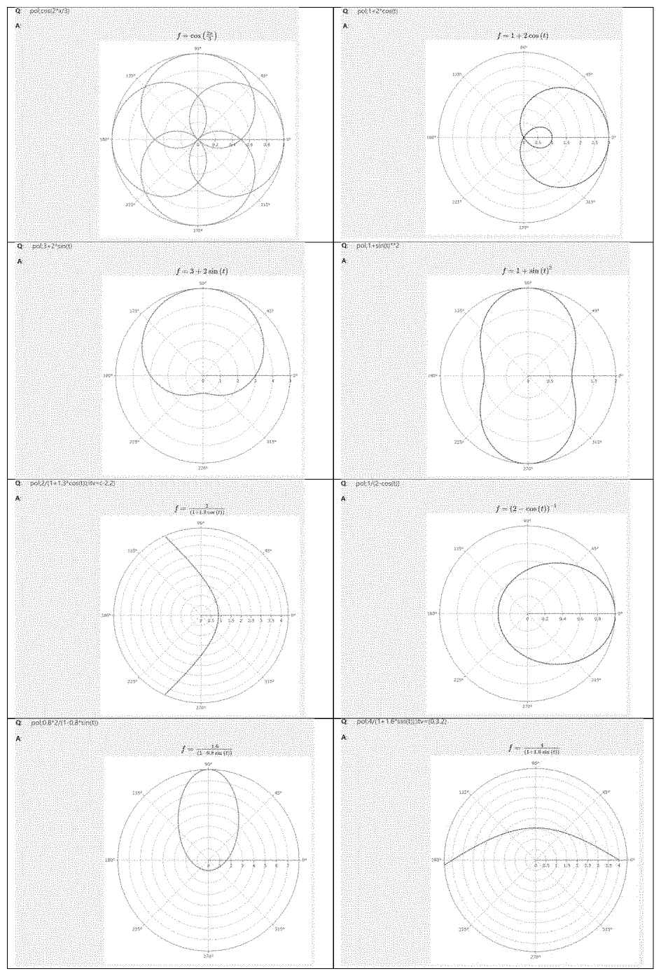

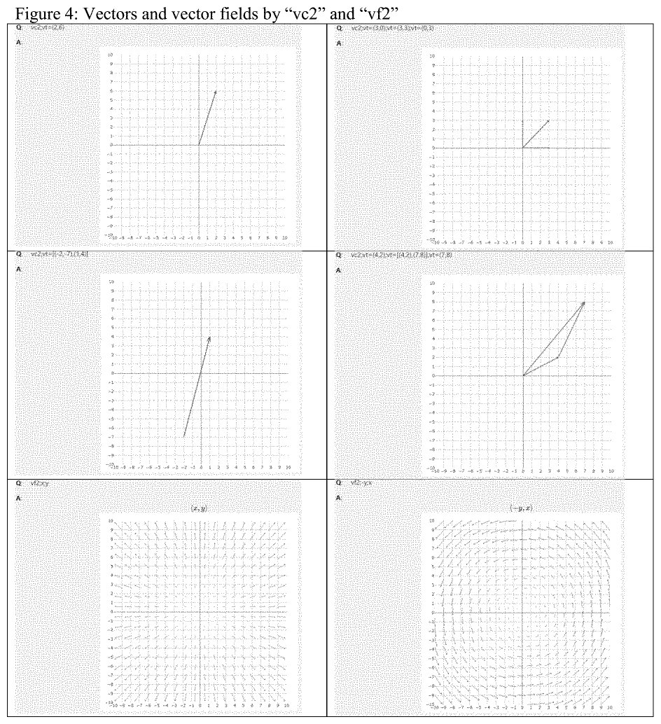

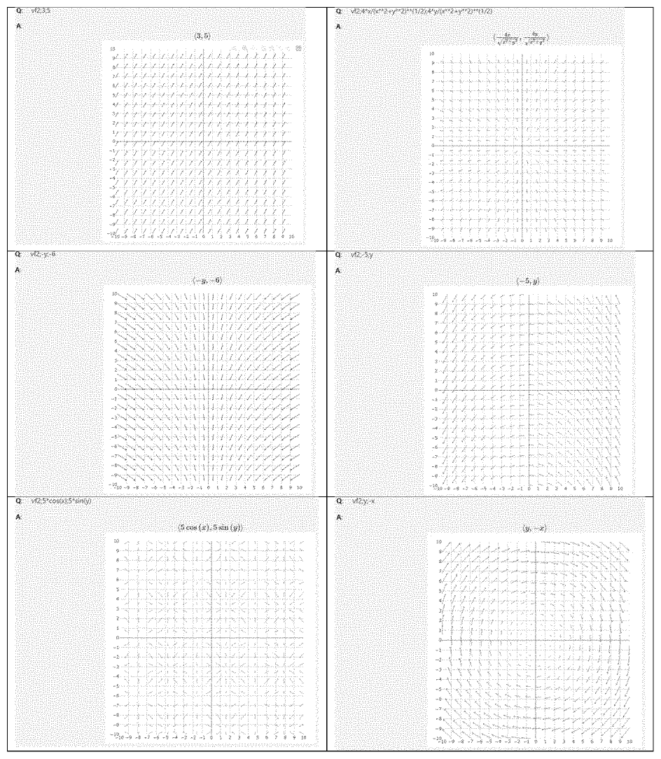

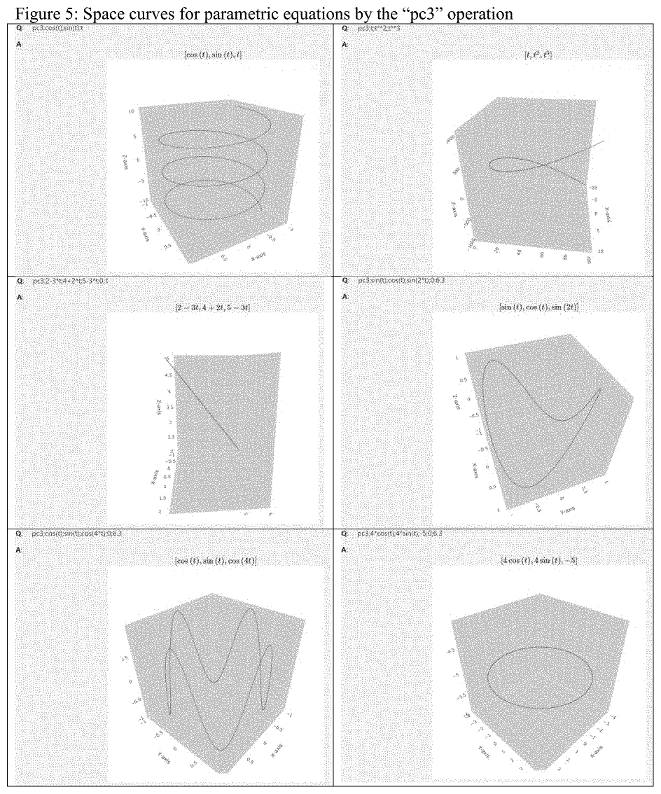

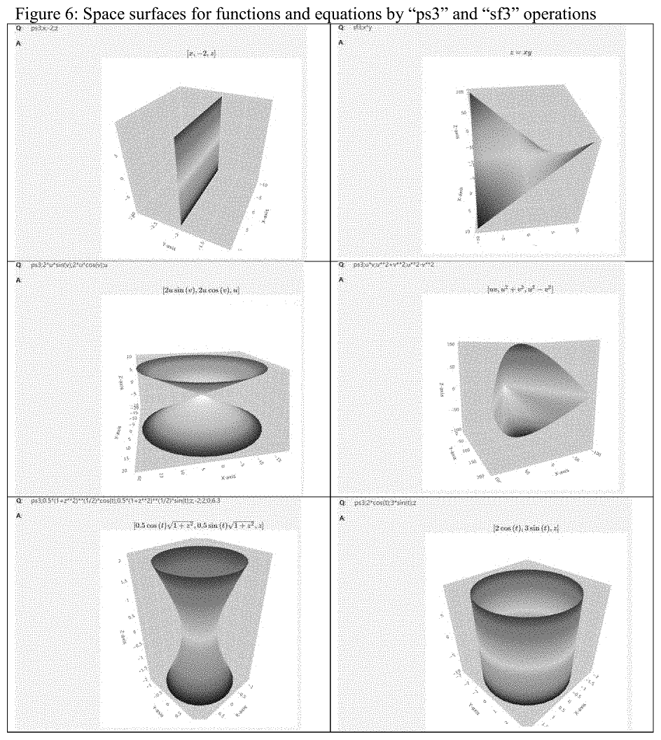

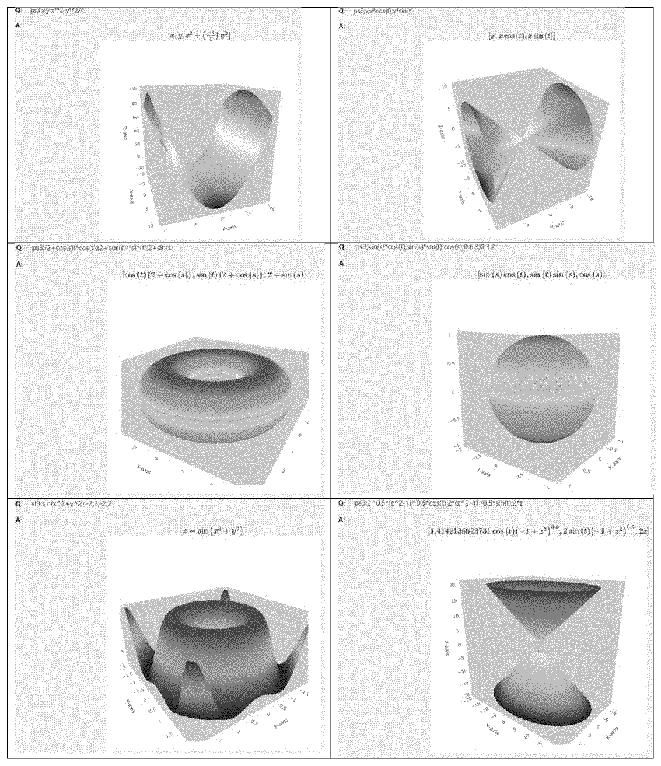

### DETAILED DESCRIPTION OF THE INVENTION

A non-programming user interface consisting of modules (functions) is created for computing and graphing input math expressions. Each module, which is indicated by three characters and appears to be typical math functions (e.g., “sin”, “log”, “exp”), can carry out a class of distinct math operations such as differentiation and integration. The nuances of the same class operations can be discerned by adding some options via two-character keywords and related values to individual modules.

Each module can be applied separately for its associated class of operations. Non-graphing modules can also combine and compose with other modules and math functions (algebraic and transcendental) to form more operations.

Combining and composing with other modules and math functions, if appropriate, enables users to write more flexible math expressions at interface, and thus accomplish more complicated math operations in a single line of input.

Applying a module for particular math operations is just as users calling a standard math function, but it involves more parameters or arguments necessary for its associated operations. For example, “sin(x\hat{ }2)” is an expression for calling sine function, but the expression for finding its limit as x approaches 0 needs to be in the form “lim(sin(x\hat{ }2), x, 0)” or “lim; sin(x\hat{ }2); x; 0”, which will return the same result 0 from the “lim” module.

In general, user inputs for module associated class of math operations require module names (three characters) and other necessary elements such as expressions of functions and equations, variables, choices of values, and optional keywords (two characters) and related values for nuances of the class functionalities. Thus, a short line of user input at interface consists of multiple elements representing names of modules, functions, variables, and keywords; choices of values; expressions for functions and equations. Non-graphing modules would return a result of an expression, number, vector, or error message; graphing modules return associated type of graph or error message.

Graphing modules are designed not to combine and compose with other modules and functions. All non-graphing modules have two different formats of applying them at interface. The two formats produce same results. One displays results along with other helpful texts; the other only displays results.

Next is an overview of the specifications, followed by detailed descriptions of how these modules and class of operations work for solving particular math problems using short lines of user inputs.

(1) Equations, inequalities and systems of equations
I. Equations and inequalities
II. Systems of equations
III. Simplify, expand, factor, and compare expressions

(2) Limits
I. Limits (one-sided, finite and infinite limits, and limits at infinity)
II. Properties and formal definition of limit
III. Derivative formulas by limits
IV. Improper integrals by limits

(3) Differentiation
I. Derivatives of single-variable functions
   1) Derivative functions
   2) Slopes, rates of change, equations of tangent lines
   3) Differentials and linearization
   4) Monotonicity, concavity, and extreme value problems
   5) Expressions for differential equations
II. Implicit differentiation
III. Derivatives for functions of several variables
   1) Partial derivatives
   2) Gradient and critical points
   3) Directional derivatives
   4) Chain rule for composite of scalar and vector functions
   5) Second derivative test, Hessian determinant and local extreme values
   6) Lagrange multipliers and optimization subject to constraints

(4) Integration
I. Antiderivatives and definite integrals
II. Numerical integration
III. Area functions or functions defined by integrals
IV. Jacobian determinant
V. Line and surface integrals

(5) Infinite series
I. Finite and infinite sum
II. Taylor series expansion and approximation
III. Series integration and differentiation

(6) Vector algebra and vector-valued function calculus
I. Vector algebra
II. Vector projection and orthogonal decomposition
III. Vector-valued function calculus
   1) Tangent and normal vectors
   2) Curvature
   3) Normal vectors at points on parametric surfaces
   4) Curl, divergence, conservative and Laplacian fields
   5) Properties of curl, divergence and Laplace operators

(7) Differential equations
I. Ordinary differential equations
II. Partial differential equations
III. Systems of ordinary differential equations

(8) Graphs of functions and equations
I. Points, lines, polygons, and graphs of explicit functions
II. Plane curves for parametric and implicit equations
III. Graphs of polar functions
IV. Vectors and vector fields
V. Space curves for parametric equations
VI. Space surfaces for functions and parametric equations

(1) Equations, Inequalities, and System of Equations

I. Solve Equations and Inequalities

To solve an equation or inequality, one needs at least three elements: The name of the operation, the expression of the equation or inequality, and the variable to be solved. The “slv” module is created for solving equations and inequalities, and the expression “slv; f(x); x” or “slv(f(x), x)” helps solve the equation f(x)=0 for x. The expressions “slv; f(x) g(x); x”, “slv(f(x) g(x),x)”, “slv; f(x)>g(x); x”, and “slv; f(x)<g(x); x” find the intervals (or values) of x such that the corresponding inequality is satisfied.

In case an equation is expressed in form of f(x)=g(x), one can rewrite it as f(x)—g(x)=0, and enter “slv; f(x)−g(x); x” to determine its solution for x.

Options can be added to the “slv” operation at the end. For instance, to find the complex roots of an equation, add the keyword “C” for complex domain to the end, making the expression become “slv(f(x),x, C)” or “slv; f(x); x; C”. Some examples and results for the “slv” operation are given in Table 1.1.

TABLE 1.1
Solving equations and inequalities by “slv” operation

| Problems | Expressions | Results |
|---|---|---|
| $\frac{{x}^{4} - 16}{{x}^{2} + 2 x - 8 = 0}$ | slv; (x\hat{ }4 − 16)/(x\hat{ }2 + 2 * x − 8); x | $\begin{matrix}Q : slv ; ( x \hat{} 4 - 16 ) / ( x \hat{} 2 + 2 * x - 8 ) ; x \\ A : Solve \frac{{x}^{4} - 16}{{x}^{2} + 2 x - 8} = 0 for x = \{ - 2 \}\end{matrix}$ |
| x⁴ − x² + 1 = 0 | slv(x\hat{ }4 − x\hat{ }2 + 1, x, C) | $\begin{matrix}Q : slv ( x \hat{} 4 - x \hat{} 2 + 1 , x , C ) \\ A : = \{ - \frac{\sqrt{3}}{2} - \frac{i}{2} , - \frac{\sqrt{3}}{2} + \frac{i}{2} , \frac{\sqrt{3}}{2} - \frac{i}{2} , \frac{\sqrt{3}}{2} + \frac{i}{2} \}\end{matrix}$ |
| $\vert \frac{3 y}{2} + 4 \vert > 1$ | slv; abs(3 * y/2 + 4) > 1; y | $\begin{matrix}Q : slv ; abs ( 3 * y / 2 + 4 ) > 1 , y \\ A : Solve abs ( \frac{3 y}{2} + 4 ) > 1 for y = ( - ∞ , - \frac{10}{3} ) ⋃ ( - 2 , ∞ )\end{matrix}$ |
| \|a − 1\| < \|3a − 5\| | slv; abs(a − 1) < abs(3 * a − 5); a | $\begin{matrix}Q : slv ; abs ( a - 1 ) < abs ( 3 * a - 5 ) ; a \\ A : Solve abs ( 1 - a ) < abs ( 5 - 3 a ) for a = ( - ∞ , \frac{3}{2} ) ⋃ ( 2 , ∞ )\end{matrix}$ |
| $\frac{1}{z - 2} > \frac{4}{z + 3}$ | slv; 1/(z − 2) > 4/(z + 3); z | $\begin{matrix}Q : slv ; 1 / ( z - 2 ) > 4 / ( z + 3 ) ; z \\ A : Solve \frac{1}{z - 2} > \frac{4}{z + 3} for z = ( - ∞ , - 3 ) ⋃ ( 2 , \frac{11}{3} )\end{matrix}$ |
| \|2 − 3w\| ≤ 4 | slv; abs(2 − 3 * w) <= 4; w | $\begin{matrix}Q : slv ; abs ( 2 - 3 * w ) <= 4 , w \\ A : Solve abs ( 2 - 3 w ) \leq 4 for w = [ - \frac{2}{3} , 2 ]\end{matrix}$ |
| $\frac{1}{t} < \frac{2 t}{t - 5}$ | slv; 1/t < 2 * t/(t − 5); t | $\begin{matrix}Q : slv ; 1 / t < 2 * t / ( t - 5 ) ; t \\ A : Solve \frac{1}{t} < \frac{2 t}{t - 5} for t = ( - ∞ , 0 ) ⋃ ( 5 , ∞ )\end{matrix}$ |
| \|2 − 7u\| > 3u − 16 | slv; abs(2 − 7 * u) > 3 * u − 16; u | Q: slv; abs(2 − 7 * u) > 3 * u − 16; u |
| | | A: Solve 3u − 16 < abs (2 − 7u) for u = (−∞, ∞) |
| \|10 − 3m\| < 11m + 18 | slv; abs(10 − 3 * m) < 11 * m + 18; m | $\begin{matrix}Q : slv ; abs ( 10 - 3 * m ) < 11 * m + 18 ; m \\ A : Solve 11 m + 18 > abs ( 10 - 3 m ) for m = ( - \frac{4}{7} , ∞ )\end{matrix}$ |
| ax + b = 0 | slv; a * x + b; x | $\begin{matrix}Q : slv ; a * x + b ; x \\ A : Solve ax + b = 0 for x = ℝ ⋂ \{ - \frac{b}{a} \}\end{matrix}$ |
| ax² + bx + c = 0 | slv(a * x\hat{ }2 + b * x + c, x) | $\begin{matrix}Q : slv ( a * x \hat{} 2 + b * x + c , x ) \\ A : = ℝ ⋂ \{ - \frac{b}{2 a} - \frac{\sqrt{- 4 ax + {b}^{2}}}{2 a} , - \frac{b}{2 a} + \frac{\sqrt{- 4 ax + {b}^{2}}}{2 a} \}\end{matrix}$ |
| \|x² − 2\| = \|2x − 17\| | slv; abs(x\hat{ }2 − 3) − abs(2 * x − 17); x | Q: slv; abs(x\hat{ }2 − 3) − abs(2 * x − 17); x |
| | | A: Solve abs (3 − x²) − abs (17 − 2x) = 0 for x = {−1 + \sqrt{21}, −\sqrt{21} − 1} |
| \|x² − x − 6\| = x − 1 | slv; abs(x\hat{ }2 − x − 6) − (x − 1); x | Q: slv; abs(x\hat{ }2 − x − 6) − (x − 1); x |
| | | A: Solve −x + abs (−x² + x + 6) + 1 = 0 for x = {\sqrt{7}, 1 + \sqrt{6}} |
| 2 log b = 3 | slv; 2 * log(b) − 3; b | $\begin{matrix}Q : slv ; 2 * log ( b ) - 3 ; b \\ A : Solve 2 log ( b ) - 3 = 0 for b = \{ {e}^{\frac{3}{2}} \}\end{matrix}$ |
| e^{-2v} = 5 | slv; exp(−2 * v) − 5; v | $\begin{matrix}Q : slv ; exp ( - 2 * v ) - 5 ; v \\ A : Solve - 5 + {e}^{- 2 v} = 0 for v = \{ - \frac{log ( 5 )}{2} \}\end{matrix}$ |
| 2sin t + cos t = 1 | slv; 2 * sin(t) + cos(t) − 1; t | Q: slv; 2 * sin(t) + cos(t) − 1; t |
| | | A: Solve 2 sin (t) + cos (t) − 1 = 0 for t = {2nπ \| n ∈ Z} ∪ {2nπ − |
| | | atan (⅓) + π \| n ∈ Z} |
| 3 sin⁻¹ x = 2π | slv; 3 * asin(x) − 2 * pi; x | $\begin{matrix}Q : slv ; 3 * asin ( x ) - 2 * pi ; x \\ A : Solve 3 asin ( x ) - 2 π = 0 for x = \{ \frac{\sqrt{3}}{2} \}\end{matrix}$ |
| 2 cosh⁻¹ 2x = 3 | slv; 2 * acosh(2 * x) − 3; x | $\begin{matrix}Q : slv ; 2 * acosh ( 2 * x ) - 3 ; x \\ A : Solve 2 acosh ( 2 x ) - 3 = 0 for x = \{ \frac{cosh ( \frac{3}{2} )}{2} \}\end{matrix}$ |

II. Solve a System of Equations

The expression “les(f(x,y), g(x,y))” or “les; f(x,y); g(x,y)” helps solve a linear system of two equations f(x, y)=0 and g(x, y)=0 for variables x and y, and the solutions are displayed in alphabetical order.

By default, the operation “les” gives solutions to all variables in the system. One can specify particular variables to be solved at the end. In this case, the expression would become “les(f(x,y), g(x,y), x, y)” or “les; f(x,y); g(x,y); x; y”.

The expression “les; f(x,y,z); g(x;y;z); h(x;y;z); x; y; z” or “les(f(x,y,z), g(x;y;z), h(x;y;z), x, y, z)” is for solving a linear system of three equations, where variables x, y, and z are optional unless there are additional variables in the system. Following the same pattern, one can use “les” for solving a system of four or more equations. Further, replacing “les” with “nes”, one can solve a system of nonlinear equations. The following three examples describe how to use “les” and “nes” operations.

1. Solve the linear system x+y+z=u+1,2x+y+z=3u−1,3x−2y+2=u, and x−y+5z=2u+5 by “les;x+y+z−u−1;2*x+y−3*u+z+1;3*x−2*y−u+2;x−y+5*z−2*u−5”.

$$Q : les ; x + y + z - u - 1 ; {2}^{*} x + y - {3}^{*} u + z + 1 ; \\ {3}^{*} x - {2}^{*} y - u + 2 ; x - y + {5}^{*} z - {2}^{*} u - 5$$

$$A : Solve [ - u + x + y + z - 1 = 0 , \\ - 3 u + 2 x + y + z + 1 = 0 , - u + 3 x - 2 y + 2 = 0 , - 2 u + x - y + 5 z - 5 = 0 ] for ( u , x , y , z ) = ( 1 , 0 , \frac{1}{2} , \frac{3}{2} )$$

2. Solve the nonlinear system of equations x²−y₂=α and x²+y₂=31 by “nes;x\hat{ }2−y\hat{ }2−1;x\hat{ }2+y\hat{ }2−31;x;y”.

Q: nes;x\hat{ }2−y\hat{ }2−1;x\hat{ }2+y\hat{ }2−31;x;y

A: Solve [x²−y₂−1=0, x²+y₂−31=0] for (x,y)={(−4, −\sqrt{15}), (−4, \sqrt{15}), (4, −\sqrt{15}), (4, \sqrt{15})}

3. Solve the nonlinear system by u²−v²=6 and u²−3v²+4=0 by “nes;u\hat{ }2−v\hat{ }2−6;2*u\hat{ }2−3*v\hat{ }2+4”.

Q: nes;u\hat{ }2−v\hat{ }2−6;2*u\hat{ }2−3*v\hat{ }2+4

A: Solve [(u²−v²−6=0, 2u²−3v²+4=0] for (u, v)={(−\sqrt{22}, −4), (−\sqrt{22}, 4), (\sqrt{22}, −4), (\sqrt{22}, 4)}

III. Simplify, Expand, Factor, and Compare Expressions

To simplify an expression, one only needs to enter the expression; to expand an expression, type the expression and add keyword “ep” to the end; to factor an expression, enter the expression and add keyword “fc” to the end.

For complex numbers, type “I” for the imaginary unit, and use function “Abs( )” to calculate magnitude.

To evaluate if two expressions are equivalent, one can enter a line like “f(x)=g(x)” or “f(x)−g(x)=0”, where “f(x)” and “g(x)” can be either a variable or number expression. If the two expressions are equivalent, the result is “True”, and “False” otherwise.

Similarly, one can compare two numbers and determine if one is greater or less than the other by entering expressions like “x>y” or “x<y”.

Some examples and results are given in Table 1.2 for the above operations.

TABLE 1.2
Simplify, expand, factor, and compare expressions

| True or False | Expressions | Results |
|---|---|---|
| e^{π} > π^{e} | e\hat{ }pi > pi\hat{ }e | Q: e\hat{ }pi > pi\hat{ }e |
| | | A: True |
| Sin(0.1) < cos(0.1) | sin(0.1) < cos(0.1) | Q: sin(0.1) < cos(0.1) |
| | | A: True |
| $\frac{1}{3} \geq 0.33333$ | ⅓ >= 0.33333 | Q: ⅓ >= 0.33333 A: True |
| a(b − 3) = ab − 3a | a * (b − 3) = = a * b − 3 * a | Q: a * (b − 3) = = a * b − 3 * a |
| | | A: True |
| log_{0.6} 0.5 > log_{0.5} 0.6 | log(.6)/log(.5) > log(.5)/log(.6) | Q: log(.6)/log(.5) > log(.5)/log(.6) |
| | | A: False |
| (cos(t) + isin(t))⁹ = [symbol] | (cos(t) + l * sin(t))\hat{ }9 = = | Q: (cos(t) + l * sin(t))\hat{ }9 = = exp(9 * l * t) |
| | exp(9 * l * t) | A: True |
| e^{iπ} = −1 | exp(l * pi) = = −1 | Q: exp(l * pi) = = −1 |
| | | A: True |
| (2 + 5i)⁴(2 − 5i)⁴ | (2 + 5 * l)\hat{ }4 + (2 − 5 * l)\hat{ }4 | Q: (2 + 5 * l)\hat{ }4 + (2 − 5 * l)\hat{ }4 |
| | | A: = 82 |
| cos(t) + isin(t) = e^{it} | cos(t) + l * sin(t) = = exp(l * t) | Q: cos(t) + l * sin(t) = = exp(l * t) |
| | | A: True |
| \|3 + 4i\| | Abs(3 + 4 * l) | Q: Abs(3 + 4 * l) |
| | | A: = 5 |
| (cos(t) + isin(t))ⁿ = e^{nit} | (cos(t) + l * sin(t))\hat{ }n = = exp(n * l * t) | Q: (cos(t) + l * sin(t))\hat{ }n = = exp(n * l * t) |
| | | A: (e^{jt})ⁿ = e^{jnt} |
| (2 + 3i)(4 − 9i) | (2 + 3 * l) * (4 − 9 * l) | Q: (2 + 3 * l * (4 − 9 * l) |
| | | A: 35 − 6i = 35 − 6j |
| 2f(x)² − f(x)g(y) | 2 * f(x)\hat{ }2 − f(x) * g(y); fc | Q: 2 * f(x)\hat{ }2 − f(x) * g(y); fc |
| | | A: Factor − f(x)g(y) + 2f²(x) = (2f(x) − g(y))f(x) |
| (sin x)² + (cos x)² | sin(x)\hat{ }2 + cos(x)\hat{ }2 | Q: sin(x)\hat{ }2 + cos(x)\hat{ }2 |
| | | A: sin² (x) + cos² (x) = 1 |
| x + 5 > x | x + 5 > x | Q: x + 5 > x |
| | | A: True |
| x − 3 > x | x − 3 > x | Q: x − 3 > x |
| | | A: False |
| True or False | cos(x − y) = = cos(x) * cos(y) + | Q: cos(x − y) = = cos(x) * cos(y) + sin(x) * sin(y) |
| | sin(x) * sin(y) | A: True |
| True or False | cos(x)\hat{ }2 = = (1 + cos(2 * x))/2 | Q: cos(x)\hat{ }2 = = (1 + cos(2 * x))/2 |
| | | A: True |
| $cos ( {sin}^{- 1} \frac{1}{2} )$ | cos(asin(½)) | $\begin{matrix}Q : cos ( asin ( 1 / 2 ) ) \\ A : = \frac{\sqrt{3}}{2}\end{matrix}$ |
| (a + b)⁵ | (a + b)\hat{ }5 | Q: (a + b)\hat{ }5; ep |
| | | A: Expand (a + b)⁵ = 5ab⁴ + 10a²b³ + 10a³b² + 5a⁴b + |
| | | a⁵ + b⁵ |
| (1 − 2x)⁶ | (1 − 2 * x)\hat{ }6 | Q: (1 − 2 * x)\hat{ }6; ep |
| | | A: Expand (1 − 2x)⁶ = 1 − 12x + 60x² − 160x³ + |
| | | 240x⁴ − 192x⁵ + 64x⁶ |
| Factor z⁴ − 16 | z\hat{ }4 − 16; fc | Q: z\hat{ }4 − 16; fc |
| | | A: Factor z⁴ − 16 = (z − 2) (z + 2) (z² + 4) |
| True or False | tan(pi/2 − x) = = cot(x) | Q: tan(pi/2 − x) = = cot(x) |
| | | A: True |
| sinh(cosh⁻¹ \sqrt{5}) | sinh(acosh(5 ** (½))) | Q: sinh(acosh(5 ** (½))) |
| | | A = 2 |
| (tanh x)² + (sech x)² | tanh(x)\hat{ }2 + sech(x)\hat{ }2 | Q: tanh(x)\hat{ }2 + sech(x)\hat{ }2 |
| | | A: tanh² (x) + sech² (x) = 1 |
| ${( cosh \frac{1}{3} )}^{2} - {( sinh \frac{1}{3} )}^{2}$ | cosh(⅓)\hat{ }2 − sinh(⅓)\hat{ }2 | Q: cosh(⅓)\hat{ }2 − sinh(⅓)\hat{ }2 A: = 1 |
| $cos 3 ( x + \frac{2 π}{3} )$ | cos(3 * (x + 2 * pi/3)) | $\begin{matrix}Q : cos ( 3 * ( x + 2 * pi / 3 ) ) \\ A : cos ( 3 ( x + \frac{2 π}{3} ) ) = cos ( 3 x )\end{matrix}$ |
| $( \begin{matrix}53 \\ 5\end{matrix} )$ | gamma(53)/(gamma(6) * gamma(48)) | Q: gamma(53)/(gamma(6) * gamma(48)) A: = 2598960 |
| (sinh x + cosh x)⁹ | (sinh(x) + cosh(x))\hat{ }9 | Q: (sinh(x) + cosh(x))\hat{ }9 |
| | | A: (sinh (x) + cosh (x)⁹ = e^{9x} |
| True or False | x\hat{ }7 = = exp(7 * log(x)) | Q: x\hat{ }7 = = exp(7 * log(x)) |
| | | A: True |

(2) Limit

I. Limits (One-Sided, Finite and Infinite Limits, Limits at Infinity)

To determine the limit of function f(x) as x approaches c, one needs to include four elements “lim; f(x); x; c” or “lim(f(x), x, c, n/p)” in order, where ‘lim’ is the operation name, ‘f(x)’ the function expression, ‘x’ the independent variable, and ‘c’ the number ‘x’ approaches.

For one-sided limits, one needs to add keyword ‘n’ (negative ‘−’ or left side), or ‘p’ (positive ‘+’ or right side) to the end, making the expression become “lim; f(x); x; c; n” or “lim; f(x); x; c; p”. The default limit is two-sided (“np” or “pn”).

To find limit at infinity, one needs to enter ‘oo’ for infinity ∞ and ‘−oo’ for −∞. Similarly, “pi” represents the number π, and “e” or “E” for the number e. Some examples and results of the “lim” operation are given in Table 2.1.

TABLE 2.1
Determine limits of functions by “lim” operation

| Problems | Expressions | Results |
|---|---|---|
| ${lim}_{n \to ∞} {( 1 + \frac{1}{n} )}^{n} = e$ | lim((1 + 1/n)\hat{ }n, n, oo) | Q: lim((1 + 1/n)\hat{ }n, n, oo) A: = e |
| ${lim}_{x \to 0} \frac{sin x}{x} = 1$ | lim(sin(x)/x, x, 0) | Q: lim(sin(x)/x, x, 0) A: = 1 |
| ${lim}_{x \to {0}^{-}} \frac{\vert x \vert}{x} = - 1$ | lim(abs(x)/x, x, 0, n) | $\begin{matrix}Q : lim ; abs ( x ) / x , x , 0 ; n \\ A : {lim}_{x \to {0}^{-}} \frac{\vert x \vert}{x} = - 1\end{matrix}$ |
| ${lim}_{z \to 9} \frac{{z}^{8} - {9}^{8}}{{z}^{7} - {9}^{7}} = \frac{72}{7}$ | lim((z\hat{ }8 − 9\hat{ }8)/(z\hat{ }7 − 9\hat{ }7), z, 9) | $\begin{matrix}Q : lim ( ( z \hat{} 8 - 9 \hat{} 8 ) / ( z \hat{} 7 - 9 \hat{} 7 ) , z , 9 ) \\ A : = \frac{72}{7}\end{matrix}$ |
| ${lim}_{x \to - ∞} \frac{2 x - 3}{\sqrt[2]{{x}^{2} - 2 x - 1}} = - 2$ | lim; (2 * x − 3)/(x\hat{ }2 − 2 * x − 1)\hat{ }(1/2); | $\begin{matrix}Q : lim ; ( 2 * x - 3 ) / ( x \hat{} 2 - 2 * x - 1 ) \hat{} ( 1 / 2 ) ; x ; - oo \\ A : {lim}_{x \to - ∞} \frac{2 x - 3}{\sqrt{{x}^{2} - 2 x - 1}} = - 2\end{matrix}$ |
| ${lim}_{x \to {2}^{+}} ⌊ x ⌋$ | lim(floor(x), x, 2, p) | $\begin{matrix}Q : lim ; floor ( x ) ; x ; 2 ; p \\ A : {lim}_{x \to {2}^{+}} ⌊ x ⌋ = 2\end{matrix}$ |
| ${lim}_{x \to - {3}^{-}} ⌈ x ⌉$ | lim(ceiling(x), x, −3, n) | $\begin{matrix}Q : lim ; ceiling ( x ) ; x ; - 3 ; n \\ A : {lim}_{x \to - 3} ⌈ x ⌉ = - 3\end{matrix}$ |
| Linear combination | 2 * lim(tan(2 * x)/sin(3 * x), x, 0) − 3 * lim(y\hat{ }y, y, 0, p)/(4 * lim(atan(t), t, −oo)) | $\begin{matrix}Q : {2}^{*} lim ( tan ( {2}^{*} x ) / sin ( {3}^{*} x ) , x , 0 ) - 3 * lim ( y \hat{} y , y , 0 , p ) / ( {4}^{*} lim ( atan ( t ) , t , - oo ) ) \\ A : = \frac{9 + 8 π}{8 π}\end{matrix}$ |
| ${lim}_{n \to ∞} sin x$ | lim; sin(x); x; oo | $\begin{matrix}Q : lim ; sin ( x ) ; x ; oo \\ A : {lim}_{x \to ∞} sin ( x ) = 〈 - 1 , 1 〉\end{matrix}$ |
| ${lim}_{n \to 0} \frac{1}{x}$ | lim; 1/x; x; 0 | $\begin{matrix}Q : lim ; 1 / x ; x ; 0 \\ A : {lim}_{x \to 0} \frac{1}{x} = \overline{∞}\end{matrix}$ |
| ${lim}_{n \to - ∞} c$ | lim; c; x; −oo | $\begin{matrix}Q : lim ; c ; x ; - oo \\ A : {lim}_{x \to - ∞} c = c\end{matrix}$ |

II. Verify Properties and Formal Definition of Limit

The expression “a*lim(f(x),x,c)+b*lim(g(x),x,c)−lim(a*f(x)+b*g(x),x,c)” yields a result of 0, which show the linearity property

$${lim}_{x \to c} [ a \cdot f ( x ) + b \cdot ℊ ( x ) ] = a \cdot {lim}_{x \to c} f ( x ) + b \cdot {lim}_{x \to c} ℊ ( x ) .$$

Q: a*lim(f(x),x,c+b*lim(g(x),x,c)−lim(a*f(x)+b*g(x),x,c)

A: =0

Using the “lim” operation, one can verify the formal definition of limit and find a corresponding δ interval for given ϵ value by adding e to the end, so the expression would become “lim; f(x); x; c; np; ϵ”. Refer to some examples and results in Table 2.2.

TABLE 2.2
Verify properties and formal definition of limit by “lim” operation

| Expressions | Results |
|---|---|
| lim; 1/n ** 2; n; oo; p; 0.001 | $\begin{matrix}Q : lim ; 1 / n ** 2 ; n ; oo ; p ; 0.001 \\ A : {lim}_{x \to ∞} \frac{1}{{n}^{2}} = 0 ; \vert {n}^{- 2} \vert < 0.001 if n ∈ ( 31.6227766016838 , ∞ )\end{matrix}$ |
| lim; ½ ** n; n; oo; p; 0.000001 | $\begin{matrix}Q : lim ; 1 / 2 ** n ; n ; oo ; p ; 0.000001 \\ A : {lim}_{n \to ∞} {2}^{- n} = 0 ; \vert {2}^{- n} \vert < 1 e - 06 if n ∈ ( \frac{13.8155105579643}{log ( 2 )} , ∞ )\end{matrix}$ |
| lim; 1/x; x; −oo; np; 0.001 | $\begin{matrix}Q : lim ; 1 / x ; x ; - oo ; np ; 0.001 \\ A : {lim}_{x \to - ∞} \frac{1}{x} = 0 ; \vert {x}^{- 1} \vert < 0.001 if x ∈ ( - ∞ , - 1000. )\end{matrix}$ |
| lim; 2/(3 − z); z; 3; p; −500 | $\begin{matrix}Q : lim ; 2 / ( 3 - z ) ; z ; 3 ; p ; - 500 \\ A : {lim}_{x \to {3}^{+}} - \frac{2}{z - 3} = - ∞ ; \frac{2}{( 3 - z )} < - 500. if z ∈ ( 3 , 3.004 )\end{matrix}$ |
| lim; 1/x; x; 0; p; 1000000 | $\begin{matrix}Q : lim ; 1 / x ; x ; 0 ; p ; 1000000 \\ A : {lim}_{x \to {0}^{+}} \frac{1}{x} = ∞ ; 1000000.0 < {x}^{- 1} if x ∈ ( 0 , 1. \cdot {10}^{- 6} )\end{matrix}$ |
| lim; log(1 + u); u; 0; np; 0.01 | $\begin{matrix}Q : lim ; log ( 1 + o ) ; o ; 0 ; np ; 0.01 \\ A : {lim}_{u \to 0} log ( u + 1 ) = 0 ; \vert log ( 1 + u ) \vert < 0.01 if u ∈ ( - 0.00995016625083189 , 0.0100501670841679 )\end{matrix}$ |

III. Verify Derivative Formulas

One can evaluate derivatives by definition, and thus verify some derivative formulas using the “lim” operation. Table 2.3 presents some examples and results of the “lim” operation for derivatives.

TABLE 2.3
Verify derivatives formulas by “lim” operation

| Derivatives by definition | Expressions | Results |
|---|---|---|
| ${lim}_{h \to 0} \frac{f ( x + h ) - f ( x )}{h} = {f}^{′} ( x )$ | lim; (f(x + h) − f(x))/h; h; 0 | $Q : lim ; ( f ( x + h ) - f ( x ) ) / h ; h ; 0 \\ A : {lim}_{h \to 0} \frac{if ( x ) + f ( h + z )}{h} = \frac{d}{dx} f ( x )$ |
| ${lim}_{x \to c} \frac{f ( x ) - f ( c )}{x - c} = {f}^{′} ( c )$ | lim(f(x) −f(c))/(x − c), x, c) | $Q : lim ; ( f ( x ) - f ( c ) ) / ( x - c ) ; x ; c \\ A : {lim}_{x \to c} \frac{f ( c ) - f ( x )}{c - x} = \frac{d}{dc} f ( c )$ |
| ${lim}_{h \to 0} \frac{{a}^{x + h} - {a}^{x}}{h} = {a}^{x} log ( a ) ,$ | lim((a\hat{ }(x + h) − a\hat{ }x)/h, h, 0) | Q: lim((a\hat{ }(x + h) − a\hat{ }x)/h, h, 0) A: = a^{x} log (a) |
| ${lim}_{h \to 0} \frac{{( 2 + h )}^{x} - {2}^{x}}{h} = {2}^{x} log ( 2 )$ | lim((2\hat{ }(x + h) − 2\hat{ }x)/h, h, 0) | Q: lim ((2\hat{ }(x + h) − 2\hat{ }x)/h, h, 0) A: = 2^{x} log (2) |
| ${lim}_{x \to c} \frac{\sqrt[3]{{x}^{2}} - \sqrt[3]{{c}^{2}}}{x - c} = \frac{2}{3 \sqrt[3]{c}}$ | lim((x\hat{ }(2/3) − c\hat{ }(2/3))/(x − c), x, c) | $Q : lim ( x ∧ ( 2 / 3 ) - c ∧ ( 2 / 3 ) ) / ( x - c ) , x , c ) \\ A : = \frac{2}{3 \sqrt[3]{c}}$ |
| ${lim}_{h \to 0} \frac{\sqrt[3]{{( 8 + h )}^{2}} - \sqrt[3]{{8}^{2}}}{h} = \frac{1}{3}$ | lim(((8 + h)\hat{ }(2/3) − 8\hat{ }(2/3))/h, h, 0) | $Q : lim ( ( ( 8 + h ) ∧ ( 2 / 3 ) - 8 ∧ ( 2 / 3 ) ) / h , h , 0 ) \\ A : = \frac{1}{3}$ |
| ${lim}_{x \to 0} \frac{sin ( x ) - sin ( 0 )}{x}$ | lim;(sin(x) − sin(0))/x; x; 0 | $Q : lim ; ( sin ( x ) - sin ( 0 ) ) / x ; x ; 0 \\ A : {lim}_{x \to 0} \frac{sin ( x )}{x} = 1$ |
| ${lim}_{h \to 0} \frac{exp ( x + h ) - exp ( x )}{h}$ | lim; (exp(x + h) − exp(x))/h; h; 0 | $Q : lim ; ( exp ( x + h ) - exp ( x ) ) / h ; h ; 0 \\ A : {lim}_{h \to 0} \frac{- {e}^{z} + {e}^{h + z}}{h} = {e}^{x}$ |
| ${lim}_{h \to 0} \frac{tan ( \frac{π}{4} + h ) - 1}{h}$ | lim; (tan(pi/4 + h) − 1)/h; h; 0 | $Q : lim ; ( tan ( pi / 4 + h ) - 1 ) / h ; h ; 0 \\ A : {lim}_{h \to 0} \frac{tan ( h + \frac{π}{4} ) - 1}{h} = 2$ |
| ${lim}_{h \to 0} \frac{f ( a + h , b ) - f ( a , b )}{h}$ | lim; (f(a + h, b) − f(a, b))/h; h; 0 | $Q : lim ; ( f ( a + h , b ) - f ( a , b ) ) / h ; h ; 0 \\ A : {lim}_{h \to 0} \frac{- f ( a , b ) + f ( a + h , b )}{h} = \frac{\partial }{\partial a} f ( a , b )$ |
| ${lim}_{h \to 0} \frac{f ( a , b + h ) - f ( a , b )}{h}$ | lim;(f(a, b + h) − f(a, b))/h; h; 0 | $Q : lim ; ( f ( a , b + h ) - f ( a , b ) ) / h ; h ; 0 \\ A : {lim}_{h \to 0} \frac{- f ( a , b ) + f ( a , b + h )}{h} = \frac{\partial }{\partial b} f ( a , b )$ |

IV. Find Limits of Vector Functions

To find the limit of a vector function by “lim” operation, one need to express the vector as a linear combination of basis vectors i, j and k, and then apply it in “lim” operation as a scalar function. Two examples and results are given in Table 2.4.

TABLE 2.4
Limits of vector-valued functions by “lim” operation

| Expressions | Results |
|---|---|
| lim; cos(t) * i + exp(−t) * j − (1 + t)\hat{ }(−2) * k; t; 0 | $\begin{matrix}Q : lim ; cos ( t ) * i + exp ( - t ) * j - ( 1 + t ) \hat{} ( - 2 ) * k ; t ; 0 \\ A : {lim}_{t \to 0} i cos ( t ) + {je}^{- t} - \frac{k}{{( t + 1 )}^{2}} = i + j - k\end{matrix}$ |
| lim; sin(u) * i + cos(u) * j + u * k; u; pi/2 | $\begin{matrix}Q : lim ; sin ( u ) * i + cos ( u ) * j + u * k ; u ; pi \text{/2} \\ A : {lim}_{u \to \frac{π}{2}} i sin ( u ) + j cos ( u ) + ku = i + \frac{π k}{2}\end{matrix}$ |

Evaluate Improper Integrals

Using “lim” operation, one can evaluate improper integrals by its definition and combining it with the “int” operation. Refer to Table 2.5 for some examples and results for this operation.

TABLE 2.5
Evaluate improper integrals by ″lim″ and ″int″ operations

| Expressions | Results |
|---|---|
| lim(int(e\hat{ }(−x), x, 0, a), a, oo) | Q: lim(int(e\hat{ }(−x), x, 0, a), a, oo) |
| | A: = 1 |
| lim(int(1/x, x, 0, a), a, 0, p) | Q: lim(int(1/x, x, 0, a), a, 0, p) |
| | A: = ∞ |
| lim(int(1/x**(⅔), x, a, 1), a, 0, p) | Q: lim(int(1/x**(⅔), x, a, 1), a, 0, p) |
| | A: = 3 |
| lim(int(1/x**3, x, b, 1), b, 0, p) | Q: lim(int(1/x**3, x, b, 1), b, 0, p) |
| | A: = ∞ |

(3) Differentiation

I. Derivatives of Single-Variable Functions

(1). Derivative Functions

The derivative of a differentiable function f(x) with respect to x can be calculated by entering the expression “dif; f(x); x” or “dif(f(x),x)”, where “dif” is the operation name, “f(x)” is the function expression, and “x” is the variable to which the derivative is taken. By default, the operation returns the first derivative. One can add an option “n”, a positive integer, to the end and write “dif; f(x); x; n” for nth-order derivative. Some examples and results for “dif” operation are given in Table 3.1.

TABLE 3.1
Determine derivatives by “dif” operation

| Expressions | Results |
|---|---|
| dif; a*f(x) + b*g(x); x | $Q : dif ; {a}^{*} f ( x ) + {b}^{*} g ( x ) ; x \\ A : \frac{\partial }{\partial x} ( af ( x ) + bg ( x ) ) = a \frac{d}{dx} f ( x ) + b \frac{d}{dx} g ( x )$ |
| dif; f(g(x)); x | $Q : dif ; f ( g ( x ) ) ; x \\ A : \frac{d}{dx} f ( g ( x ) ) = \frac{d}{dx} g ( x ) \frac{d}{dg ( x )} f ( g ( x ) )$ |
| dif; f(x)*g(x); x | $Q : dif ; {f ( x )}^{*} g ( x ) ; x \\ A : \frac{d}{dx} f ( x ) g ( x ) = f ( x ) \frac{d}{dx} g ( x ) + g ( x ) \frac{d}{dx} f ( x )$ |
| dif;f(x)/g(x); x | $Q : dif ; f ( x ) / g ( x ) ; x \\ A : \frac{d}{dx} \frac{f ( x )}{g ( x )} = \frac{( - f ( x ) \frac{d}{dx} g ( x ) + g ( x ) \frac{d}{dx} f ( x ) )}{{g ( x )}^{2}}$ |
| dif; x*f(x)\hat{ }n; x | $Q : dif ; {x}^{*} f ( x ) ∧ n ; x \\ A : \frac{\partial }{\partial x} x {f}^{n} ( x ) = nx {f ( x )}^{- 1 + n} \frac{d}{dx} f ( x ) + {f ( x )}^{n}$ |
| dif; a\hat{ }(f(x)); x | $Q : dif ; a ∧ ( f ( x ) ) ; x \\ A : \frac{\partial }{\partial x} {a}^{f ( x )} = {a}^{f ( x )} log ( a ) \frac{d}{dx} f ( x )$ |
| dif; f(x)\hat{ }(g(x)); x | $Q : dif ; f ( x ) ∧ ( g ( x ) ) ; x \\ A : \frac{d}{dx} {f}^{g ( x )} ( x ) = {f ( x )}^{- 1 + g ( x )} ( g ( x ) \frac{d}{dx} f ( x ) + f ( x ) log ( f ( x ) ) \frac{d}{dx} g ( x ) )$ |
| dif; log(f(x)); x | $Q : dif ; log ( f ( x ) ) ; x \\ A : \frac{d}{dx} log ( f ( x ) ) = \frac{\frac{d}{dx} f ( x )}{f ( x )}$ |
| dif;((h\hat{ }3 − 3)/(2*h\hat{ }2 + 1))\hat{ }2; h; 2 | $Q : dif ; ( ( h ∧ 3 - 3 ) / ( {2}^{*} h ∧ 2 + 1 ) ) ∧ 2 ; h ; 2 \\ A : \frac{{d}^{2}}{{dh}^{2}} \frac{{( {h}^{3} - 3 )}^{2}}{{( 2 {h}^{2} + 1 )}^{2}} = \frac{2 ( - 36 - 18 h + 300 {h}^{2} + 96 {h}^{3} + 15 {h}^{4} - 24 {h}^{5} + 8 {h}^{6} + 4 {h}^{8} )}{( 1 + 8 {h}^{2} + 24 {h}^{4} + 32 {h}^{6} + 16 {h}^{8} )}$ |
| dif; L/(1 − A*exp (−k*t)); t; 2 | $Q : dif ; L / ( 1 - {A}^{*} exp ( - {k}^{*} t ) ) ; t ; 2 \\ A : \frac{{\partial }^{2}}{\partial {t}^{2}} \frac{L}{- A {e}^{- kt} + 1} = \frac{- {ALk}^{3} {e}^{kt} ( A + {e}^{kt} )}{{( A - {e}^{kt} )}^{3}}$ |
| dif; cos(t)*exp(t); t | $Q : dif ; {cos ( t )}^{*} exp ( t ) ; t \\ A : \frac{d}{dt} {e}^{t} cos ( t ) = \sqrt{2} {e}^{t} cos ( t + ( \frac{1}{4} ) π )$ |
| dif; (x + 2)\hat{ }(60); x | $Q : dif ; ( x + 2 ) ∧ ( 60 ) ; x \\ A : \frac{d}{dx} {( x + 2 )}^{60} = 60 {( 2 + x )}^{59}$ |
| dif; c/(c\hat{ }2 + 8)\hat{ } (1/2); c; 2 | $Q : dif ; c / c ( c ∧ 2 + 8 ) ∧ ( 1 / 2 ) ; c ; 2 \\ A : \frac{{d}^{2}}{{dc}^{2}} \frac{c}{\sqrt{{c}^{2} + 8}} = \frac{- 24 c}{{( 8 + {c}^{2} )}^{\frac{5}{2}}}$ |
| dif; log(x)/x; x; 4 | $Q : dif ; log ( x ) / x ; x ; 4 \\ A : \frac{{d}^{4}}{{dx}^{4}} \frac{log ( x )}{x} = \frac{2 ( - 25 + 12 log ( x ) )}{{x}^{5}}$ |
| dif; 1/(y + 1); y; 14 | $Q : dif ; 1 / ( y + 1 ) ; y ; 14 \\ A : \frac{{d}^{14}}{{dy}^{14}} \frac{1}{y + 1} = \frac{87178291200}{{( 1 + y )}^{15}}$ |
| dif; sin(v); v; 15 | $Q : dif ; sin ( v ) ; v ; 15 \\ A : \frac{{d}^{15}}{{dv}^{15}} sin ( v ) = - cos ( v )$ |
| dif; exp(−z); z; 16 | $Q : dif ; exp ( - z ) ; z ; 16 \\ A : \frac{{d}^{16}}{{dz}^{16}} {e}^{- z} = {e}^{- z}$ |

(2). Slopes, Rates of Change, Equation of Tangent Lines

To evaluate the derivative of f(x) at x=c, one needs to add the keyword “rt” followed by value c, making the expression as “dif; f(x); x; n; rt; c”. For instance, one can find the slope of the tangent line to the curve y=f(x) at x=c by “dif(f(x),x,1,rt,c)” or “dif; f(x); x; 1; rt; c”, and determine the equation of the tangent line by “dif(f(x),x,1,rt,c)” or “dif; f(x); x; 1; tn; c”. Refer to Table 3.2 for examples and results of these operations.

TABLE 3.2
Rates of change, slopes, and equations of tangent lines by “dif” operation

| Expressions | Results |
|---|---|
| dif; (x − 2)\hat{ }2*(x + 3)/ 5; x; 1; rt; 0 | $Q : dif ; ( x - 2 ) ∧ {2}^{*} ( x + 3 ) / 5 ; x ; 1 ; rt ; 0 \\ A : \frac{d}{dx} \frac{{( x - 2 )}^{2} ( x + 3 )}{5} = \frac{( - 2 + x ) ( 4 + 3 x )}{5} ; \frac{d}{dx} \frac{{( x - 2 )}^{2} ( x + 3 )}{5} {\vert}_{x = 0} = \frac{- 8}{5}$ |
| dif; (x − 2)\hat{ }2*(x + 3)/ 5; x; 1; tn; 0 | $Q : dif ( x - 2 ) ∧ {2}^{*} ( x + 3 ) / 5 ; x ; 1 ; tn ; 0 \\ A : \frac{d}{dx} \frac{{( x - 2 )}^{2} ( x + 3 )}{5} = \frac{( - 2 + x ) ( 4 + 2 x )}{5} ; \frac{d}{dx} \frac{{( x - 2 )}^{2} ( x + 3 )}{5} {\vert}_{x = 0} = \frac{- 8}{5} ; \\ tangent line L ( x ) = \frac{12}{5} + ( \frac{- 8}{5} ) x$ |
| dif; (2*x\hat{ }2 + 1)\hat{ }(1/2); x; 1; tn; 2 | $Q : dif ; ( {2}^{*} x ∧ 2 + 1 ) ∧ ( 1 / 2 ) ; x ; 1 ; tn ; 2 \\ A : \frac{d}{dx} \sqrt{2 {x}^{2} + 1} = \frac{2 x}{\sqrt{1 + 2 {x}^{2}}} ; \frac{d}{dx} \sqrt{2 {x}^{2} + 1} {\vert}_{x = 2} = \frac{4}{3} ; \\ tangent line L ( x ) = \frac{1}{3} + ( \frac{4}{3} ) x$ |
| dif; s/(1 + s\hat{ }2)\hat{ }(1/2); s; 1; tn; −1 | $Q : dif ; s / ( 1 + s ∧ 2 ) ∧ ( 1 / 2 ) ; s ; 1 ; tn ; - 1 \\ A : \frac{d}{dx} \frac{s}{\sqrt{{s}^{2} + 1}} = {( 1 + {s}^{2} )}^{\frac{- 3}{2}} ; \frac{d}{dx} \frac{s}{\sqrt{{s}^{2} + 1}} {\vert}_{s = - 1} = \frac{\sqrt{2}}{4} ; \\ tangent line L ( s ) = \frac{\sqrt{2} ( - 1 + x )}{4}$ |
| dif; x*exp(x); x; 1; tn; −2 | $Q : dif ; {x}^{*} exp ( x ) ; x ; 1 ; tn ; - 2 \\ A : \frac{d}{dx} {xe}^{x} = {e}^{x} ( 1 + x ) ; \frac{d}{dx} {xe}^{x} {\vert}_{x = - 2} = - {e}^{- 2} ; tangent line L ( x ) = - {e}^{- 2} ( 4 + x )$ |

(3). Differentials and Linearization

The expression “dif; f(x); x; 1; df; c; dx” or “dif(f(x), x, 1, df, c, dx)” approximates f(x) at x close to c, where keyword “df” is for differential, “c” is a value (tangency point at x=c), and “dx” is an increment (or small change Δx). The result from “dif(f(x), x, 1, df, c, dx)” gives a linear approximation of the value f(c+dx). Three examples and results for this operation are presented in Table 3.3.

TABLE 3.3
Differentials and linearization by “dif” operation

| Problem | Code | Result |
|---|---|---|
| Estimate sec(58°) | dif; sec(x); x; 1; df; pi/3; −pi/90 | $Q : dif ; sec ( x ) ; x ; 1 ; df ; pi / 3 ; - pi / 90 \\ A : Δ f \approx df = \frac{- 1 \sqrt{3} π}{45} ; f ( \frac{29 π}{90} ) \approx 1.87908004$ |
| Estimate e^{0.1} | dif; exp(x); x; | Q: dif; exp(x); x; 1; df, 0, 0.1 |
| | 1; df; 0; 0.1 | A: Δƒ ≈ dƒ = 0.1; ƒ(0.1) ≈ 1.1 |
| Estimate 25.8^{2/3} | dif; x\hat{ }(2/3); x; | Q dif; x\hat{ }(2/3), x; 1; df, 27; −1.2 |
| | 1; df; 27; −1.2 | A: Δƒ ≈ dƒ = −0.266666666666667; f(25.8) ≈ 8.73333333 |

(4). Monotonicity, Concavity and Extreme Value Problems

Using “dif” operation, one can also determine the interval on which f(x) is increasing by “dif; f(x); x; 1; ic” and decreasing by “dif; f(x); x; 1; dc”, and determine the interval on which f(x) is concave up by “dif; f(x); x; 2; cu” and down by “dif; f(x); x; 2; cd”. Replacing the keyword with “cp” or “ip”, one has the expression “dif; f(x); x; 1; cp” for finding the possible critical numbers, and “dif; f(x); x; 2; ip” for inflection points of f(x).

With results from these operations, one can determine local extreme values for f(x).

For example, let

$$f ( x ) = \frac{{x}^{2}}{x - 2} .$$

First, locate possible critical numbers of f(x) by “dif;x\hat{ }2/(x−2);x; 1;cp”, which gives x={0, 4}.

$$Q : dif ; x \hat{} 2 / ( x - 2 ) ; x ; 1 ; cp$$

$$A : \frac{d}{dx} \frac{{x}^{2}}{x - 2} = \frac{x ( - 4 + x )}{( 4 - 4 x + {x}^{2} )} ; \frac{{x}^{2}}{( - 2 + x )} has critical number ( s ) x = \{ 0 , 4 \}$$

The second derivative test by “dif;x\hat{ }2/(x−2);x;2;cu” and “dif;x\hat{ }2/(x−2);x;2;cd” indicates g(x) is concave up on (2, ∞) and down on (−∞, 2), which implies g“(4)>0, g”(0)<0. Thus, g(4)=8 is a relative minimum, and g(0)=0 is a local maximum.

$$Q : dif ; x \hat{} 2 / ( x - 2 ) ; x ; 2 ; cu$$

$$A : \frac{{d}^{2}}{{dx}^{2}} \frac{{x}^{2}}{x - 2} = \frac{8}{( - 8 + 12 x - 6 {x}^{2} + {x}^{3} )} ; \frac{{x}^{2}}{( - 2 + x )} concave up on ( 2 , ∞ )$$

$$Q : dif ; x \hat{} 2 / ( x - 2 ) ; x ; 2 ; cd$$

$$A : \frac{{d}^{2}}{{dx}^{2}} \frac{{x}^{2}}{x - 2} = \frac{8}{( - 8 + 12 x - 6 {x}^{2} + {x}^{3} )} ; \frac{{x}^{2}}{( - 2 + x )} concave down on ( - ∞ , 2 )$$

Table 3.4 give examples and results from “dif” operations on monotonicity, concavity, critical numbers and inflection points.

TABLE 3.4
Monotonicity and concavity, and extreme values by “dif” operation

| Expressions | Results |
|---|---|
| dif; x\hat{ }3 − 8*x\hat{ }2; x; 1; dc or slv(dif(x\hat{ }3 − 8*x\hat{ }2, x) < 0, x) | $Q : dif ; x ∧ 3 - {8}^{*} x ∧ 2 ; x ; 1 ; dc \\ A : \frac{d}{dz} ( {x}^{3} - 8 {x}^{2} ) = x ( - 16 + 3 x ) ; - 8 {x}^{2} + {x}^{3} decreases on ( 0 , \frac{16}{3} )$ |
| dif; x − x\hat{ }3; x; 2; cd | $Q : dif ; x - x ∧ 3 ; x ; 2 ; cd \\ A : \frac{{d}^{3}}{{dx}^{2}} ( - {x}^{3} + x ) = - 6 x ; x - {x}^{3} concave down on ( 0 , ∞ )$ |
| dif; u/(1 + u\hat{ }2); u; 2; cu | $Q : dif ; u / ( 1 + u ∧ 2 ) ; u ; 2 ; cu \\ A : \frac{{d}^{2}}{{du}^{2}} \frac{u}{{u}^{2} + 1} = \frac{2 u ( - 3 + {u}^{2} )}{{( 1 + {u}^{2} )}^{3}} ; \frac{u}{( 1 + {u}^{3} )} concave up on ( - \sqrt{3} , 0 ) ⋃ ( \sqrt{3} , ∞ )$ |
| dif; cosh(t); t; 2; cu | $Q : dif ; cosh ( t ) ; t ; 2 ; cu \\ A : \frac{{d}^{2}}{{dt}^{2}} cosh ( t ) = cosh ( t ) ; cosh ( t ) concave up on ℝ$ |
| dif; s\hat{ }2*exp(−s); s; 2; ip | $Q : dif ; s ∧ {2}^{*} exp ( - s ) ; s ; 2 ; ip \\ A : \frac{{d}^{2}}{{ds}^{2}} {s}^{2} {e}^{- s} = {e}^{- s} ( 2 - 4 s + {s}^{2} ) ; {s}^{2} {e}^{- 2} has inflection point s = \{ 2 - \sqrt{2} , \sqrt{2} + 2 \}$ |
| dif; x\hat{ }4 − 9*x\hat{ }3 + 30*x\hat{ }2 − 44*x + 24; x; 1; cp | $Q : dif ; x ∧ 4 - {9}^{*} x ∧ 3 + {30}^{*} x ∧ 2 - {44}^{*} x + 24 ; x ; 1 ; cp \\ A : \frac{d}{dx} ( {x}^{4} - 9 {x}^{3} + 30 {x}^{3} - 44 x + 24 ) = - 44 + 60 x - 27 {x}^{2} + 4 {x}^{3} ; \\ 24 - 44 x + 30 {x}^{2} - 9 {x}^{3} + {x}^{4} has critical number ( s ) x = \{ 2 , \frac{11}{4} \}$ |
| Dif;x\hat{ }3/5 + 11*x\hat{ }2/ 10 − 4*x/5 − 8; x; 1; ic | $Q : dif ; x ∧ 3 / 5 + {11}^{*} x ∧ 2 / 10 - {4}^{*} x / 5 - 8 ; x ; 1 ; ic \\ A : \frac{d}{dx} ( \frac{{x}^{3}}{5} + \frac{11 {x}^{3}}{10} - \frac{4 x}{5} - 8 ) = \frac{- 4}{5} + ( \frac{11}{5} ) x + ( \frac{3}{5} ) {x}^{3} ; - 8 + ( \frac{- 4}{5} ) x + ( \frac{11}{10} ) {x}^{2} + ( \frac{1}{5} ) {x}^{3} increase on ( - ∞ , - 4 ) ⋃ ( \frac{1}{3} , ∞ )$ |

(5). Expressions for Differential Equations

One can use “dif” operation to write ordinary differential equations and solve them by the “ode” operation. For instance, the expression “dif(g(x),x,2)−2*dif(g(x),x)−3” represents the differential equation g″(x)−2g′(x)−3=0, and “ode(dif(g(x),x,2)−2*dif(g(x),x)−3)” finds the general solution to the unknown function g(x). Refer to section (7) differential equations for more details.

II. Implicit Differentiation

Suppose y is implicitly defined by x in f(x, y)=0. To find implicit differentiation by “dif” operation, one needs to specify which variable is independent, which is dependent, and enter the expression “dif; f(x, y); x; y; n” for the nth derivative of “y” to “x”. By default n=1, and it is optional.

To evaluate derivatives at a given point (x₀, y₀), add the values “x₀” (for “x”) and “y₀” (for “y”) to the end, making the expression as “dif; f(x, y); x; y; n; x₀, y₀” or “dif(f(x, y), x, y, n, x₀, y₀)”.

In case both x and y are functions of t, x′(t) and y′(t) are called related rates, because the functions x and y are related in the equation f(x(t), y(t))=0. One can use implicit differentiation “dif;f(x(t), y(t)); t; x” for x′(t), and “dif;f(x(t), y(t)); t; y” for y′(t). Specifying “x” as “x(t)” and “y” as “y(t)” in the operation is required because both are functions of “t”. Otherwise, “x” and “y” would be treated as constants.

For instance, if y(x) and z(x) are related in x+2y−3z=7, one can find y′(x) by “dif;x+2*y(x)−3*z(x)−7;x;y” and z′(x) by “dif;x+2*y(x)−3*z(x)−7;x;z”.

$$Q : dif ; x + {2}^{*} y ( x ) - {3}^{*} z ( x ) - 7 ; x ; y$$

$$A : \frac{d}{dx} y = \frac{3 \frac{d}{dz} s ( x )}{2} - \frac{1}{2}$$

$$Q : dif ; x + {2}^{*} y ( x ) - {3}^{*} z ( x ) - 7 ; x ; z$$

$$A : \frac{d}{dx} z = \frac{2 \frac{d}{dx} y ( x )}{3} + \frac{1}{3}$$

Table 3.5 displays some examples and results from “dif” operation for implicit differentiation.

TABLE 3.5
Implicit differentiation by “dif” operation

| Expressions | Results |
|---|---|
| dif; x\hat{ }2 + x*y + y\hat{ }2 − 1; x; y | $Q : dif ; x ∧ 2 + {x}^{*} y + y ∧ 2 - 1 ; x ; y \\ A : \frac{d}{dx} y = - \frac{2 x + y}{x + 2 y}$ |
| dif; x\hat{ }2 + x*y + y\hat{ }2 − 1; x; y; 2 | $Q : dif ; x ∧ 2 + {x}^{*} y + y ∧ 2 - 1 ; x ; y ; 2 \\ A : \frac{{d}^{2}}{{dx}^{2}} y = - \frac{3 x ( 2 x + y ) + 3 y ( x + 2 y )}{( x + 2 y ) ( {x}^{2} + 4 xy + 4 {y}^{2} )}$ |
| dif; x\hat{ }2 + x*y + y\hat{ }2 − 1; x; y; 1; 0; l | $Q : dif ; x ∧ 2 + {x}^{*} y + y ∧ 2 - 1 ; x ; y ; 1 ; 0 ; 1 \\ A : \frac{d}{dx} y {\vert}_{( 0 , 1 )} = \frac{- 1}{2}$ |
| dif;x\hat{ }2 + x*y + y\hat{ }2 − 1; x; y; 2; 0; 1 | $Q : dif ; x ∧ 2 + {x}^{*} y + y ∧ 2 - 1 ; x ; y ; 2 ; 0 ; 1 \\ A : \frac{{d}^{2}}{{dx}^{2}} y {\vert}_{( 0 , 1 )} = \frac{- 3}{4}$ |
| dif; exp(x + y) − cos(x*y) − x\hat{ }2*y\hat{ }2; x; y | $Q : dif ; exp ( x + y ) - cos ( x ∧ y ) - x ∧ {2}^{*} y ∧ 2 ; x ; y \\ A : \frac{d}{dx} y = \frac{2 {xy}^{2} - y sin ( xy ) - {e}^{x + y}}{- 2 {x}^{2} y + x sin ( xy ) + {e}^{x + y}}$ |
| dif; y\hat{ }2 − x − cos(x*y); x; y; 1; 0; 1 | $Q : dif ; y ∧ 2 - x - cos ( {x}^{*} y ) ; x ; y ; 1 ; 0 ; 1 \\ A : \frac{d}{dx} y {\vert}_{( 0 , 1 )} = \frac{1}{2}$ |

III. Multivariate Derivatives

(1). Partial Derivatives

The expression “pdv; f(x, y, z, . . . ); x; y; z; x . . . ” helps find partial derivatives for a differentiable function f(x, y, z, . . . ) of two or more variables, where “pdv” is the operation name, “f(x, y, z, . . . )” a function of several variables, and “x; y; z; . . . ” are the sequence of variables to which the partial derivative is taken.

One can calculate the first partial derivative of f(x, y) by “pdv;f(x,y);x” and “pdv;f(x,y);y”, and the second partial derivatives by “pdv;f(x,y);x;x”, “pdv;f(x,y);y;y”, “pdv;f(x,y);x;y”, and “pdv;f(x,y);y;x”. Continue this pattern for higher order partial derivatives. Table 3.6 presents some examples and results for this operation.

TABLE 3.6
Partial derivatives by “pdv” operation

| Expressions | Results |
|---|---|
| pdv; exp(x*y*z) *sin(x); x; y; z | $Q : pdv ; {exp ( {x}^{*} {y}^{*} z )}^{*} sin ( x ) ; x ; y ; z \\ A : \frac{{\partial }^{3}}{\partial x \partial y \partial z} {e}^{xyz} sin ( x ) = {e}^{xyz} ( x cos ( x ) + 3 xyz sin ( x ) + {x}^{2} yz cos ( x ) + \\ {x}^{2} {y}^{2} {z}^{2} sin ( x ) + sin ( x ) )$ |
| pdv; exp(x*y*z) *sin(x); z; y; x | $Q : pdv ; {exp ( {x}^{*} {y}^{*} z )}^{*} sin ( x ) ; z ; y ; x \\ A : \frac{{\partial }^{2}}{\partial x \partial y \partial z} {e}^{xyz} sin ( x ) = {e}^{xyz} ( x cos ( x ) + 3 xyz sin ( x ) + {x}^{2} yz cos ( x ) + \\ {x}^{2} {y}^{2} {z}^{2} sin ( x ) + sin ( x ) )$ |
| pdv; x\hat{ }3*sin(y) + y\hat{ }2*cos(x); y; x | $Q : pdv ; x ∧ {3}^{*} sin ( y ) + y ∧ {2}^{*} cos ( x ) ; y ; x \\ A : \frac{{\partial }^{2}}{\partial x \partial y} ( {x}^{3} sin ( y ) + {y}^{2} cos ( x ) ) = 3 {x}^{2} cos ( y ) - 2 y sin ( x )$ |
| pdv; sin(x*y*z) + z/y; x; y; z | $Q : pdv ; sin ( {x}^{*} {y}^{*} z ) + z / y ; x ; y ; z \\ A : \frac{{\partial }^{3}}{\partial x \partial y \partial z} ( sin ( xyz ) + \frac{x}{y} ) = - 3 xyz sin ( xyz ) - {x}^{2} {y}^{2} {z}^{2} cos ( xyz ) + cos ( xyz )$ |
| pdv; y\hat{ }x; x; y; x | $Q : pdv ; y ∧ x ; x ; y ; x \\ A : \frac{{\partial }^{3}}{\partial x \partial y \partial z} {y}^{x} = {y}^{- 1 + x} log ( y ) ( 2 + x log ( y ) )$ |
| pdv; cos(x\hat{ }2*y\hat{ }3); y; x; y | $Q : pdv ; cos ( x ∧ {2}^{*} y ∧ 3 ) ; y ; x ; y \\ A : \frac{{\partial }^{3}}{\partial y \partial x \partial y} cos ( {x}^{2} {y}^{3} ) = - 12 xy sin ( {x}^{2} {y}^{3} ) - 48 {x}^{3} {y}^{4} cos ( {x}^{2} {y}^{3} ) + \\ 18 {x}^{5} {y}^{7} sin ( {x}^{2} {y}^{3} )$ |
| pdv; u/(u + v); u; u; v | $Q : pdv ; u / ( u + v ) ; u ; u ; v \\ A : \frac{{\partial }^{3}}{\partial v \partial {u}^{2}} \frac{u}{u + v} = \frac{2 ( - u + 2 v )}{{( u + v )}^{4}}$ |
| pdv; asin(x/y); u; v | $Q : pdv ; a sin ( x / y ) ; u ; v \\ A : \frac{{\partial }^{2}}{\partial y \partial u} a sin ( \frac{x}{y} ) = 0$ |
| pdv; cos(3*x)*sin (4*y); y; x | $Q : pdv ; {cos ( {3}^{*} x )}^{*} sin ( {4}^{*} y ) ; y ; x \\ A : \frac{{\partial }^{2}}{\partial x \partial y} sin ( 4 y ) cos ( 3 x ) = - 12 sin ( 3 x ) cos ( 4 y )$ |
| pdv; (x\hat{ }2*y − x*y\hat{ }2)/(x\hat{ }2 + y\hat{ }2); x; y | $Q : pdv ; ( x ∧ {2}^{*} y - {x}^{*} y ∧ 2 ) / ( x ∧ 2 + y ∧ 2 ) ; x ; y \\ A : \frac{{\partial }^{2}}{\partial y \partial x} \frac{{x}^{2} - {xy}^{2}}{{x}^{2} + {y}^{2}} = \frac{2 xy ( - 3 {xy}^{2} + 3 {x}^{2} y + {x}^{3} - {y}^{3} )}{( 3 {x}^{2} {y}^{4} + 3 {x}^{4} {y}^{2} + {x}^{6} + {y}^{6} )}$ |

Using “pdv” operation, one can verify if the order of partial derivatives matters by the expression “pdv(f(x,y),x,y)−pdv(f(x,y),y,x)”. Refer to the examples and results in Table 3.7 for this operation.

TABLE 3.7
Equality of mixed partial derivatives by “pdv” operation

| Problems | Expressions | Results |
|---|---|---|
| f_{xy} = f_{yx} | pdv(f(x, y), x, y) − | Q: pdv(f(x, y), x, y) − pdv(f(x, y), y, x) |
| | pdv(f(x, y), y, x) | A: = 0 |
| f (x, y) = | pdv(cos(x + y)* | Q: pdv(cos(x + y )*exp(x*y), x, y) − pdv(cos (x + y*exp(x*y), y, x) |
| cos(x + y)e^{xy} | exp(x*y), x, y) − | A: = 0 |
| | pdv(cos(x + y)* | |
| | exp(x*y), y, x) | |
| f_{xy} = f_{yx}, f(x, | pdv(x\hat{ }2*y + y\hat{ }3*x, x, y) − | Q: pdv(x\hat{ }2*y + y\hat{ }3*x, xy) − pdv(x\hat{ }2*y + y\hat{ }3*xy, x) |
| y) = yx² + y³ | pdv(x\hat{ }2*y + y\hat{ }3*x, y, x) | A: = 0 |
| f (x, y) = | pdv(g(x)*h(y), x, y) − | Q: pdv(g(x)*h (y), x, y) − pdv(g(x) * h (y), y, x) |
| g(x)h(y); f_{xy} = | pdv(g(x)*h(y), y, x) | A: = 0 |
| f_{yx}, | | |
| fₓf_{y} − f_{xy}f | pdv(g(x)*h(y), x)* | Q: pdv(g(x)*h(y), x)*pdv(g(x)*th(y),y)-pdv(g(x)*h(y), x, y)*g(x)*h(y) |
| | pdv(g(x)*h(y), y) − | A: = 0 |
| | pdv(g(x)*h(y), x, y)* | |
| | g(x)*h(y) | |
| Let z = ye^{x/y}. | x*dif(y*exp(x/y), x) + | Q: x*dif(y*exp(x/y), x) + y*dif(y*exp(x/y), y) −y*exp(x/y) |
| Show xzₓ + | y*dif(y*exp(x/y), y) − | A: = 0 |
| yz_{y} = z | y*exp(x/y) | |
| Let z = x^{2 -} | x*dif(x\hat{ }2 −5*x*y+y\hat{ }2, x) + | Q x*dif(x\hat{ }2 − 5*x*y + y\hat{ }2, x) + y*dif(x\hat{ }2 −5*x* y + y\hat{ }2, y) − 2*(x\hat{ }2 − 5*x*y + y\hat{ }2) |
| 5xy + z². xzₓ + | y*dif(x\hat{ }2 − | A: = 0 |
| yz_{y} = 2z | 5*x*y + y\hat{ }2, y) − | |
| | 2*(x\hat{ }2 − 5*x*y + y\hat{ }2) | |
| Let z = f(x² + | dif(f(x\hat{ }2 + y\hat{ }2), x)*y − | Q: dif(f(x\hat{ }2 +y\hat{ }2), x)*y − x*dif(f(x\hat{ }2 + y−2), y) |
| y²). Show | x*dif(f(x\hat{ }2 + y\hat{ }2), y) | A: = 0 |
| xz_{y} − yzₓ = 0 | | |
| | pdv; cos(3*x)* sin(4*y); y; x | $Q : pdv ; {cos ( {3}^{*} x )}^{*} sin ( {4}^{*} y ) ; y ; x \\ A : \frac{{\partial }^{2}}{\partial x \partial y} sin ( 4 y ) cos ( 3 x ) = - 12 sin ( 3 x ) cos ( 4 y )$ |
| | pdv;(x\hat{ }2*y − x*y\hat{ }2)/(x−2 + y\hat{ }2); x; y | $Q : pdv ; ( x ∧ {2}^{*} y - {x}^{*} y ∧ 2 ) / ( x ∧ 2 + y ∧ 2 ) ; x ; y \\ A : \frac{{\partial }^{2}}{\partial y \partial x} \frac{{x}^{2} y - {xy}^{2}}{{x}^{2} = {y}^{2}} = \frac{2 xy ( - 3 {xy}^{2} + 3 {x}^{2} y + {x}^{3} - {y}^{3} )}{( 3 {x}^{2} {y}^{4} + 3 {x}^{4} {y}^{2} + {z}^{6} + {y}^{6} )}$ |

There are three approaches for finding certain type of partial derivatives. For example, the three expressions “dif; exp(x*y); x; 3”, “dif(exp(x*y), x, 3)”, and “pdv(exp(x*y), x, x, x)” yield the same results as expected. Refer to the results for the three operations.

$$Q : dif ; exp ( {x}^{*} y ) ; x ; 3$$

$$A : \frac{{\partial }^{3}}{\partial {x}^{3}} {e}^{xy} = {y}^{3} {e}^{xy}$$

$$Q : dif ( exp ( {x}^{*} y ) , x , 3 )$$

$$A : = {y}^{3} {e}^{xy}$$

$$Q : pdv ( exp ( {x}^{*} y ) , x , x , x )$$

$$A : = {y}^{3} {e}^{xy}$$

One can also use the expression “dif(f(x,y),x)” to write a first-order partial differential equation. For example, the expression “dif(g(x,y),y)−2*x” stands for the partial differential equations g_{y}(x, y)−2x=0, and “pde(dif(g(x,y),y)−2*x)” gives the general solution to the unknown function g(x, y). Refer to section (7) Partial differential equations for more information.

(2). Gradient and Critical Points

The “grd” operation is designed to find gradient vectors of multivariate functions, and the expression “grd; f(x, y, z); x; y; z” or “grd(f(x, y, z), x, y, z)” finds the gradient vector of the function f(x, y, z). To evaluate the gradient vector at a particular point (x₀, y₀, z₀), use expression “grd; f(x, y, z); x; x₀; y; y₀; z; z₀” or “grd(f(x, y, z), x, x₀, y, y₀, z, z₀)”.

The operation “cpt” helps find possible critical points of a function f(x, y, z) of two or three variables by “cpt; f(x, y, z); x; y; z” or “cpt(f(x, y, z), x, y, z)”. The “cpt” operation is equal to the operations “nes(grd(f(x, y, z), x, y, z))” or “les(grd(f(x, y, z), x, y, z))”, depending on whether the system of equations is linear or nonlinear. Table 3.8 lists some examples and results for “grd” and “cpt” operations.

TABLE 3.8
Gradient and critical points for several-variable functions by “grd” and “cpt” operations

| Expressions | Results |
|---|---|
| grd; 2*x + 3*y\hat{ }2 − cos(z); | Q: grd; 2*x +3*y\hat{ }2 − cos (z); xy; z |
| x; y; z | |
| | A: <2, 6y, sin (z)> |
| grd; 2*x + 3*y\hat{ }2 − | Q: grd; 2*x + 3*y\hat{ }2 −cos(z), x; 1; y; 2; z; pi/2 |
| cos(z); x; 1; y; 2; z; pi/2 | A: <2, 12, 1> |
| grd; x\hat{ }3*y + z\hat{ }2; x; 2; | Q: grd; x\hat{ }3 y + z\hat{ }2, x; 2; y; 3; z; −1 |
| y; 3; z; −1 | A: <36, 8, −2> |
| cpt; x*y*(x + 2*y + 3); x; y | $Q : cpt ; {x}^{*} {y}^{*} ( x + {2}^{*} y + 3 ) ; x ; y \\ A : Critical point ( s ) ( x , y ) = \{ ( - 3 , 0 ) , ( - 1 , - \frac{1}{2} ) , ( 0 , - \frac{3}{2} ) , ( 0 , 0 ) \}$ |
| cpt; x\hat{ }2*y + x*y\hat{ }2 − x*y; x; y | $Q : cpt ; x ∧ {2}^{*} y + {x}^{*} y ∧ 2 - {x}^{*} y ; x ; y \\ A : Critical points ( s ) ( x , y ) = \{ ( 0 , 0 ) , ( 0 , 1 ) , ( \frac{1}{3} , \frac{1}{3} ) , ( 1 , 0 ) \}$ |
| cpt; x\hat{ }3 + y\hat{ }3 + 3*x\hat{ }2* y\hat{ }2; x; y | $Q : cpt ; x ∧ 3 + y ∧ 3 + {3}^{*} x ∧ {2}^{*} y ∧ 2 , x , y \\ A : Critical points ( s ) ( x , y ) = \{ ( - \frac{1}{3} , - \frac{1}{3} ) , ( 0 , 0 ) ( - 2 {( \frac{1}{4} - \frac{\sqrt{3} i}{4} )}^{2} , \frac{1}{4} - \frac{\sqrt{3} i}{4 )} , \\ ( - 2 {( \frac{1}{4} + \frac{\sqrt{3} i}{4} )}^{2} , \frac{1}{4} + \frac{\sqrt{3} i}{4} ) \}$ |
| cpt(x*y*(x + 2*y + 3), x, y) | $Q : cpt ( {x}^{*} {y}^{*} ( x + {2}^{*} y + 3 ) , x , y ) \\ A : = \{ ( - 3 , 0 ) , ( - 1 , - \frac{1}{2} ) , ( 0 , - \frac{3}{2} ) , ( 0 , 0 ) \}$ |
| cpt(x\hat{ }2*y + x*y\hat{ }2 − x*y, x, y) | $Q : cpt ( x ∧ {2}^{*} y + {x}^{*} y ∧ 2 - {x}^{*} y , x , y ) \\ A : \{ ( 0 , 0 ) , ( 0 , 1 ) , ( \frac{1}{3} , \frac{1}{3} ) , ( 1 , 0 ) \}$ |
| cpt(x\hat{ }3 + y\hat{ }3 + 3*x\hat{ }2* y\hat{ }2, x, y) | $Q : cpt ( x ∧ 3 + y ∧ 3 + {3}^{*} x ∧ {2}^{*} y ∧ 2 , x , y ) \\ A : = \{ ( - \frac{1}{2} , - \frac{1}{2} ) , ( 0 , 0 ) , ( - 2 {( \frac{1}{4} - \frac{\sqrt{3} i}{4} )}^{3} , \frac{1}{4} - \frac{\sqrt{3} i}{4} ) , ( - 2 {( \frac{1}{4} + \frac{\sqrt{3} i}{4} )}^{2} , \frac{1}{4} + \frac{\sqrt{3} i}{4} ) \}$ |
| nes(grd(x\hat{ }3 + y\hat{ }3 + 3* x\hat{ }2*y\hat{ }2, x, y)) | $Q : nes ( grd ( x ∧ 3 + y ∧ 3 + {3}^{*} x ∧ {2}^{*} y ∧ 2 , x , y ) ) \\ A : = \{ ( - \frac{1}{2} , - \frac{1}{2} ) , ( 0 , 0 ) , ( - 2 {( \frac{1}{4} - \frac{\sqrt{3} i}{4} )}^{3} , \frac{1}{4} - \frac{\sqrt{3} i}{4} ) , ( - 2 {( \frac{1}{4} + \frac{\sqrt{3} i}{4} )}^{2} , \frac{1}{4} + \frac{\sqrt{3} i}{4} ) \}$ |
| nes(grd(x*y*(x + 2*y + 3), x, y)) | $Q : nes ( grd ( {x}^{*} {y}^{*} ( x + {2}^{*} y + 3 ) , x , y ) ) ) \\ A : \{ ( - 3 , 0 ) , ( - 1 , - \frac{1}{2} ) , ( 0 , - \frac{3}{2} ) , ( 0 , 0 ) \}$ |
| nes(grd(x\hat{ }2*y + x*y\hat{ }2 − x*y, x, y)) | $Q : nes ( grd ( x ∧ {2}^{*} y + {x}^{*} y ∧ 2 - {x}^{*} y , x , y ) ) \\ A : = \{ ( 0 , 0 ) , ( 0 , 1 ) , ( \frac{1}{3} , \frac{1}{3} ) , ( 1 , 0 ) \}$ |
| nes(grd(x\hat{ }3 + y\hat{ }3 + 3* x\hat{ }2*y\hat{ }2, x, y)) | $Q : nes ( grd ( x ∧ 3 + y ∧ 3 + 3 ∧ x ∧ {2}^{*} y ∧ 2 , x , y ) ) \\ A : = \{ ( - \frac{1}{2} , - \frac{1}{2} ) , ( 0 , 0 ) , ( - 2 {( \frac{1}{4} - \frac{\sqrt{3} i}{4} )}^{2} , \frac{1}{4} - \frac{\sqrt{3} i}{4} ) , ( - 2 {( \frac{1}{4} + \frac{\sqrt{3} i}{4} )}^{2} , \frac{1}{4} + \frac{\sqrt{3} i}{4} ) \}$ |

(3). Directional Derivatives

The expression “drd; u; f(x, y, z); x; y; z” or “drd(u, f(x, y, z), x, y, z)” helps find directional derivatives for a function f(x, y, z) along the direction of u, where “drd” is the operation name, “u” the expression of the direction vector u, f(x, y, z) the function expression, and the rest are independent variables x, y, z. The “drd” operation requires that the vector u must be written as a linear combination of basis vectors i, j, and k. Some examples and results for the “drd” operation are given in Table 3.9.

TABLE 3.9
Directional derivatives by “drd” operation

| Expressions | Results |
|---|---|
| drd; i ;x\hat{ }2*y\hat{ }3/z; x; y; z | $Q : drd ; i ; x ∧ {2}^{*} y ∧ 3 / z ; x ; y ; z \\ A : \frac{2 {xy}^{3}}{z}$ |
| drd; j; x\hat{ }2*y\hat{ }3/z; x; y; z | $Q : drd ; j ; x ∧ {2}^{*} y ∧ 3 / z ; x ; y ; z \\ A : \frac{3 {x}^{2} {y}^{3}}{z}$ |
| drd; k; x\hat{ }2*y\hat{ }3/z; x; y; z | $Q : drd ; k ; x ∧ {2}^{*} y ∧ 3 / z ; x ; y ; z \\ A : \frac{- {x}^{2} {y}^{3}}{{z}^{2}}$ |
| drd; 3*i + 4*j; exp(x*y); x; y | $Q : drd ; {3}^{*} i + {4}^{*} ; exp ( {x}^{*} y ) ; x ; y \\ A : \frac{( 4 x + 3 y ) {e}^{xy}}{5}$ |
| drd; 0.6*i +0.8*j; exp(x*y); | Q drd; 0.6*i + 0.8*j; exp(x*y); x;y |
| x; y | A: e^{xy} (0.8x + 0.6y) |
| drd; i − 2*j + 2*k; z − x\hat{ }2*y; x; y; z | $Q : drd ; i - {2}^{*} j + {2}^{*} k ; z - x ∧ {2}^{*} y ; x ; y ; z \\ A : \frac{2}{3} + ( \frac{- 2}{3} ) xy + ( \frac{2}{3} ) {x}^{2}$ |

One can verify that partial derivatives and gradient vectors can be viewed as directional derivatives, in the direction of the standard basis vectors i, j, k or coordinate axes.

For example, if f(x, y, z)=x²y³z⁻¹, get the gradient vector by “grd(x\hat{ }2*y\hat{ }3/z,x,y,z)”, whose components can be computed by directional derivatives along the coordinate axes by “drd(i,x\hat{ }2*y\hat{ }3/z,x,y,z)”, “drd(j,x\hat{ }2*y\hat{ }3/z,x,y,z)”, “drd(k,x\hat{ }2*y\hat{ }3/z,x,y,z)”, or by partial derivatives “pdv(x\hat{ }2*y\hat{ }3/z,x)”, “pdv(x\hat{ }2*y\hat{ }3/z,y)”, “pdv(x\hat{ }2*y\hat{ }3/z,z)”. Refer to the results as follows for these operations.

$$Q : grd ( x \hat{} {2}^{*} y \hat{} 3 / z , x , y , z )$$

$$A : = ( \frac{2 {xy}^{3}}{x} , \frac{3 {x}^{2} {y}^{2}}{x} , - \frac{{x}^{2} {y}^{3}}{{z}^{2}} )$$

$$\begin{matrix}Q : drd ( i , x \hat{} {2}^{*} y \hat{} 3 / z , x , y , z ) \\ A : = \frac{2 {xy}^{3}}{z}\end{matrix} \begin{matrix}Q : drd ( j , x \hat{} {2}^{*} y \hat{} 3 / z , x , y , z ) \\ A : = \frac{3 {x}^{2} {y}^{2}}{z}\end{matrix} \begin{matrix}Q : drd ( k , x \hat{} {2}^{*} y \hat{} 3 / z , x , y , z ) \\ A : = - \frac{{x}^{2} {y}^{3}}{{z}^{2}}\end{matrix}$$

$$\begin{matrix}Q : pdv ( x \hat{} {2}^{*} y \hat{} 3 / z , x ) & Q : pdv ( x \hat{} {2}^{*} y \hat{} 3 / z , y ) & Q : pdv ( x \hat{} {2}^{*} y \hat{} 3 / z , z ) \\ A : = \frac{2 {xy}^{3}}{z} & A : = \frac{3 {x}^{2} {y}^{2}}{z} & A : = - \frac{{x}^{2} {y}^{3}}{{z}^{2}}\end{matrix}$$

(4). Chain Rule for Composites of Scalar and Functions

Using the expression “chr; f(x, y, z); x; x(u, v); y; y(u, v); z; z(u, v)” or “chr(f(x, y, z), x, x(u, v), y, y(u, v), z, z(u, v))”, one can calculate the derivatives of f(x, y, z) with respect to parameters u and v, where “chr” is the operation name, “f(x, y, z)” the function expression, and the key-value pairs “x=x(u, v); y=y(u, v); z=z(u, v)” are the parametric equations. The number of variables in the “chr” operation is not necessarily three. It can be one, two, three or more. Further, the names of these independent variables and parameters are not necessarily (x, y, z) and (u, v). They can be any other variables names depending on whatever variables the function and each parametric equation have. Table 3.10 presents some examples and results for the “chr” operation.

TABLE 3.10
Chain rule for composite of scalar and vector functions by “chr” operation

| Expressions | Results |
|---|---|
| chr; x\hat{ }2 + 2*y\hat{ }2; x; | Q: chr; x\hat{ }2 + 2\hat{ }y\hat{ }2; x; r*cos(t); y; r*sin(t) |
| r*cos(t); y; r*sin(t) | A: Derivatives to [r, t] (in order) are in <2r (1 + sin (t)²), r² sin (2t)> |
| chr; x\hat{ }3 − | Q: chr; x\hat{ }3 − 2*x*y*z + z\hat{ }3; x; u +v; y; u + v; z; u*v |
| 2*x*y*z + z\hat{ }3; x; u + | A: Derivatives to [u, v] (in order) are in |
| v; y; u − v; z; u*v | <6uv − 6u²v + 3u²v³ + 3u² + 3v² + 2v³, 6uv + 6uv² + 3u³v² + 3u² − 2u³ + 3v²> |
| chr;2*x\hat{ }3 + y\hat{ }3; x; | Q: chr, 2*x\hat{ }3 + y\hat{ }3; x; cos(t); y; sin(t) |
| cos(t); y; sin(t) | A: Derivatives to [t] (in order) are in <3 (sin (t) − 2 cos (t)) sin (t) cos (t)> |
| chr; x\hat{ }2*y\hat{ }4; x; 2* | Q: chr; x\hat{ }2*y\hat{ }4; x; 2*t\hat{ }2; y; 3*(t − 2)\hat{ }3 |
| t\hat{ }2; y; 3*(t − 2)\hat{ }3 | A: Derivatives to [t] (in order) are in <t³(−2 + t)¹¹ (−2592 +5184t)> |
| chr; log(x\hat{ }2 + y\hat{ }2); x; exp(t\hat{ }2); y; exp(−t) | $Q : chr ; log ( x ∧ 2 + y ∧ 2 ) ; x ; exp ( t ∧ 2 ) ; y ; exp ( - t ) \\ A : Derivatives to [ t ] ( in order ) are in 〈 \frac{2 ( - 1 + 2 {te}^{2 t ( 1 + t )} )}{( 1 + {e}^{2 t ( 1 + t )} )} 〉$ |
| chr; u\hat{ }3*v\hat{ }2; u; | Q: chr; u\hat{ }3*v\hat{ }2; u; x + y; v; x − y |
| x + y; v; x − y | A: Derivatives to [x, y] (in order) are n <(5x − y)(x + y)(x + y)³, |
| | (x + y)²(2(−x + y)(x + y) + 3(x −y)²)> |
| chr(x\hat{ }2 − 2*y + z\hat{ }3, x, exp(t), y, log(t), z, cos(t)) | $Q : chr ( x ∧ 2 - {2}^{*} y + z ∧ 3 , x , exp ( t ) , y , log ( t ) , z , cos ( t ) ) \\ A : = ( 2 {e}^{2 t} - 3 sin ( t ) {cos}^{2} ( t ) - \frac{2}{t} , 0 , 0 )$ |
| chr(u\hat{ }3*v\hat{ }2, u, | Q: chr(u\hat{ }3*v\hat{ }2; u; x + y; v; x − y) |
| x + y, v, x − y) | A: = (5x⁴ + 4x³y − 6x²y² − 4xy³ + y⁴, x⁴ − 4x³y − 6x²y² + 4xy³ +5y⁴, 0) |

(5). Second Derivative Test, Hessian Determinant and Local Extreme Values

Suppose f(x, y) has continuous second partial derivatives in an open disk containing a critical point (x, y)=(a, b). Using “hsd; f(x, y); x; a; y; b” or “hsd(f(x, y), x, a, y, b)”, one can calculate the Hessian determinant and the second partial derivatives fₓₓ, f_{yy}, and f_{xy}, by which whether the function has a local minimum, maximum, or neither at critical point can be tested. In this operation, “hsd” is the operation name, and the values (a, b) correspond to the critical numbers “x=a” and “y=b”.

The results from the expression “hsd(f(x, y), x, a, y, b)” are expressed in the form “Di+fₓₓj+f_{yy}k”, where D is Hessian determinant, and fₓₓ and f_{yy} are the second partial derivatives. The following example explains how to use “hsd” operation to determine local extreme values.

Let f(x, y)=xy(x+2y+3). Four critical points are found by “cpt;x*y*(x+2*y+3);x;y”.

$$Q : cpt ; {x}^{*} {y}^{*} ( x + {2}^{*} y + 3 ) ; x ; y$$

$$A : Critical point ( s ) ( x , y ) = \{ ( - 3 , 0 ) , ( - 1 , - \frac{1}{2} ) , ( 0 , - \frac{3}{2} ) , ( 0 , 0 ) \}$$

Results of the second derivative test for each point by “hsd” operation are given below.

| | |
|---|---|
| “hsd; x*y*(x + 2*y + 3); | Q: hsd; x*y*(x + 2*y + 3); x; 0; y; 0 |
| x; 0; y; 0” | A: Hessian determinant = −9; |
| | fxx = 0; fyy = 0 |
| “hsd; x*y*(x + 2*y + 3); | Q: hsd; x*y*(x + 2*y + 3); x; −3; y; 0 |
| x; −3; y; 0” | A: Hessian determinant = −9; |
| | fxx = 0; fyy = −12 |
| “hsd; x*y*(x + 2*y + 3); | Q: hsd; x*y*(x + 2*y + 3); x; 0; y; −3/2 |
| x; 0; y; −3/2” | A: Hessian determinant = −9; |
| | fxx = −3; fyy = 0 |
| “hsd; x*y*(x + 2*y + 3); | Q: hsd; x*y*(x + 2*y + 3); x; −1; y; −½ |
| x; −1; y; −½” | A: Hessian determinant = 3; |
| | fxx = −1; fyy = −4 |

These results show f(x, y) has a local maximum at (−1, −1/2), where D=3, fxx=−1.

(6). Lagrange Multipliers and Optimization Subject to Constraints

Assume f(x, y) and g(x, y) are differentiable. If f(x, y) has a local extreme value on the constraint curve g(x, y)=0, one need to solve the Lagrange equations ∇f=λ∇g along with the curve g(x, y)=0 in order to determine the critical point, where ∇f and ∇g are gradient vectors for ∇gₚ a nonzero vector, and λ is some constant.

The expression “nes(grd(f(x, y), x, y)−m*grd(g(x, y), x, y)+g(x, y, z)*k)” or “les(grd(f(x, y), x, y)−m*grd(g(x, y), x, y)+g(x, y, z)*k)” is for solving a system of three equations for (m, x, y), and helps find the critical points for f(x, y) subject to the constraint g(x, y)=0, where “grd(f(x, y), x, y)−m*grd(g(x, y), x, y)” represents the Lagrange equations ∇f=m∇g, and “g(x, y)*k” is for the constraint equation g(x, y)=0. The solutions to the unknown variables (m, x, y) appear in alphabetic order.

For functions of three variables f(x, y, z) and constraints g(x, y, z)=0, one needs to get the three Lagrange equations by “grd(f(x, y, z), x, y, z)−m*grd(g(x, y, z), x, y, z)”, simplify these equations by substitution, and then use “nes” or “les” operation to solve the reduced equations and g(x, y, z)=0 at the same time for (m, x, y, z).

If there are two constraints g(x, y, z)=0 and h(x, y, z)=0, the critical points must simultaneously satisfy the three Lagrange equations ∇f=λ∇g+μ∇h and two constraint equations g(x, y, z)=0 and h(x, y, z)=0. In this case, one can use “grd(f(x,y,z), x, y, z)−m*grd(g(x,y,z), x, y, z)−n*grd(h(x,y,z), x, y, z)” to get the Lagrange equations, simplify them by substitution, and then apply “slv” or “les” or “nes” to find solutions to the system of five equations for (m, n, x, y, z). Following the same logic, one can determine critical points for functions subject to more than two constraints. The following three examples describe how to use these operations to determine critical points and extreme values subject to constraints.

Example 1: If f(x, y)=2x²+y₂ subject to the constraint x−2y=3, one can determine the critical points by two steps. First, compute the two gradients ∇f and ∇g by “grd” operation, and then solve the three equations simultaneously by “les” operation. Or one can combine “dif” and “les” operations to get the critical point (m, x, y)=(4/3, 1/3, −4/3) by “les(dif(2*x\hat{ }2+y\hat{ }2,x)−m*dif(x−2*y−3,x),dif(2*x\hat{ }2+y\hat{ }2,y)−m*dif(x−2*y−3,y),x−2*y−3)”.

$$Q : les ( dif ( {2}^{*} x \hat{} 2 + y \hat{} 2 , x ) - {m}^{*} dif ( x - {2}^{*} y - 3 , x ) , \\ dif ( {2}^{*} x \hat{} 2 + y \hat{} 2 , y ) - {m}^{*} dif ( x - {2}^{*} y - 3 , y ) , x - {2}^{*} y - 3 )$$

$$A : = ( \frac{4}{3} , \frac{1}{3} , - \frac{4}{3} )$$

One can also combine “grd” and “les” operations to determine the critical point by “les(grd(2*x\hat{ }2+y\hat{ }2,x,y)−m*grd(x−2*y−3,x,y)+(x−2*y−3)*k)”.

$$Q : les ( grd ( {2}^{*} x \hat{} 2 + y \hat{} 2 , x , y ) - {m}^{*} grd ( x - {2}^{*} y - 3 , x , y ) + {( x - {2}^{*} y - 3 )}^{*} k )$$

$$A : = ( \frac{4}{3} , \frac{1}{3} , - \frac{4}{3} )$$

Example 2: Find a point (x, y, z) on the plane 2x+3y−z=7 that is closest to the origin by “grd” and “les” operations. To minimize the distance is to minimize d²=x²+y₂+z² subject to the constraint 2x+3y−z=7. Get the gradients by “grd;x\hat{ }2+y\hat{ }2+z\hat{ }2;x;y;z” and “grd;2*x+3*y−z−7;x;y;z”.

| Q: | grd; x\hat{ }2 + y\hat{ }2 + z\hat{ }2; x; y; z | Q: | grd; 2*x + 3*y − z − 7; x; y; z |
|---|---|---|---|
| A: | [symbol] 2x, 2y, 2z [symbol] | A: | [symbol] 2, 3, −1 [symbol] |

Solve the system of equations by “les;x−m;2*y−3*m;2*z+m;2*x+3*y−z−7”. So the critical point is (1, 3/2, −1/2).

$$Q : les : x - m ; 2 * y - 3 * m ; 2 * z + m ; 2 * x + 3 \hat{} y - z - 7$$

$$A : Solve [ - m + x = 0 , - 3 m + 2 y = 0 , m + 2 z = 0 , 2 x + 3 y - z - 7 = 0 ] for ( m , x , y , z ) = ( 1 , 1 , \frac{3}{2} , - \frac{1}{2} )$$

Example 3: Determine the extreme values of x²+y₂+z² subject to the two constraints x+z=2 and x−y=4 by “grd” and “les” operations. First, get the Lagrange equations by “grd(x\hat{ }2+y\hat{ }2+z\hat{ }2,x,y,z)−m*grd(x+z−2,x,y,z)−n*grd(x−y−4,x,y)”.

Q: grd(x\hat{ }2+y\hat{ }2+z\hat{ }2,x,y,z)−m*grd(x+z−2,x,y,z)−n*grd(x−y−4,x,y)

A: =(−m−n+2x, n+2y, −m+2z)

Then solve the system of linear equations “les;2*x−m−n;2*y+n;2*z−m;x+z−2;x−y−4”. The critical point is at (x, y, z)=(2, −2, 0). Thus, the minimum value of x²+y₂+z² is 4.

Q: les;2*x−m−n;2*y+n;2*z−m;x+z−2;x−y−4

A: Solve [−m−n+2x=0, n+2y=0, −m+2z=0, x+z−2=0, x−y−4=0] for (m, n, x, y, z)=(0, 4, 2, −2, 0)

Table 3.11 displays some examples and results of finding critical points and extreme values by “grd”, “les” or “nes” operations.

TABLE 3.11
Lagrange multipliers method by “les” or “nes” and “grd” operations

| Problems | Expressions | Results |
|---|---|---|
| f(x, y) = 2x2 + y² and 8(x, y) = x − 2y − 3 | les(grd(2*x\hat{ }2 + y\hat{ }2, x, y) − m*grd(x − 2*y −3, x, y) + (x − 2*y −3 )*k) | $Q : les ( grd ( {2}^{*} x ∧ 2 + y ∧ 2 , x , y ) - {m}^{*} grd ( x - {2}^{*} y - 3 , x , y ) + {( x - {2}^{*} y - 3 )}^{*} k ) \\ A : = ( \frac{4}{3} , \frac{1}{3} , - \frac{4}{3} )$ |
| Find a point on 2x + 3y = 4 closest to the origin | les(grd(x\hat{ }2 + y\hat{ }2, x, y) − m*grd(2*x − 3*y − 4, x, y) + (2*x − 3*y −4)*k) | $Q : les ( grd ( x ∧ 2 + y ∧ 2 , x , y ) - {m}^{*} grd ( {2}^{*} x - {3}^{*} y - 4 , x , y ) + {( {2}^{*} x - {3}^{*} y - 4 )}^{*} k ) \\ A : = ( \frac{8}{13} , \frac{8}{13} , - \frac{12}{13} )$ |
| Find a point on 2x + | grd(x\hat{ }2 + y\hat{ }2 + z\hat{ }2, x, y, z) − | Q: grd(x\hat{ }2 + y\hat{ }2 + z\hat{ }2, x, y, z) − m*grd(2*x + 3*y − z −70, x, y, z) |
| 3y − z = 7 closest to | m*grd(2*x + 3*y − z − | A: = (−2m + 2x, −3m + 2y, m + 2z) |
| the origin | 70, x, y, z) | |
| | les; x −m; 2*y − | |
| | 3*m; 2*z + m; 2*x + 3*y − z − 70 | |
| Find extreme | grd(x*y*z, x, y, z) − | Q: grd(x*y*z, x, y, z) −m*grd(x + y + z − 3, x, y, z) − n*grd(x − y + z −5, x, y, z) |
| values of xyz | m*grd(x + y + z −3, x, y, z) − | A: = (−m − n + yz, − m + n + xz, − m − n + xy) |
| subject to | n*grd(x − y + z − 5, x, y, z) | |
| constrains x + y + z = | nes; y*z −m −n; x*z − | |
| 3 and x − y + z = 5 | m + n; x*y − m −n; x + y + z −3; | |
| | x − y + z −5 | |
| Find the extreme | grd(x\hat{ }2 + y\hat{ }2 + z\hat{ }2, x, y, z) − | Q: grd(x\hat{ }2 + y\hat{ }2 + z\hat{ }2, x, y, z) - m\hat{ }grd(x + z − 2, x, y, z) − n*grd(x − y −4, x, y, z) |
| values of x² + y² + | m*grd(x + z − 2, x, y, z) − | A: = (−m − n + 2x, n + 2y, − m + 2z) |
| z² subject to | n*grd(x − y −4, x, y, z) | |
| constraint x + z = 2 | les; 2*x −m −n; 2*y + n; 2*z − m; | |
| and x − y = 4 | x + z − 2; x − y − 4 | |

(4) Integrals

I. Antiderivatives and Definite Integrals

If f(x) is integrable, the expression “int(f(x), x)” or “int; f(x); x” helps find an antiderivative of f(x), where “int” is the operation name, “f(x)” the integrand expression, and “x” the variable of integration.

Integration and differentiation are inverse operations, so the effects of combing these two operations (“dif” and “int”) cancel each other, and one can verify both expressions “int(dif(f(x),x),x)” and “dif(int(f(x),x),x)” are equal to f(x) or differ by a constant.

| | | | |
|---|---|---|---|
| Q: | int(dif(f(x), x), x) | Q: | dif(int(f(x), x), x) |
| A: | = f(x) | A: | = f(x) |

Table 4.1 presents some examples and results for “dif” and “int” operations.

TABLE 4.1
Antiderivatives or indefinite integrals by “int” operation

| Expressions | Results |
|---|---|
| int(dif(x, x), x) | Q: int(dif(x, x), x) |
| | A: = x |
| dif(int(f(x), x), x) | Q: dif(int(f(x), x), x) |
| | A: = f(x) |
| dif(int(cos(x\hat{ }2), x), x) | Q: dif(int(cos(x\hat{ }2), x), x) |
| | A: = cos (x²) |
| int(x**n, x) | $Q : int ( {{x}^{*}}^{*} n , x ) \\ A : \{ \begin{matrix}\frac{{x}^{n + 1}}{n + 1} & for n \neq - 1 \\ log ( x ) & otherwise\end{matrix}$ |
| int(c*f(x), x) | Q: int(c*f(x), x) |
| | A: = c ∫ f(x) dx |
| int(f(x) + g(x), x) | Q: int(f(x) + g(x), x) |
| | A: = ∫ (f(x) + g(x)) dx |
| int(a*f(x) + b*g(x), x) − | Q: int(a*f(x) + b*g(x), x) − a*int(f(x), x) −b*int(g(x), x) |
| a*int(f(x), x) − | A: = 0 |
| b*int(g(x), x) | |
| dif(int(f(x), x) + c, x) | Q: dif(int(f(x), x) + c, x) |
| | A: = f(x) |
| int(2*dif(f(x), x), x) | Q: int(2*dif(f(x), x), x) |
| | A: = 2f(x) |
| dif(int(log(x)**2, x), x) | Q: dif(int(log(x)j**2, x), x) |
| | A: = log (x)² |
| int(dif(exp(−x), x), x) | Q: int(dif(exp(−x), x), x) |
| | A = e^{-x} |
| int(dif(2*x, x), x) | Q: int(dif(2*x, x), x) |
| | A: = 2x |
| int; atan(x) − cosh(x); x | $Q : int ; a tan ( x ) - cosh ( x ) ; x \\ A : \int - cosh ( x ) + a tan ( x ) dx = x tan ( x ) - \frac{log ( {x}^{2} + 1 )}{2} = sinh ( x )$ |

Using the expression “int(f(x), x, a, b, y, c, d, z, u, v)” or “int; f(x); x; a; b; y; c; d; z; u; v”, one can evaluate definite integrals. The expression for a simple definite integral can be “int(f(x), x, a, b)” or “int; f(x); x; a; b”, where “f(x)” is the integrand expression, “x” the integration variable, and “a; b” are two integration limits. One can write expressions for double and triple integrals in a similar fashion. Table 4.2 presents some examples and results from the “int” operation for definite integrals.

TABLE 4.2
Definite integrals by “int” operation

| Expressions | Results\| |
|---|---|
| int(c, x, a, b) | Q: int(c, x, a, b) |
| | A: = c(−a + b) |
| int(c*f(x), x, a, b) | $Q : int ( {c}^{*} f ( x ) , x , a , b ) \\ A : c {{\int }_{a}}^{b} f ( x ) dx$ |
| int; abs(x); x; −2; 3 | $Q : int ; abs ( x ) x ; - 2 ; 3 \\ A : {\int }_{- 2}^{3} abs ( x ) dx = \frac{13}{2}$ |
| int(f(x) + g(x), x, a, b) − | Q: int(f(x) + g(x), x, a, b) − int(f(x), x, a, b) − int(g(x), x, a, b) |
| int(f(x), x, a, b) − int(g(x), x, a, b) | A: = 0 |
| int(f(x), x, a, a) | Q: int(f(x), x, a, a) |
| | A: = 0 |
| int(x, x, a, c) − int(x, x, a, b) − | Q: int(x, x, a, c) −int(x, x, a, b) − int(x, x, b, c) |
| int(x, x, b, c) | A: = 0 |
| int(x**2, x, a, b) + int(x**2, x, b, a) | Q: int(x**2, x, a, b) + int(x**2, x, b, a) |
| | A: = 0 |
| int; 1/log(x)**(1/3); x; e; oo | $Q : int ; 1 / {log ( x )}^{**} ( 1 / 3 ) ; x ; e ; oo \\ A : {\int }_{e}^{∞} \frac{1}{\sqrt[3]{log ( x )}} dx = {{\int }_{e}}^{∞} \frac{1}{\sqrt[3]{log ( x )}} dx$ |
| int; r*h; r; 0; a; t; 0; 2*pi | Q: int; r*h; r; 0; a; t; 0; 2*pi |
| | A: ∫ₑ^{^{2π}} ∫₀^{^{a}} hrdrdt = πa²h |
| int; r**2*sin(s); r; 0; 2*a*cos(s); s; 0; pi/4; t; 0; 2*pi | $Q : int ; {2}^{⋆} sin ( s ) ; r ; 0 ; {2}^{⋆} {a}^{⋆} cos ( s ) ; s ; 0 ; pi / 4 ; t ; 0 ; {2}^{⋆} pi \\ A : {\int }_{0}^{2 π} {\int }_{0}^{\frac{π}{4}} {\int }_{0}^{2 a cos ( s )} {r}^{2} sin ( s ) drdsdt = π {a}^{3}$ |
| int; 2*(a**2 − r**2)**(1/2)*r; r; 0; a; t; 0; 2*pi | $Q : int ; {2}^{*} {( {a}^{**} 2 - {r}^{**} 2 )}^{**} {( 1 / 2 )}^{*} r ; r ; 0 ; a ; t ; 0 ; {2}^{*} pi \\ A : {\int }_{0}^{2 π} {\int }_{0}^{a} 2 r \sqrt{{a}^{2} - {r}^{2}} drdt = \frac{4 {πa}^{2} \sqrt{{a}^{2}}}{3}$ |
| int; z; z; x + y; x*y; y; x; x**2; x; 0; 1 | $Q : int ; z ; z ; x + y ; {x}^{*} y ; y ; x ; {x}^{**} 2 ; x ; 0 ; 1 \\ A : {\int }_{0}^{1} {\int }_{x}^{{x}^{2}} {\int }_{x + y}^{xy} zdzdydx = \frac{569}{7560}$ |
| int; z; z; cos(x + y); sin(x − y); y; x; 0; x; 0; pi/4 | $Q : int ; z ; z ; cos ( x + y ) ; sin ( x - y ) ; y ; x ; 0 ; x ; 0 ; pi / 4 \\ A : {\int }_{0}^{\frac{π}{4}} {\int }_{x}^{0} {\int }_{cos ( z + y )}^{sin ( x - y )} zdzdydx = \frac{1}{16}$ |
| int; z; z; x + y; 2*x + 3*y; x; 0; 3; y; 1; 4 | $Q : int ; z ; z ; x + y ; {2}^{*} x + {3}^{*} y ; x ; 0 ; 3 ; y ; 1 ; 4 \\ A : {\int }_{1}^{4} {\int }_{0}^{3} {\int }_{x + y}^{2 x + 3 y} zdzdxdy = \frac{1845}{4}$ |
| int; x; z; x − y; 2*x + 3*y; y; 0; x; x; −2; 3 | $Q : int ; x ; z ; x - y ; {2}^{*} x + {3}^{*} y ; y ; 0 ; x ; x ; - 2 ; 3 \\ A : {\int }_{- 2}^{3} {\int }_{0}^{x} {\int }_{x - y}^{2 x + 3 y} xdzdydx = \frac{195}{4}$ |
| int; x − y; x; 2*z; 3*y; y; −z; 0; z; 0; 1 | $Q : int ; x - y ; x ; {2}^{*} z ; {3}^{*} y ; y ; - z ; 0 ; 0 ; 1 \\ A : {\int }_{0}^{1} {\int }_{- z}^{0} {\int }_{2 z}^{3 y} x - ydxdydz = - \frac{5}{8}$ |
| int(y\hat{ }2, y, 0, 1 −x\hat{ }2, x, −1, 1)/ int(y, y, 0, 1 − x\hat{ }2, x, −1 , 1) | $Q : int ( y ∧ 2 , y , 0 , 1 - x ∧ 2 , x , - 1 , 1 ) / int ( y , y , 0 , 1 - x ∧ 2 , x , - 1 , 1 ) \\ A : = \frac{4}{7}$ |
| log(x)= =int(1/t, t, 1,x) | Q log(x)= =int(1/t, t, 1, x) |
| | A: = True |

II. Numerical Integration

The expression “nit(f(x), x, a, b, n)” or “nit; f(x); x; a; b; n” helps approximate definite integrals by Riemann sum (e.g., Simpson's approach), where “f(x)” is the integrand, “x” the integration variable, “n” the number of partitions, and “a; b” are two integration limits. Table 4.3 presents some examples and results for the “nit” operation.

TABLE 4.3
Numerical integration by “nit” operation

| Expressions | Results |
|---|---|
| nit; cos(x**2); | Q: nit; cos(x**2); x; 0; 3; 20 |
| x; 0; 3; 20 | A: Simpson = 0.7029; Trapezoidal = 0.6982; |
| | Midpoints = 0.7053; Right endpoints = 0.5548; |
| | Left endpoints = 0.8415 |
| nit((1 + | Q: nit((1 + x**2)**( 1 /2), x, 0, 2, 20) |
| x**2)**(½), | A: = 2.9579 |
| x, 0, 2, 20) | |
| nit; exp(−x**3); | Q: nit; exp(−x**3); x; 0; 2; 20 |
| x; 0; 2; 20 | A: Simpson = 0.893; Trapezoidal = 0.893; |
| | Midpoints = 0.893, Right endpoints = 0.843; |
| | Left endpoints = 0.9429 |
| nit; (1 + x**3); | Q: nit; (1 + x**3); x; −1; 2; 20 |
| x; −1; 2; 20 | A: Simpson = 6.75; Trapezoidal = 6.7669; |
| | Midpoints = 6.7416; Right endpoints = 7.4419; |
| | Left endpoints = 6.0919 |
| nit(sin(x**2), | Q: nit(sin(x**2), x, 0, 1, 20) |
| x, 0, 1, 20) | A: = 0.3103 |

III. Operations on Area Functions or Functions Defined by Integrals

Area functions are defined by integrals, and one can find their derivatives, partial derivatives, or limits by combining the “dif”, “pdv”, or “lim” with “int” operations. Table 4.4 presents some examples and results for operations among area functions.

TABLE 4.4
Operation on functions defined by integrals by “dif”, “pdv”, “lim” and “int”

| Expressions | Results |
|---|---|
| dif(int(f(t), t, a, h(x)), x) | $Q : dif ( int ( f ( t ) , t , a , h ( x ) ) , x ) \\ A : f ( h ( x ) ) \frac{d}{dx} h ( x )$ |
| dif(int(f(t), t, u(x), h(x)), x) | $Q : dif ( int ( f ( t ) , t , u ( x ) , h ( x ) ) , x ) \\ A : - f ( h ( x ) ) \frac{d}{dx} h ( x ) - f ( u ( x ) ) \frac{d}{dx} u ( x )$ |
| dif(int(f(t), t, b, −x), x) | Q: dif(int(f(t), t, b, −x), x) |
| | A: = −f(−x) |
| dif(int(f(t), t, −x, x), x) | Q: dif(int(f(t), t, −x, x), x) |
| | A: = f(−x) + f(x) |
| int(dif(exp(y/x)/x, y), x, 1,2) | $Q : int ( dif ( exp ( y / x ) / x , y ) , x , 1 , 2 ) \\ A : = \{ \begin{matrix}\frac{( {e}^{\frac{y}{2}} - 1 ) {e}^{\frac{y}{2}}}{y} & for y > - ∞ ∧ y < ∞ ∧ y \neq 0 \\ \frac{1}{2} & otherwise\end{matrix}$ |
| lim(int(exp(t**2 − | Q: lim(int(exp(t**2 −1), t, 1, 1 + h)/h, h, 0) |
| 1), t, 1, 1 + h)/h, h, 0) | A: = 1 |
| lim(int(exp(t**2 − | Q: lim(int(exp(t**2 −1), t, a, a + h)/h, h, 0) |
| 1), t, a, a + h)/h, h, 0) | A: = e^{a}^{²}⁻¹ |
| dif(int(f(x, y), y, a, b), x) − | Q: dif(int(f(x, y), y, a, b), x) − int(dif(f(x, y), x),y, a, b) |
| int(dif(f(x, y), x), y, a, b) | A: = 0 |
| int(dif(f(x, y), x), y, a, b) | $Q : int ( dif ( f ( x , y ) , x ) , y , a , b ) \\ A : {{\int }_{a}}^{b} \frac{\partial }{\partial z} f ( x , y ) dy$ |
| int(dif(f(x, y), x), y, a, b) | $Q : int ( dif ( f ( x , y ) , x ) , y , a , b ) \\ A : {{\int }^{b}}_{a} \frac{\partial }{\partial x} f ( x , y ) dy$ |
| dif(int(f(t), t, x, y), x, 2) | $Q : dif ( int ( f ( t ) ) , t , x , y ) x , 2 ) \\ A : = - \frac{d}{dx} f ( x )$ |
| pdv(int(f(x, y, z), z, a, b), x, y) | $Q : pdv ( int ( f ( x , y , z ) , z , a , b ) , x , y ) \\ A : = {{\int }^{b}}_{a} \frac{{\partial }^{2}}{\partial y \partial x} f ( x , y , z ) dz$ |
| dif(int(f(x, y, z), z, a, b), y, 2) | $Q : dif ( int ( f ( x , y , z ) , z , a , b ) , y , 2 ) \\ A : = {{\int }^{b}}_{a} \frac{{\partial }^{2}}{\partial {y}^{2}} f ( x , y , x ) dz$ |
| dif(int(f(x, y, z), z, a, b), x) | $Q : dif ( int ( f ( x , y , z ) , z , a , b ) , x ) \\ A : {{\int }^{b}}_{a} \frac{\partial }{\partial x} f ( x , y , z ) dz$ |
| dif(int(f(t), t, x, y), y, 2) | $Q : dif ( int ( f ( t ) , t , x , y ) , y , 2 ) \\ A : = \frac{d}{dy} f ( y )$ |
| dif(int(f(t), t, x, y), y) | Q: dif(int(f(t), t, x, y), y) |
| | A = f (y) |
| dif(int(f(t), t, x, y), x) | Q: dif(int(f(t), t, x, y), x) |
| | A: = −f(x) |

IV. Jacobian Determinant for Transformation

The expression “jcb; x(u,v,w)*i+y(u,v,w)*j+z(u,v,w)*k; u; v; w” or “jcb(x(u,v,w)*i+y(u,v,w)*j+z(u,v,w), u, v, w)” calculates the Jacobian determinant for a general transformation J(u, v, w), whose components are expressed as a linear combination of basis vectors i, j, k. The first partial derivatives are taken with respect to parameters u, v, w of the transformation. Table 4.5 gives some examples and results for the “jcb” operation.

TABLE 4.5
Jacobian determinant for transformation by “jcb” operation

| Problems | Expressions | Results |
|---|---|---|
| J(u, v) = [symbol] u − 2v, | jcb((u − 2*v)*i + | Q: jcb((u − 2*v)*i + (3*u + v)*j, u, v) |
| 3u + v [symbol] | (3*u + v)*j, u, v) | A: = 7 |
| J(u, v) = [symbol] 2u − | jcb; (2*u − 3*v)*i + | Q: jcb; (2*u − 3*v)*i + u*v*j; u; v |
| 3v, uv [symbol] | u*v*j; u; v | A: Jacobian = 2u + 3v |
| J(r, s, t) = | jcb(r*sin(s)*cos(2*t)*i + | Q: jcb(r*sin(s)*cos(2*t)*i + r*cos(2*s)*sin(t)*j + |
| [symbol] r*sin(s)cos(2*t), | r*cos(2*s)*sin(t)*j + | r*cos(2*s)*k, r, s, t) |
| r*cos(2*s)sin(t), | r*cos(2*s)*k, r, s, t) | A: = r² (2 − cos (2s)) cos (s) cos (2s) cos (t) cos (2t) |
| r*cos(2*s) [symbol] | | |
| x = rcos(t), | jcb; r*cos(t)*i + | Q: jcb; r*cos(t)*i + r*sin(t)*j; r; t |
| y = rsin(t) | r*sin(t)*j; r; t | A: Jacobian = r |
| x = rcos(t), y = | jcb; r*cos(t)*i + | Q: jcb; r*cos(t)*i + r*sin(t)*j + z*k; r; t; z |
| rsin(t), z = z | r*sin(t)*j + z*k; r; t; z | A: Jacobian = r |
| x = rsin(s)cos(t), | jcb; r*sin(s)*cos(t)*i + | Q: jcb; r*sin(s)*cos(t)*i + r*sin(s)*sin(t)*j + |
| y = rsin(s)sin(t), | r*sin(s)*sin(t)*j + | r*cos(s)*k; r; s; t |
| z = rcos(s) | r*cos(s)*k; r; s; t | A: Jacobian = r² sin (s) |

V. Line and Surface Integrals

The expression “lit; f(x,y,z); x(t)i+y(t)j+z(t)k; t; a; b; x; y; z” or “lit(f(x, y, z), x(t)i+y(t)j+z(t)k, t, a, b, x, y, z)” helps evaluate scalar line integrals, where “lit” is the operation name, “f(x, y, z)” the scalar function, “x(t), y(t)” and “z(t)” are component functions of a vector parametrization r(t)=(x(t), y(t), z(t)) for the curve, “t” is the parameter, “a; b” is the interval [a, b] of parameter “t”, and “x; y; z” are the component names of r(t). The operation requires the order of the names “x; y; z” of r(t) should exactly match the parametrization r(t)=x(t)i+y(t)j+z(t)k, or parametric equations x=x(t), y=y(t), z=z(t).

If f(x, y, z)=1, the expression “lit; 1; x(t)*i+y(t)*j+z(t)*k; t; a; b” of line integral calculates the arc length of the curve r(t)=(x(t), y(t), z(t)) for a≤t≤b.

Replacing “f(x, y, z)” in the expression for scalar line integral with a vector field F, one has the expression “lit; F; x(t)i+y(t)j+z(t)k; t; a; b; x; y; z” or “lit(F, x(t)i+y(t)j+z(t)k, t, a, b, x, y, z)” for evaluating vector line integrals. The expression of the field F must be written as a linear combination of basis vectors i, j, and k. Table 4.6 presents some examples and results on line integrals by “lit” operation.

TABLE 4.6
Line integrals by “lit” operation

| Expressions | Results |
|---|---|
| lit; x − y**2; 3*t*i − 2*j; t; 0; 2; x; y | Q: lit; x − y**2; 3*t*i − 2*j; t; 0; 2; x; y |
| | $A : {\int }_{c} x - {y}^{2} ds = - 6$ |
| lit; x**2 + y**2 + z**2; cos(t)*i + | Q: lit; x**2 + y**2 + z**2; cos(t)*i + 2*t*j + sin(t)*k; t; 0; 2; x; y; z |
| 2*t*j + sin(t)*k; t; 0; 2; x; y; z | $A : {\int }_{c} {x}^{2} + {y}^{2} + {z}^{2} ds = \frac{38 \sqrt{5}}{3}$ |
| lit; −y*i + x**2*j; t*i + | Q: lit; −y*i + x**2*j; t*i + t**2*j; t; 0; 2; x; y |
| t**2*j; t; 0; 2; x; y | $A : {\int }_{c} - ydx + {x}^{2} dy = \frac{16}{3}$ |
| lit; 1; cos(t)*i + sin(t)*j; | Q: lit; 1; cos(t)*i + sin(t)*j; t; 0; 2*pi |
| t; 0; 2*pi | $A : {\int }_{c} 1 ds = 2 π$ |
| lit; 1; cos(t)*i + sin(t)*j + t*k; | Q: lit; 1; cos(t)*i + sin(t)*j + t*k; t; 0; pi |
| t; 0; pi | $A : {\int }_{c} 1 ds = \sqrt{2} π$ |
| lit; x**3; t*i + t**3*j/3; | Q: lit; x**3; t*i + t**3*j/3; t; 0; 1; x |
| t; 0; 1; x | $A : {\int }_{c} {x}^{3} ds = \frac{1}{6} + \frac{\sqrt{2}}{3}$ |
| lit; x*i + 2*y*j; t*i + t**2*j; | Q: lit; x*i + 2*y*j; t*i + t**2*j; t; 0; 1; x; y |
| t; 0; 1; x; y | $A : {\int }_{c} xdx + 2 ydy = \frac{3}{2}$ |
| lit; −y*i + x*j; (t-sin(t))*i + | Q: lit; −y*i + x*j; (t-sin(t))*i + (1-cos(t))*j; t; 2*pi; 0; x; y |
| (1-cos(t))*j; t; 2*pi; 0; x; y | $A : {\int }_{c} - ydx + xdy = 6 π$ |
| lit; (+y*i + x*j)/(x**2 + y**2); | Q: lit; (+y*i + x*j)/(x**2 + y**2); cos(t)*i + sin(t)*j; t; 0; 2*pi; x; y |
| cos(t)*i + sin(t)*j; t; 0; 2*pi; x; y | $A : {\int }_{c} \frac{- y}{( {x}^{2} + {y}^{2} )} dx + \frac{x}{( {x}^{2} + {y}^{2} )} dy = 2 π$ |
| lit; (x**2*y − 1)*i + (y**2 + 3*x)*j; | Q: lit; (x**2*y − 1)*i + (y**2 + 3*x)*j;t**2*i + t*j; t; 1; 0; x; y |
| t**2*i + t*j; t; 1; 0; x; y | $A : {\int }_{c} - 1 + {x}^{2} ydx + 3 x + {y}^{2} dy = - \frac{13}{21}$ |

Let r(u,v) be a parametrization of a surface S defined in a parameter domain D. The P expression “sit; f(x,y,z); x(u,v)*i+y(u,v)*j+z(u,v)*k; u; a; b; v; c; d; x; y; z” or “sit(f(x,y,z), x(u,v)*i+y(u,v)*j+z(u,v)*k, u, a, b, v, c, d, x, y, z)” helps evaluate the scalar surface integrals, where “f(x, y, z)” is the scalar function, r(u,v)=“x(u,v)i+y(u,v)j+z(u,v)k” is a surface parametrization, “u” and “v” are parameters for “u” in the interval [a, b] and “v” in [c, d]. The operation requires the names “x; y; z” in order, because they are not only independent variables of the function “f(x, y, z)”, but also the component functions that define the parametric equations x=x(u, v), y=y(u, v), z=z(u, v) for the surface.

In a similar fashion, the expression “sit; F; r(u, v); u; a; b; v; c; d; x; y; z” or “sit(F, r(u, v), u, a, b, v, c, d, x, y, z)” helps evaluate vector surface integrals, where “sit” is the operation name, “F” represents the expression of the vector field, “r(u,v)=x(u,v)i+y(u,v)j+z(u,v)k” a surface parametrization, “u, v” are the parameters for u in the interval [a, b] and v in [c, d], and “x; y; z” are the names of component functions for the surface parametrizations. The names “x; y; z” in order are not only intendent variables of the vector field F, but also components functions that define the equations x=x(u, v), y=y(u, v), z=z(u, v) for the surface.

The “sit” operation on vector surface integral requires the intervals “u; a; b; v; c; d” (in order) correspond to the positive surface orientation, and “v; c; d; u; a; b” to negative surface orientation. Table 4.7 presents some examples and results for the “sit” operation.

TABLE 4.7
Surface integrals by “sit” operation

| Problems | Expressions | Results |
|---|---|---|
| f(x, y, z) = x + 2y − 3z, | sit; x + 2*y − 3*z; | Q: sit; x + 2*y − 3*z; cos(u)*i + sin(u)*j + v*k; u; 0; 2*pi; v; 0; 4; x; y; z |
| r(u, v) = cos(u)i + sin(u)j + vk, 0 ≤ u ≤ 2π, 0 ≤ v ≤ 4 | cos(u)*i + sin(u)*j + v*k; u; 0; 2*pi; v; 0; 4; x; y; z | $A : {\int \int }_{s} x + 2 y - 3 zd S = - 48 π$ |
| A sphere of radius 1 | sit; 1; sin(s)*cos(t)*i + | Q: sit; 1; sin(s)*cos(t)*i + sin(s)*sin(t)*j + cos(s)*k; s; 0; pi; t; 0; 2*pi |
| has surface area 4π | sin(s)*sin(t)*j + cos(s)*k; s; 0; pi; t; 0; 2*pi | $A : {\int \int }_{s} 1 d S = 4 π$ |
| surface integral over | sit; 1; 4*cos(t)*i + | Q: sit; 1; 4*cos(t)*i + 4*sin(t)*j + z*k; t; 0; 2*pi; z; 0; 3 |
| the cylinder (side) x2 + y2 = 16 from z = 0 to z = 3 | 4*sin(t)*j + z*k; t; 0; 2*pi; z; 0; 3 | $A : {\int \int }_{s} 1 d S = 24 π$ |
| S be the disk x² + | sig; i; r*cos(t)*i + | Q: sig; i; r*cos(t)*i + r*sin(t)*j; r; 0; 3; t; 0; pi*2 |
| y² ≤ 9, F = [symbol] 1, 0, 0 [symbol] | r*sin(t)*j; r; 0; 3; t; 0; pi*2 | $A : {\int \int }_{s} 〈 1 , 0 , 0 〉 \cdot dS = 0$ |
| F = [symbol] 0, 2, 0 [symbol] | sit; 2*j; r*cos(t)*i + | Q: sit; 2*j; r*cos(t)*i + r*sin(t)*j; r; 0; 3; t; 0; pi*2 |
| | r*sin(t)*j; r; 0; 3; t; 0; pi*2 | $A : {\int \int }_{s} 〈 0 , 2 , 0 〉 \cdot dS = 0$ |
| F = [symbol] 0, 0, 1 [symbol] | sit; k; r*cos(t)*i + | Q: sit; k; r*cos(t)*i + r*sin(t)*j; r; 0; 3; t; 0; pi*2 |
| | r*sin(t)*j; r; 0; 3; t; 0; pi*2 | $A : {\int \int }_{s} 〈 0 , 0 , 1 〉 \cdot dS = 9 π$ |
| F = [symbol] 2, 3, 4 [symbol] | sit; 2*i + 3*j + 4*k; | Q: sit; 2*i + 3*j + 4*k; r*cos(t)*i + r*sin(t)*j; r; 0; 3; t; 0; pi*2 |
| | r*cos(t)*i + r*sin(t)*j; r; 0; 3; t; 0; pi*2 | $A : {\int \int }_{s} 〈 2 , 3 , 4 〉 \cdot dS = 36 π$ |

(5) Infinite Series

I. Finite and Infinite Sum

The expression “ism; f(n); n; n1; oo” or “ism(f(n), n, n1, ∞)” helps calculate the infinite sum of f(n) for n from n1 to infinity, which is represented by “oo”. In this operation, “f(n)” is the expression of the nth term, and “n” is a variable for whole numbers.

Replacing “oo” in the above expression with “m”, another variable for whole numbers, one gets the operation for a finite sum of f(n) from n1 to m. The expression for this operation becomes “ism; f(n); n; n1; m” or “ism(f(n), n, n1, m)”, which would return a formula or function of “m” for the sum.

For a finite sum of f(n) from n1 to m1, the expression becomes “ism; f(n); n; n1; m; m1” or “ism(f(n), n, n1, m, m1)”, which would return a finite number.

Adding a keyword “cv” to “ism; f(n); n; n1; oo” to the end, one has the expression “ism; f(n); n; n1; oo; cv” or “ism(f(n), n, n1, oo, cv)” that returns True if the sum converges and False otherwise. Replacing “cv” with “ac”, one gets the expression “ism; f(n); n; n1; oo; ac” or “ism(f(n), n, n1, oo, ac)” that returns True if the sum converges absolutely and False otherwise.

In addition to ratio test, one can use “ism; f(x, n); n; n1; oo” or “ism(f(x, n), n, n1, ∞)” to determine the radius and possible convergence interval for a series f(x, n). Table 5.1 presents some examples and results for the above “ism” operations.

TABLE 5.1
Finite and infinite sum, convergence interval by “ism“ operation

| Expressions | Results |
|---|---|
| ism; (j − 3)**2; j; 5; m; 9 | Q: ism; (j − 3)**2; j; |
| | $A : {\sum }_{j = 5}^{9} {( j - 3 )}^{2} = 90$ |
| ism; a; i; 1; n | Q: ism; a; i; 1; n |
| | $A : {\sum }_{i = 1}^{n} a = an$ |
| ism; i; i; 1; n | Q: ism; i; i; 1; n |
| | $A : {\sum }_{i = 1}^{n} i = \frac{{n}^{2}}{2} + \frac{n}{2}$ |
| ism; i**2; i; 1; n | Q: ism; i**2; i; 1; n |
| | $A : {\sum }_{i = 1}^{n} {i}^{2} = \frac{{n}^{2}}{3} + \frac{{n}^{2}}{2} + \frac{n}{6}$ |
| ism; i**3; i; 1; n | Q: ism; i**3; i; 1; n |
| | $A : {\sum }_{i = 1}^{n} {i}^{3} = \frac{{n}^{4}}{4} + \frac{{n}^{3}}{2} + \frac{{n}^{2}}{4}$ |
| ism; i**4; i; 1; n | Q: ism; i**4; i; 1; n |
| | $A : {\sum }_{i = 1}^{n} {i}^{4} = \frac{{n}^{5}}{5} + \frac{{n}^{4}}{2} + \frac{{n}^{3}}{3} - \frac{n}{30}$ |
| ism; 5; i; 1; n; 10 | Q: ism; 5; i; 1; n; 10 |
| | $A : {\sum }_{i = 1}^{10} 5 = 50$ |
| ism; (−0.8)**i; i; 0; n; 500 | Q: ism; (−0.8)**i; i; 0; n; 500 |
| | $A : {\sum }_{i = 0}^{500} {( - 0.8 )}^{i} = 0.555555555555556$ |
| ism; (−1)**i; i; 0; n; 10 | Q: ism; (−1)**i; i; 0; n; 10 |
| | $A : {\sum }_{i = 0}^{10} {( - 1 )}^{i} = 1$ |
| ism; i**2; i; 1; n; 100 | Q: ism; i**2; i; 1; n; 100 |
| | $A : {\sum }_{i = 1}^{100} {i}^{2} = 338350$ |
| ism; 1/(2*n + 1) − 1/(2*n + 3); n; 0; m; 50 | Q: ism; 1/(2*n + 1) − 1/(2*n + 3); n; 0; m; 50 |
| | $A : {\sum }_{n = 0}^{50} \frac{2}{( 2 n + 1 ) ( 2 n + 3 )} = \frac{102}{103}$ |
| ism; i**3; i; 1; n; 500 | Q: ism; i**3; i; 1; n; 500 |
| | $A : {\sum }_{i = 1}^{500} {i}^{8} = 15687562500$ |
| ism; (−8.2)**i; i; 1; n | Q: ism; (−8.2)**i; i; 1; n |
| | $A : {\sum }_{i = 1}^{n} {( - 8.2 )}^{i} = - 0.108695652173913 {( - 8.2 )}^{n + 1} - 0.891304347826087$ |
| ism; (−1)**n*2**(2*n)/gamma(2*n + 1); n; | Q: ism; (−1)**n*2**(2*n)/gamma(2*n + 1); n; 0; oo |
| 0; oo | $A : {\sum }_{n = 0}^{∞} \frac{{( - 4 )}^{n}}{Γ ( 2 n + 1 )} = cos ( 2 )$ |
| ism; n**(−1.5); n; 1; oo | Q: ism; n**(−1.5); n; 1; oo |
| | $A : {\sum }_{n = 1}^{∞} {n}^{- 1.5} = 2.61237534868549$ |
| ism; 1/gamma(n + 1); n; 0; oo | Q: ism; 1/gamma(n + 1); n; 0; oo |
| | $A : {\sum }_{n = 1}^{∞} {n}^{- 1.5} = 2.61237534868549$ |
| ism; n**(−2/3); n; 1; oo | Q: ism; n**(−2/3); n; 1; oo |
| | $A : {\sum }_{n = 0}^{∞} \frac{1}{{n}^{\frac{2}{3}}} = {\sum }_{n = 1}^{∞} \frac{1}{{n}^{\frac{2}{3}}}$ |
| ism; 1/n; n; 1; oo; cv | Q: ism; 1/n; n; 1; oo; cv |
| | ${\sum }_{n = 1}^{∞} \frac{1}{n} = False$ |
| ism; (−1)\hat{ }n/(n + 1); n; 0; oo; ac | Q: ism; (−1)\hat{ }n/(n + 1); n; 0; oo; ac |
| | $A : {\sum }_{n = 0}^{∞} \frac{{( - 1 )}^{n}}{n + 1} = False$ |
| ism; 2**n/gamma(n + 1); n; 0; oo; cv | Q: ism; 2**n/gamma(n + 1); n; 0; oo; cv |
| | $A : {\sum }_{n = 0}^{∞} \frac{{2}^{n}}{Γ ( n + 1 )} = True$ |
| ism; (−1)**n*1/n**2; n; 1; oo; ac | Q: ism; (−1)**n*1/n**2; n; 1; oo; ac |
| | $A : {\sum }_{n = 1}^{∞} \frac{{( - 1 )}^{n}}{{n}^{2}} = True$ |
| ism; 1/n**(1/2); n; 1; oo; ac | Q: ism; 1/n**(1/2); n; 1; oo; ac |
| | $A : {\sum }_{n = 1}^{∞} \frac{1}{\sqrt{n}} = False$ |
| ism; x\hat{ }(2*n)/gamma(n + 1); n; 0; oo | Q: ism; x\hat{ }(2*n)/gamma(n + 1); n; 0; oo |
| | $A : {\sum }_{n = 0}^{∞} \frac{{x}^{2 n}}{Γ ( n + 1 )} = {e}^{{x}^{2}}$ |
| ism; 5*(x/4)\hat{ }n; n; 0; oo | Q: ism; 5*(x/4)\hat{ }n; n; 0; oo |
| | $A : {\sum }_{n = 0}^{∞} 5 {( \frac{x}{4} )}^{n} = 5 ( \{ \begin{matrix}\frac{1}{1 - \frac{x}{4}} & for \frac{\vert x \vert}{4} < 1 \\ {\sum }_{n = 0}^{∞} {4}^{- n} {x}^{n} & otherwise\end{matrix} )$ |
| ism; x**n/gamma(n + 1); n; 0; oo | Q: ism; x**n/gamma(n + 1); n; 0; oo |
| | $A : {\sum }_{n = 0}^{∞} \frac{{x}^{n}}{Γ ( n + 1 )} = {e}^{x}$ |
| ism; (−1)**n*x**(2*n + 1)/gamma(2*n + 2); | Q: ism; (−1)**n*x**(2*n + 1)/gamma(2*n + 2); n; 0; oo |
| n; 0; oo | $A : {\sum }_{n = 0}^{∞} \frac{{( - 1 )}^{n} {x}^{2 n + 1}}{Γ ( 2 n + 2 )} = sin ( x )$ |

II. Taylor Series Expansion and Approximation

The expression “ses; f(x); x; c; N; n/p” or “ses(f(x), x, c, N, n/p)” expands a function f(x) about center x=c as a power series, where “x” is the independent variable, “N” the number of terms, ‘p’=‘+’ or ‘n’=‘−’ (positive or negative) is the direction. By default, c=0, N=5, and the direction is ‘p’ (positive).

The expression “ses; f(x); x; c; N; n/p; x₀” or “ses(f(x), x, c, N, n/p, x₀)” helps approximate the value of f(c+x₀) by Taylor polynomials. Table 5.2 presents some examples and results for the “ses” operation.

TABLE 5.2
Taylor series expansion and approximation by “ses” operation

| Expressions | Results |
|---|---|
| ses; (1 + x)**(1/2); x; | Q: ses; (1 + x)**(1/2); x; 0; 10 |
| 0; 10 | $A : \sqrt{x + 1} = 1 + \frac{x}{2} - \frac{{x}^{2}}{8} + \frac{{x}^{3}}{16} - \frac{5 {x}^{4}}{128} + \frac{7 {x}^{5}}{256} - \frac{21 {x}^{6}}{1024} + \frac{33 {x}^{7}}{2048} - \frac{429 {x}^{8}}{32768} + \frac{715 {x}^{9}}{65536} + O ( {x}^{10} )$ |
| ses(sin(x)/exp(x), x, | Q: ses(sin(x)/exp(x), x, 0, 10) |
| 0, 10) | $A : = x ( \frac{{x}^{8}}{22680} - \frac{{x}^{0}}{630} + \frac{{x}^{5}}{90} - \frac{{x}^{4}}{30} + \frac{{x}^{2}}{3} - x + 1 )$ |
| ses; (1 − x**2)**(1/2); | Q: ses; (1 − x**2)**(1/2); x; 0; 10 |
| x; 0; 10 | $A : \sqrt{1 - {x}^{2}} = 1 - \frac{{x}^{2}}{2} - \frac{{x}^{4}}{8} - \frac{{x}^{6}}{16} - \frac{5 {x}^{8}}{128} + O ( {x}^{10} )$ |
| ses; sin(x); x; 0; 10 | Q: ses; sin(x); x; 0; 10 |
| | $A : sin ( x ) = x - \frac{{x}^{3}}{0} + \frac{{x}^{5}}{120} - \frac{{x}^{7}}{5040} + \frac{{x}^{9}}{362880} + O ( {x}^{10} )$ |
| ses; 2**x; x | Q: ses; 2**x; x |
| | $A : {2}^{x} = 1 + x log ( 2 ) + \frac{{x}^{2} log {( 2 )}^{2}}{2} + \frac{{x}^{3} log {( 2 )}^{3}}{6} + \frac{{x}^{4} log {( 2 )}^{4}}{24} + \frac{{x}^{5} log {( 2 )}^{5}}{120} + O ( {x}^{6} )$ |
| ses(exp(x)*cos(x), x, | Q: ses(exp(x)*cos(x), x, 0, 10) |
| 0, 10) | $A : = \frac{{x}^{9}}{22680} + \frac{{x}^{8}}{2520} + \frac{{x}^{7}}{630} - \frac{{x}^{5}}{30} - \frac{{x}^{4}}{6} - \frac{{x}^{3}}{3} + x = 1$ |
| ses; sinh(x); x | Q: ses; sinh(x); x |
| | $A : sinh ( x ) = x + \frac{{x}^{3}}{6} + \frac{{x}^{5}}{120} + O ( {x}^{6} )$ |
| ses; x**(1/2); x; 2; 8 | Q: ses; x**(1/2); x; 2; 8 |
| | $\begin{matrix}A : \sqrt{x} = \sqrt{2} + \frac{\sqrt{2} ( x \cdot 2 )}{4} - \frac{\sqrt{2} {( x \cdot 2 )}^{2}}{32} + \frac{\sqrt{2} {( x \cdot 2 )}^{3}}{128} - \frac{5 \sqrt{2} {( x - 2 )}^{4}}{2048} - \frac{7 \sqrt{2} {( x - 2 )}^{5}}{8192} + \frac{21 \sqrt{2} {( x - 2 )}^{6}}{85536} + \frac{33 \sqrt{2} {( x \cdot 2 )}^{7}}{262144} + \\ O ( {( x - 2 )}^{8} ; x \to 2 )\end{matrix}$ |
| ses; sin(x)/x; x | Q: ses; sin(x)/x; x |
| | $A : \frac{sin ( x )}{x} = 1 - \frac{{x}^{2}}{6} + \frac{{x}^{4}}{120} + O ( {x}^{6} )$ |
| ses; tan(x); x; pi/6 | Q: ses; tan(x); x; pi/6 |
| | $A : tan ( x ) = \frac{\sqrt{3}}{3} - \frac{2 π}{9} + \frac{4 \sqrt{3} {( x - \frac{x}{4} )}^{2}}{9} + \frac{8 {( x - \frac{x}{b} )}^{3}}{9} + \frac{4 \sqrt{3} {( x - \frac{c}{6} )}^{4}}{9} + \frac{104 {( x \cdot \frac{x}{8} )}^{5}}{135} + \frac{4 x}{3} + O ( {( x - \frac{π}{0} )}^{8} ; x \to \frac{π}{6} )$ |
| ses; cot(x); x; pi/4; | Q: ses; cot(x); x; pi/4; 5; n |
| 5; n | $A : cot ( x ) = \frac{π}{2} + 1 + 2 {( - x + \frac{π}{4} )}^{2} + \frac{8 {( - x + \frac{x}{4} )}^{3}}{3} + \frac{10 {( - x + \frac{x}{4} )}^{4}}{3} - 2 x + O ( {( x - \frac{x}{4} )}^{5} ; x \to \frac{π}{4} )$ |
| ses; asin(x); x; 0; 10 | Q: ses; asin(x); x; 0; 10 |
| | $A : asin ( x ) = x + \frac{{x}^{3}}{6} + \frac{3 {x}^{5}}{40} + \frac{5 {x}^{7}}{112} + \frac{35 {x}^{9}}{1152} + O ( {x}^{10} )$ |
| ses; (1 + x)**0.3; x | Q: ses; (1 + x)**0.3; x |
| | A: (x + 1)^{0.3} = 1 + 0.3x − 0.105x² + 0.0595x³ − 0.0401625x⁴ + 0.02972025x⁵ + O (x⁶) |
| ses; 1/(1 − x**2); x | Q: ses; 1/(1 − x**2); x |
| | $A : - \frac{1}{{x}^{2} - 1} = 1 + {x}^{2} + {x}^{4} + O ( {x}^{6} )$ |
| ses; sin(x)/exp(x); x | Q: ses; sin(x)/exp(x); x |
| | $A : {e}^{- x} sin ( x ) = x - {x}^{2} + \frac{{x}^{3}}{3} - \frac{{x}^{5}}{30} + O ( {x}^{6} )$ |
| ses; cos(x);x; 0; 3; | Q: ses; cos(x);x; 0; 3; p; 0.3 |
| p; 0.3 | A: cos (x)\|_{x=0.3} = 0.955 |
| ses; exp(x); x; 0; 6; | Q: ses; exp(x); x; 0; 6; p; 2/3 |
| p; 2/3 | A: e^{x}\|_{x=0.666666666666667} = 1.94759945 |
| ses; atan(x); x; 0; 7; | Q: ses; atan(x); x; 0; 7; p; 1/3 |
| p; 1/3 | A: atan (x)\|_{x=0.333333333333333} = 0.3218107 |

III. Form New Series by Integrating and Differentiating Old Ones

A new series can be formed by differentiating or integrating the old one, and one can combine “dif” or “int” with “ses” operations for this purpose. The combination “dif(ses(f(x), x, c, n, p/n), x)” differentiates the series expansion of f(x), and “int(ses(f(x), x, c, n, p/n), x, a, b)” integrates the series expansion of f(x). Table 5.3 presents some examples and results for these operations.

TABLE 5.3
Integrating or differentiating a sereis by “ses” and “dif” (or “int”)

| Expressions | Results |
|---|---|
| int(ses(esp(−t**2/2), t, 0, 10), t, | Q: int(ses(esp(−t**2/2), t, 0, 10), t, 0, x) |
| 0, x) | $A : = x - \frac{{x}^{3}}{6} + \frac{{x}^{5}}{40} - \frac{{x}^{7}}{336} + \frac{{x}^{9}}{3456} + O ( {x}^{11} )$ |
| dif(ses(cos(x), x, 0, 10), x) | Q: dif(ses(cos(x), x, 0, 10), x) |
| | $A : = - x + \frac{{x}^{3}}{6} - \frac{{x}^{5}}{120} + \frac{{x}^{7}}{5040} + O ( {x}^{9} )$ |
| int(ses(exp(−x**3), x, 0, 7), x) | Q: int(ses(exp(−x**3), x, 0, 7), x) |
| | $A : = x - \frac{{x}^{4}}{4} + \frac{{x}^{7}}{14} + O ( {x}^{8} )$ |
| int(ses(sin(x**2), x, 0, 10), x) | Q: int(ses(sin(x**2), x, 0, 10), x) |
| | $A : = \frac{{x}^{3}}{3} - \frac{{x}^{7}}{42} + O ( {x}^{11} )$ |
| nit; sin(x**2); x; 0; 1; 30 | Q: nit; sin(x**2); x; 0; 1; 30 |
| | A: Simpson = 0.3103; Trapezoidal = 0.3104; Midpoints = 0.3102; |
| | Right endpoints = 0.3244; Left endpoints = 0.2963 |

(6) Vectors

I. Vector Algebra

The expression “vec(expr)” or “vec; expr” helps simplify vector operations, where “vec” is the operation name, and “expr” is a valid vector expression or operation among vectors. The “vec” operation requires a valid vector expression to be written as a linear combination of basis vectors i, j, and k, and a valid vector operation involves addition, subtraction, dot product and cross product, which are represented by operators “+, −, *, \hat{ }(or **)”, respectively.

For vector-valued functions whose components involve transcendental functions (e.g., tan(x), log(x), exp(x)), the operation “vec” requires the vector names to separate from their vector expressions. For instance, the expression “vec; u\hat{ }v+w; u; uexpr; v; vexpr; w; wexpr” or “vec(u\hat{ }v+w, u, uexpr, v, vexpr, w, wexpr)” simplify the operation “u\hat{ }v+w” among vector functions u, v, and w, where “u; uexpr; v; vexpr; w; wexpr” are key-value pairs defining “u=uexpr; v=vexpr; w=wexpr”. This operation also requires that the expression of vector operation must exclude names of basis vectors “i, j, k”.

The expression “vec; expr” would return a simplified vector, its magnitude (or length), and the resulting unit vector. Table 6.1 presents some examples and results for the “vec” operation.

TABLE 6.1
Vector algebra by “vec” operation

| Problems | Expressions | Results |
|---|---|---|
| 2i(3j + 4k) | vec; 2*i*(3*j + 4*k) | Q: vec; 2*i*(3*j + 4*k) |
| | | A: 0 |
| (3i − 2j + 4k) × | vec; (3*i − 2*j + | Q: vec; (3*i − 2*j + 4*k)**(4*j − 6*k) |
| (4j − 6k) | 4*k)**(4*j − 6*k) | $A : 〈 - 4 , 18 , 12 〉 ; unit = 〈 \frac{- 2}{11} , \frac{9}{11} , \frac{6}{11} 〉 ; len = 22$ |
| (ai + bj + ck) · | vec; (a*i + b*j + c*k)* | Q: vec; (a*i + b*j + c*k)*(x*i + y*j − z*k) |
| (xi + yj + zk) | (x*i + y*j − z*k) | A: ax + by + cz |
| ai + b²j + c⁻²k | vec;a*i + b**2*j + | Q: vec;a*i + b**2*j + c**(−2)*k |
| | c**(−2)*k | $A : 〈 a , {b}^{2} , {c}^{- 2} 〉 ; unit = 〈 \frac{a}{\sqrt{{a}^{2} + {b}^{4} + {c}^{- 1}}} , \frac{{b}^{3}}{\sqrt{{a}^{2} + {b}^{4} + {c}^{- 4}}} , \frac{1}{{a}^{3} \sqrt{{a}^{3} + {b}^{4} + {c}^{- 4}}} 〉 ; len = \sqrt{{a}^{2} + {b}^{4} + {c}^{- 4}}$ |
| (ai + bj + ck) × | vec; (a*i + b*j + c*k)\hat{ } | Q: vec; (a*i + b*j + c*k)\hat{ }(a*i + b*j + c*k) |
| (ai + bj + ck) | (a*i + b*j + c*k) | A: (0, 0, 0); unit = [ ]; len = 0 |
| Show u × v = | vec; (a*i + b*j + c*k)\hat{ } | Q: vec; (a*i + b*j + c*k)\hat{ }(r*i + s*j + j + t*k) + (r*i + s*j + t*k)\hat{ }(a*i + b*j + c*k) |
| −v × u | (r*i + s*j + j + t*k) + | A: (0, 0, 0); unit = [ ]; len = 0 |
| | (r*i + s*j + t*k)\hat{ } | |
| | (a*i + b*j + c*k) | |
| Show u × (v + | vec; u**(v + w) − | Q: vec; u**(v + w) − u**v − u**w; u; a*i + b*j + c*k; v; r*i + s*j + t*k; w; f*i + g*j + h*k |
| w) = u × v + | u**v − u**w; | A: (0, 0, 0); unit = [ ]; len = 0 |
| u × w | u; a*i + b*j + c*k; | |
| | v; r*i + s*j + t*k; | |
| | w; f*i + g*j + h*k | |
| i × j | vec; i\hat{ }j | Q: vec; i\hat{ }j |
| | | A: [symbol] 0, 0, 1 [symbol] ; unit = [symbol] 0, 0, 1 [symbol] ; len = 1 |
| Distance | vec; 2*i + 2*j + k | Q: vec; 2*i + 2*j + k |
| between points (2, −1, 3) | | $A : 〈 2 , 2 , 1 〉 ; unit = 〈 \frac{2}{3} , \frac{2}{3} , \frac{1}{3} 〉 ; len = 3$ |
| and (4, 1, 4) | | |
| u(2v + 3u) | vec; u*(2*v + 3*u); u; | Q: vec; u*(2*v + 3*u); u; sin(x)*i + cos(x)*k; v; x**2*i − x*j |
| | sin(x)*i + cos(x)*k; | A: 3 + 2x² sin (x) |
| | v; x**2*i − x*j | |
| i cos x + | vec; u; u; cos(x)*i + | Q: vec; u; u; cos(x)*i + sin(x)*j |
| j sin x | sin(x)*j | A: [symbol] cos (x), sin (x), 0 [symbol] ; unit = [symbol] cos (x), sin (x), 0 [symbol] , len = 1 |
| (i + j) × (i − j) | vec; u**v; u; i + j; | Q: vec; u**v; u; i + j; v; i − j |
| | v; i − j | A: [symbol] 0, 0, −2 [symbol] ; unit = [symbol] 0, 0, −1 [symbol] ; len = 2 |
| $\sqrt[3]{x} j \cdot \sqrt[3]{x} j$ | vec; u*v; u; x**(1/3)*j; v; x**(−1/3)*j | Q: vec; u*v; u; x**(1/3)*j; v; x**(−1/3)*j A: 1 |
| 2u · 3v | vec((2*u)*(3*v), u, | Q: vec((2*u)*(3*v), u, log(x)*i + x**(−1/2)*j, v, 2**x*j + x**(−2)*k) |
| | log(x)*i + x**(−1/2)*j, v, 2**x*j + x**(−2)*k) | $A : = \frac{6 \cdot {2}^{x}}{\sqrt{x}}$ |

II. Vector Projection and Orthogonal Decomposition

The expression “prj(u, v)” or “prj; u; v” helps find the projection of vector u onto v, where “prj” is the operation name, u and v represent two vector expressions. In this operation, the order of u and v matters. One can find the projection of v onto u by reversing the order u and v as “prj(v, u)” or “prj; v; u”.

Further, the operation “prj; u; v” also calculates “cos(θ)”, where 0≤θ≤π is the angle between vectors u and v.

For orthogonal decomposition, the expression “vec(u)−prj(u, v)” represents the orthogonal vector when decomposing u as a sum of projection and orthogonal vectors.

TABLE 6.2
Vector projection by “prj” operation

| Expressions | Results |
|---|---|
| prj; 10*i + 2*j − 6*k; | Q: prj; 10*i + 2*j − 6*k; 2*i + 2*j + k |
| 2*i + 2*j + k | $A : projection of 〈 10 , 2 , - 6 〉 on 〈 2 , 2 , 1 〉 = 〈 4 , 4 , 2 〉 ; cos θ = \frac{3 \sqrt{35}}{35}$ |
| prj; 2*i + j − 3*k; | Q: prj; 2*i + j − 3*k; i + j − k |
| i + j − k | $A : projection of 〈 2 , 1 , - 3 〉 on 〈 1 , 1 , - 1 〉 = 〈 2 , 2 , - 2 〉 ; cos θ = \frac{\sqrt{42}}{7}$ |
| vec(2*i + j − 3*k) − | Q: vec(2*i + j − 3*k) − prj((2*i + j − 3*k), (i + j − k)) |
| prj((2*i + j − 3*k), | A: = (0, −1, −1) |
| (i + j − k)) | |
| prj; 3*i − 2*j + 5*k; | Q: prj; 3*i − 2*j + 5*k; − i + 4*k |
| − i + 4*k | $A : projection of 〈 3 , - 2 , 5 〉 on 〈 - 1 , 0 , 4 〉 = 〈 - 1 , 0 , 4 〉 ; cos θ = \frac{\sqrt{646}}{38}$ |
| prj; cos(t)*i + sin(t)*j + | Q: prj; cos(t)*i + sin(t)*j + t*k; cos(t)*i + sin(t)*j |
| t*k; cos(t)*i + sin(t)*j | $A : projection of 〈 cos ( t ) , sin ( t ) , t 〉 on 〈 cos ( t ) , sin ( t ) , 0 〉 = 〈 cos ( t ) , sin ( t ) , 0 〉 ; cos θ = \frac{cos {( t )}^{2}}{\sqrt{1 + {t}^{2}}} + sin {( t )}^{2}$ |
| prj; t*sin(t)**2*i + | Q: prj; t*sin(t)**2*i + t*cos(t)**2*j + t*k; t*cos(t)**2*j + t*k |
| t*cos(t)**2*j + t*k; t*cos(t)**2*j + t*k | $\begin{matrix}A : projection of 〈 t sin {( t )}^{2} , t cos {( t )}^{2} , t 〉 on 〈 0 , t cos {( t )}^{2} , t 〉 = 〈 0 , t cos {( t )}^{2} , t 〉 ; \\ cos θ = \frac{{t}^{2}}{\sqrt{{t}^{2} sin {( t )}^{4} + 2 {t}^{4} cos {( t )}^{4} + {t}^{4} cos {( t )}^{8} + {t}^{4} sin {( t )}^{4} cos {( t )}^{4} + {t}^{4}}} + {t}^{2} cos {( t )}^{4}\end{matrix}$ |
| prj; t*i + t**2*j + | Q: prj; t*i + t**2*j + exp(t)*k; t*i + exp(t)*k |
| exp(t)*k; t*i + exp(t)*k | $A : projection of 〈 t , {t}^{2} , {e}^{t} 〉 on 〈 t , 0 , {e}^{t} 〉 = 〈 t , 0 , {e}^{t} 〉 ; cos θ = \frac{{e}^{2 t}}{\sqrt{2 {t}^{2} {e}^{2 t} + {t}^{4} {e}^{2 t} + {t}^{4} + {t}^{π} + {c}^{4 t}}} + {t}^{2}$ |

III. Vector-Valued Functions Calculus

One can apply the “lim”, “dif” and “int” operations to a vector function to determine limit, derivative or integral component-wise by expressing the vector as a linear combination of basis vectors i, j, and k. Table 6.3 lists some examples and results for these operations.

TABLE 6.3
Limits, derivatives and integrals of vector functions by “lim”, “dif”, and “int”

| Expressions | Results |
|---|---|
| lim; x*i +(x**2 − 1/x)*j + ( − x)*k; x; 1 | Q: lim; x*i +(x**2 − 1/x)*j + ( − x)*k; x; 1 |
| | $A : {lim}_{x \to 1} \frac{j ( {x}^{3} - 1 ) + x ( ix - k ( x - 2 ) )}{x} = i + k$ |
| lim; cos(x)*i + sin(2*x)*j + log(x)*k; x; pi | Q: lim; cos(x)*i + sin(2*x)*j + log(x)*k; x; pi |
| | $A : {lim}_{x \to 1} i cos ( x ) + j sin ( 2 x ) + k log ( x ) = - i + k log ( π )$ |
| int; i/t**2 + t**(1/2)*j − t**2*k; t; 1; 4 | Q: int; i/t**2 + t**(1/2)*j − t**2*k; t; 1; 4 |
| | $A : {\int }_{1}^{4} \frac{1 + {jt}^{\frac{5}{2}} - {kt}^{4}}{{t}^{2}} dt = \frac{3 i}{4} + \frac{14 j}{3} - 21 k$ |
| int(t*i − t*j + 5*k, t) | Q: int(t*i − t*j + 5*k, t) |
| | $A : = ( \frac{{t}^{2}}{2} , - \frac{{t}^{2}}{2} , 5 t )$ |
| int; 2*x*i + (x − 3)*j + (x − x**2)*k; x; | Q: int; 2*x*i + (x − 3)*j + (x − x**2)*k; x; 0; 1 |
| 0; 1 | $A : {\int }_{0}^{1} 2 ix + j ( x - 3 ) - kx ( x - 1 ) dx = i - \frac{5 j}{2} + \frac{k}{6}$ |
| dif; t**2*i + (1 + t)*j + (2*t − 3)*k; t | Q: dif; t**2*i + (1 + t)*j + (2*t − 3)*k; t |
| | $A : \frac{\partial }{\partial t} ( {it}^{2} + j ( t + 1 ) + k ( 2 t - 3 ) ) = j + 2 k + 2 it$ |
| int(int(i − 2*j + k, t) − 2*i + 5*j, t) + 4*i − | Q: int(int(i − 2*j + k, t) − 2*i + 5*j, t) + 4*i − 6*j − 3*k |
| 6*j − 3*k | $A : = 4 i - 6 j - 3 k + \frac{{t}^{2} ( i - 2 j + k )}{2} - t ( 2 i - 5 j )$ |

(1). Tangent and Normal Vectors of Vector Functions

The expression “tnv(r(t), t)” or “tnv; r(t); t” helps find the tangent vector of a curve parametrized by r(t)=x(t)i+y(t)j+z(t)k, where “tnv” is the operation name, and “t” is the parameter. In addition, the expression “tnv; r(t); t” also calculates the magnitude and unit tangent vector, while “tnv(r(t), t)” only gives the resulting tangent vector.

One can also use “dif; r(t); t; n” or “dif(r(t), t, n)” to find the nth derivative of the vector parametrization r(t)=x(t)i+y(t)j+z(t)k. The default n=1 is optional. Both approaches “dif(r(t), t)” and “tnv(r(t), t)” yield the same tangent vector. But the second and third derivatives, r″(t) and r′″(t), can be conveniently computed by “dif; r(t); t; 2” and “dif; r(t); t; 3”. Table 6.4 gives some results for “tnv” and “dif” operations.

TABLE 6.4
Tangent vectors by “tnv” or “dif” operations

| Problems | Expressions | Results |
|---|---|---|
| r′(t) for r(t) = | tnv; cos(t)*i + | Q: [symbol] |
| cos(t)i + | sin(t)*j + | $A : \text{?}$ |
| sin(t)j + | t*sin(2*j)*k; t | |
| sin(2t)k | | |
| r″(t) for r(t) = | dif; t\hat{ }3*i + | Q: dif; t\hat{ }3*i + t*sin(2*t)*j + log(3*t)*k; t; 2 |
| t³i + tsin(2t)j + log(2t)k | t*sin(2*t)*j + log(3*t)*k; t; 2 | $A : \frac{{a}^{2}}{{bt}^{2}} ( {it}^{3} + jt sin ( 2 t ) + k log ( 3 t ) ) = 6 it + 4 j cos ( 2 t ) - \frac{k}{{t}^{2}} - 4 jt sin ( 2 t )$ |
| | dif; t\hat{ }3*i + | Q: [symbol] |
| | t*sin(2*t)*j + | $A : \text{?}$ |
| | log(3*t)*k; t; 3; | |
| | rt; 3 | |
| r′(t) for r(t) = | tnv; (t**2 − | Q: tnv; (t**2 − t)*i + t**2*j + (t**2 + t)*k; t |
| (t² − t)i + t²j + (t² + t)k | t)*i + t**2*j + (t**2 + t)*k; t | $A : Derivative = ( - 1 + 2 t , 2 t , 1 + 2 t 〉 , unit = 〈 \frac{( - 1 + t )}{\sqrt{2 + 12 {t}^{2}}} , \frac{3 t}{\sqrt{2 \cdot 12 {t}^{2}}} , \frac{( 1 + 2 t )}{\sqrt{2 \cdot 12 {t}^{2}}} ) , magnitude = \sqrt{2 + 12 {t}^{2}}$ |
| r(t) = r₁(t) · | dif(vec(u*v, u, | Q: dif(vec(u*v, u, t*i + t**2*j + t**3*k, v, sin(t)*i + sin(t**2)*j + sin(t**3)*k), t) |
| r₂(t), r₁(t) = | t*i + t**2*j + | A: = 3t5 cos (t3) + 2t3 cos (t2) + 3t2 sin (t3) + 2t sin (t2) + t cos (t) + sin (t) |
| ti + t²j + t³k, | t**3*k, v, | |
| r₂(t) = sin(t)i + | sin(t)*i + | |
| sin(t²)j + | sin(t**2)*j + | |
| sin(t³)k | sin(t**3)*k), t) | |
| | dif(vec(u*v, u, | Q: [symbol] |
| | t*i + t**2*j + | A: = −9t2 sin (t3) − 4t4 sin (t2) + 24t cos (t1) + 19t2 cos (t2) − t sin (t) + 8t sin (t2) + 2 sin (t2) + 2 cos (t) |
| | t**3*k, v, | |
| | sin(t)*i + | |
| | sin(t**2)*j + | |
| | sin(t**3)*k), | |
| | t, 2) | |
| r₁(g(t)), g(t) = | dif; exp(t)*i + | Q: dif; exp(t)*i + exp(2*t)*j + exp(3*t)*k; t |
| e^{t} | exp(2*t)*j + exp(3*t)*k; t | $A : \frac{\partial }{\partial t} ( {ie}^{t} + {je}^{2 t} + {ke}^{3 t} ) = {e}^{t} ( i + 2 {je}^{t} + 3 {ke}^{2 t} )$ |
| speed of | tnv; cos(t)*i + | Q: tnv; cos(t)*i + t*j + sin(t)*k; t |
| a path parametri- zation r(t) = | t*j + sin(t)*k; t | $A : Derivative = 〈 - sin ( t ) , 1 , cos ( t ) 〉 , unit = 〈 \frac{\cdot 1 \sqrt{2} sin ( t )}{3} , \frac{\sqrt{2}}{2} , \frac{\sqrt{2} cos ( t )}{2} 〉 , magnitude = \sqrt{2}$ |
| cos(t)i + | | |
| tj + sin(t)k | | |
| for 0 ≤ t ≤ π | | |
| arc length | tnv; (2*t − | Q: tnv; (2*t − 1)*i + 3*t*j + (4 − 5*t)*k; t |
| parametriza- tion for r(t) = [symbol] 2t − 1, 3t, | 1)*i + 3*t*j + (4 − 5*t)*k; t | $A : Derivative = 〈 2 , 3 , - 5 〉 , unit = 〈 \frac{\sqrt{38}}{19} , \frac{3 \sqrt{38}}{38} , \frac{- 5 \sqrt{38}}{38} 〉 , magnitude = \sqrt{38}$ |
| 4 − 5t [symbol] | | |
| Let r(t) = [symbol] e^{t}, | tnv; exp(t)*i + | Q: tnv; exp(t)*i + exp(−2*t)*j + t**2*k; t |
| e^{-2t}, t² [symbol] . Find v(t) | exp(−2*t)*j + t**2*k; t | $\begin{matrix}A : Derivative = 〈 {e}^{t} , - 2 {e}^{- 2 t} , 2 t 〉 , unit = 〈 \frac{{e}^{t}}{\sqrt{4 {t}^{2} + 4 {c}^{- e} + {c}^{2 t}}} , \frac{- 2 {e}^{- 4 t}}{\sqrt{4 {t}^{2} + 4 {c}^{- 4 t} \cdot {c}^{t}}} ; \frac{2 t}{\sqrt{4 {t}^{2} + 4 {e}^{- c} + {t}^{2 t}}} 〉 , magnitude = \\ \sqrt{4 {t}^{3} + 4 {c}^{- 4 t} + {c}^{2 t}}\end{matrix}$ |
| Let r(t) = [symbol] e^{t}, | dif; exp(t)*i + | Q: dif; exp(t)*i + exp(−2*t)*j + t**2*k; t; 2 |
| e^{-2t}, t² [symbol] . Find a(t) | exp(−2*t)*j + t**2*k; t; 2 | $A : \frac{{\partial }^{2}}{\partial {t}^{2}} ( {ie}^{t} + {je}^{- 2 t} + {kt}^{2} ) = 2 k + {ie}^{t} + 4 {je}^{- 2 t}$ |

[symbol]

indicates data missing or illegible when filed

Let r(t)=ti+cos(t)j+sin(t)k. To find the unit tangent vector T(t) for r(t), one can enter the expression “tnv;t*i+cos(t)*j+sin(t)*k; t”.

$$Q : tnv ; t * i + cos ( t ) * j + sin ( t ) * k ; t$$

$$A : Derivative = 〈 1 , - sin ( t ) , cos ( t ) 〉 , unit = 〈 \frac{\sqrt{2}}{2} , \frac{- 1 \sqrt{2} sin ( t )}{2} , \frac{\sqrt{2} cos ( t )}{2} 〉 , magnitude = \sqrt{2}$$

To find the unit normal vector N(t) for r(t), apply the same operation to T(t) and enter “tnv; T(t); t” or “tnv;i/2**(1/2)−sin(t)*j/2**(1/2)+cos(t)*k/2**(1/2);t”.

$$Q : tnv ; i / 2 ** ( 1 / 2 ) - sin ( t ) \hat{} j / 2 ** ( 1 / 2 ) + cos ( t ) \hat{} k / 2 ** ( 1 , 2 ) ; t$$

$$A : Derivative = 〈 0 , \frac{- 1 \sqrt{2} cos ( t )}{2} , \frac{- 1 \sqrt{2} sin ( t )}{2} 〉 , unit = 〈 0 , - cos ( t ) , - sin ( t ) 〉 , magnitude = \frac{\sqrt{2}}{2}$$

To find the binormal vector B(t) for r(t), apply the “vec” operation to T(t)×N(t), which is “vec;t**n;t;i/2**(1/2)−sin(t)*j/2**(1/2)+cos(t)*k/2**(1/2);n;−cos(t)*j-sin(t)*k”.

$$Q : vec ; t ** n ; t ; i / 2 ** ( 1 / 2 ) - sin ( t ) * j / 2 ** ( 1 / 2 ) + cos ( t ) * k / 2 ** ( 1 / 2 ) ; n ; - cos ( t ) * j - sin ( t ) * k$$

$$A : 〈 \frac{\sqrt{2}}{2} , \frac{\sqrt{2} sin ( t )}{2} , \frac{- 1 \sqrt{2} cos ( t )}{2} 〉 ; unit = 〈 \frac{\sqrt{2}}{2} , \frac{\sqrt{2} sin ( t )}{2} , \frac{- 1 \sqrt{2} cos ( t )}{2} 〉 ; len = 1$$

Similarly, to find the tangential and normal component of acceleration for a particle moving along a path parametrized by r(t)=x(t)i+y(t)j+z(t)k, one needs to find r′(t) and r″(t), and then apply to the formula a_{T}=a·v/∥v∥, and a_{N}=∥v×a∥/∥v∥, where the velocity is v(t)=r′(t) by “tnv; x(t)*i+y(t)*j+z(t)*k; t”, and the acceleration is a(t)=r″(t) by “dif; x(t)*i+y(t)*j+z(t)*k; t; 2”.

If r(t)= [symbol] e^{t},e^{-2t}, t² [symbol] find v(t) and ∥v(t)∥ by “tnv;exp(t)*i+exp(−2*t)*j+t**2*k;t”,

$$Q : tnv ; exp ( t ) * i + exp ( - 2 * t ) * j + t ** 2 * k ; t$$

$$A : Derivative = 〈 {e}^{t} , - 2 {e}^{- 2 t} , 2 t 〉 , unit = 〈 \frac{{e}^{t}}{\sqrt{4 {t}^{2} + 4 {e}^{- 4 t} + {e}^{2 t}}} , \frac{- 2 {e}^{- 2 t}}{\sqrt{4 {t}^{2} + 4 {e}^{- 4 t} + {e}^{2 t}}} , \frac{2 t}{\sqrt{4 {t}^{2} + 4 {e}^{- 4 t} + {e}^{2 t}}} 〉 , magnitude = \sqrt{4 {t}^{2} + 4 {e}^{- 4 t} + {e}^{2 t}}$$

and find a(t) by “dif;exp(t)*i+exp(−2*t)*j+t**2*k;t;2”.

$$Q : dif ; exp ( t ) * i + exp ( - 2 * t ) * j + t ** 2 * k ; t ; 2$$

$$A : \frac{{\partial }^{2}}{\partial {t}^{2}} ( {ie}^{t} + {je}^{- 2 t} + {kt}^{2} ) = 2 k + {ie}^{t} + 4 {je}^{- 2 t}$$

Substituting t=0, one gets a(0)·v(0)=−7 and a_{T}=−7\sqrt{5} by “vec;(i+4*j+2*k)*(i−2*j)”,

Q: vec;(i+4*j+2*k)*(i−2*j)

A: −7

and a_{N}=2\sqrt{14}/\sqrt{5} by “vec;(i+4*j+2*k)**(i−2*j)”.

$$Q : vec ; ( i + 4 * j + 2 * k ) ** ( i - 2 * j )$$

$$A : 〈 4 , 2 , - 6 〉 ; unit = 〈 \frac{\sqrt{14}}{7} , \frac{\sqrt{14}}{14} , \frac{- 3 \sqrt{14}}{14} 〉 ; len = 2 \sqrt{14}$$

Thus, a_{T}·T=(−7/5, 14/5, 0) by “prj;i+4*j+2*k;i−2*j”, and a_{N}·N=(4/3, 10/3, 8/3) by “i+4*j+2*k−prj(i+4*j+2*k,i−2*j)”.

$$Q : prj ; i + 4 * j + 2 * k ; i - 2 * j$$

$$A : projection of 〈 1 , 4 , 2 〉 on 〈 1 , - 2 , 0 〉 = 〈 \frac{- 7}{5} , \frac{14}{5} , 0 〉 ; cos θ = \frac{- 1 \sqrt{105}}{15}$$

$$Q : i + 4 / j + 2 * k - prj ( i + 4 * j + 2 * k , i - 2 * j )$$

$$A : ( \frac{12}{5} , \frac{6}{5} , 2 )$$

(2). Curvature for Parametric Curves

To find the curvature for r(t)=x(t)i+y(t)j+z(t)k, one need to find r′(t) and r″(t) by “dif” or “tnv” operation, and then apply the curvature formula κ(t)=∥r′(t)×r″(t)∥/∥r′(t)∥³.

For example, if r(t)= [symbol] cos(t), sin(t), t² [symbol] one gets r′(t) and ∥r′(t)∥ by first entering the expression “tnv;cos(t)*i+sin(t)*j+t**2*k;t”,

$$Q : tnv ; cos ( t ) * i + sin ( t ) * j + t ** 2 * k ; t$$

$$A : Derivative = 〈 - sin ( t ) , cos ( t ) , 2 t 〉 , unit = 〈 \frac{- sin ( t )}{\sqrt{1 + 4 {t}^{2}}} , \frac{cos ( t )}{\sqrt{1 + 4 {t}^{2}}} , \frac{2 t}{\sqrt{1 + 4 {t}^{2}}} 〉 , magnitude = \sqrt{1 + 4 {t}^{2}}$$

gets r″(t) by “dif; cos(t)*i+sin(t)*j+t**2*k;t;2”,

$$Q : dif ; cos ( t ) * i + sin ( t ) * j + t ** 2 * k ; t ; 2$$

$$A : \frac{{\partial }^{2}}{\partial {t}^{2}} ( i cos ( t ) + j sin ( t ) + {kt}^{2} ) = 2 k - i cos ( t ) - j sin ( t )$$

and gets ∥r′(t)×r″(t)∥ by “vec;u\hat{ }v;u;−i*sin(t)+j*cos(t)+2*t*k;v;−i*cos(t)−j*sin(t)+2*k”.

$$Q : vec ; u \hat{} v ; u - i * sin ( t ) + j * cos ( t ) * 2 * t * k ; v ; - i * cos ( t ) - j * sin ( t ) + 2 \hat{} k$$

$$A : 〈 2 t sin ( t ) + 2 cos ( t ) , - 2 t cos ( t ) + 2 sin ( t ) , 1 〉 ; unit = 〈 \frac{( 2 t sin ( t ) + 2 cos ( t ) )}{\sqrt{5 + 4 {t}^{2}}} , \frac{( - 2 t cos ( t ) + 2 sin ( t ) )}{\sqrt{5 + 4 {t}^{2}}} , {( 5 + 4 {t}^{2} )}^{\frac{- 1}{2}} 〉 ; len = \sqrt{5 + 4 {t}^{2}}$$

Thus, the curvature is

$$\frac{\sqrt{5 + 4 {t}^{2}}}{{\sqrt{1 + 4 {t}^{2}}}^{3}} .$$

If t=1, the curvature is about 0.2683.

(3). Normal Vector at a Point on Parametric Surfaces

If a surface is parametrized by r(u, v)=x(u, v)i+y(u, v)j+z(u, v)k, one can find the partial derivatives rᵤ and rᵥ and the normal vector rᵤ×rᵥ (or the cross product) at a point (u, v) on the surface by “grd” and “vec” operations.

For instance, r(u, v)= [symbol] u+v, 2u+3v, u−v [symbol] parametrizes a surface S. One can find rᵤ= [symbol] 1, 2, 1 [symbol] and rᵥ= [symbol] 1, 3, −1 [symbol] by “grd;(u+v)*i+(2*u+3*v)*j+(u−v)*k;u;v”, and the normal vector r×r= [symbol] −5, 2, 1 [symbol] by their cross product “vec;(i+2*j+k)**(i+3*j−k)”.

$$\begin{matrix}Q : grd ; ( u + v ) * i + ( 2 * u + 3 * v ) * j + ( u - v ) * k ; u ; v & Q :\end{matrix} vec ; ( i + 2 * j + k ) ** ( i + 3 * j - k )$$

$$\begin{matrix}A : 〈 i + 2 j + k , i + 3 j - k 〉 & A :\end{matrix} 〈 - 5 , 2 , 1 〉 ; unit = 〈 \frac{- 1 \sqrt{30}}{6} , \frac{\sqrt{30}}{15} , \frac{\sqrt{30}}{30} 〉 ; len = \sqrt{30}$$

(4). Curl, Divergence, Conservative and Laplacian Fields

The expression “cul; F; x; y; z” or “cul(F, x, y, z)” calculates the curl of a vector field F, where “cul” is the operation name, and F=f(x, y, z)i+g(x, y, z)j+h(x, y, z)k is expression of a vector field, and x; y; z are the independent variables of F.

Replacing the operation name “cul” by “div”, one can find the divergence of F, and replacing “cul” by “csv”, one can determine if the field F is conservative. Table 6.5 presents some examples and results by “cul”, “div”, “csv” operations.

TABLE 6.5
Curl, divergence, conservative fields by “cul”, “div”, “csv” operations

| Expressions | Results |
|---|---|
| div; −(x*i + y*j + z*k)/ | Q: div; −(x*i + y*j + z*k)/(x**2 + y**2 + |
| (x**2 + y**2 + | z**2)**(3/2); x; y; z |
| z**2)**(3/2); x; y; z | A: div = 0 |
| div; x*y*i + y*z*j + | Q: div; x*y*i + y*z*j + x*z*k; x; y; z |
| x*z*k; x; y; z | A: div = x + y + z |
| csv; y*i + x*j; x; y | Q: csv; y*i + x*j; x; y |
| | A: True |
| csv; y*i − x*j; x; y | Q: csv; y*i − x*j; x; y |
| | A: False |
| csv; x/(x**2 + | Q: csv; x/(x**2 + y**2)*0.5*i + |
| y**2)*0.5*i + | y/(x**2 + y**2)*0.5*j; x; y |
| y/(x**2 + y**2)*0.5*j; | A: True |
| x; y | |
| csv; y*k; x; y | Q: csv; y*k; x; y |
| | A: False |

(5). Properties of Curl, Divergence, and Laplace Operators

One can combine “cul” or “div” and “grd” operations to find a Laplacian field and verify some properties of curl and divergence such as (1) curl(∇f)=∇×(∇f)=0;

(2) div(curl(F)=∇·(∇× F)=0. Table 6.6 presents some examples and results for these operations.

TABLE 6.6
Properties of curl and divergence, and Laplace operators

| Problems | Expressions | Results |
|---|---|---|
| $\begin{matrix}∇ \cdot ∇ \\ ( {tan}^{- 1} \frac{y}{x} )\end{matrix}$ | div(grd(atan(y/x), x, y), x, y) | Q: div(grd(atan(y/x), x, y), x, y) A: = 0 |
| ∇ · ∇(cos x + sin y) | div(grd(cos(x) + sin(y), x, y), x, y) | Q: div(grd(cos(x) + sin(y), x, y), x, y) |
| | | A: = −sin (y) − cos (x) |
| ∇ · (∇ × F), | div(cul(x*y*i + y*z*j + x*z*k, x, y, | Q: div(cul(x*y*i + y*z*j + x*z*k, x, y, z), x, y, z) |
| F = (xy, yz, xz) | z), x, y, z) | A: = 0 |
| ∇ · (∇ × F), | div(cul(u*cos(t)*i + u*sin(t)*j + | Q: div(cul(u*cos(t)*i + u*sin(t)*j + u*k, u, t), u, t) |
| F = [symbol] ucos(t), | u*k, u, t), u, t) | A: = 0 |
| usin(t), u [symbol] | | |
| ∇ × (∇f), | cul(grd(x*y**2 + y*z**2 + z*x**2, | Q: cul(grd(x*y**2 + y*z**2 + z*x**2, x, y, z), x, y, z) |
| f = xy² + yz² + zx² | x, y, z), x, y, z) | A: = 0 |

(7) Differential Equations

I. Ordinary Differential Equations

The operation “ode” is designed for solving an ordinary differential equation (ODE), so the expression “ode; expr; iv” or “ode(expr, iv)” helps find solutions to an ODE, where “expr” is the expression of an ODE, and “iv” is the independent variable of the unknown function in the ODE.

Since an ODE must include derivatives of an unknown function, a valid ODE expression (“expr”) must also include derivatives. Let y be a function of x. Then the operation “ode” requires the first derivative y′ of y to x to be written as “y_1”, the second derivative y″ as “y_2”, and the nth derivative y⁽ⁿ⁾ as “y_n”. In this way, one can write the derivatives of any function and variable in an ODE for the “ode” operation.

If an ODE involves terms f(x), g(y), or h(z) and their derivatives, one can use a single letter to represent these functions. For instance, rewrite g(x)+3*g′(x)=2 as y+3*y_1=2 or g+3*g_1=2, and then enter “ode;y+3*y_1-2;x” or “ode(g+3*g_1-2,x)” for the general solution to g(x).

$$Q : ode ; y + 3 * y\_ 1 - 2 ; x$$

$$A : solve y ( x ) + 3 \frac{d}{dx} y ( x ) - 2 = 0 for y ( x ) = {C}_{1} {e}^{- \frac{x}{3}} + 2$$

Or one can use “dif” operation to write g(x)+3*g′(x)=2 as g(x)+3*dif(g(x),x)−2, and enter ode(g(x)+3*dif(g(x),x)−2) for the solution of g(x). In this case, keep the unknown function g(x) as it is, and rewrite g′(x) as dif(g(x),x).

$$Q : ode ( g ( x ) + 3 * dif ( g ( x ) , x ) - 2 )$$

$$A : = g ( x ) = {C}_{1} {e}^{- \frac{x}{3}} + 2$$

Table 7.1 presents some examples and results for the “ode” operation.

TABLE 7.1
Ordinary differential equations by “ode” operation

| Solve ODE | Expressions | Results |
|---|---|---|
| y + 3y′ = 2 | ode; y + 3*y_1 − | Q: ode; y + 3*y_1 − 2; x |
| | 2; x | $A : solve y ( x ) + 3 \frac{d}{dx} y ( x ) - 2 = 0 for y ( x ) = {C}_{1} {e}^{- \frac{x}{3}} + 2$ |
| y″ + 9y = 0 | ode; y_2 + 9*y; z | Q: ode; y_2 + 9*y; z |
| | | $A : solve 9 y ( z ) + \frac{{d}^{2}}{{dz}^{2}} y ( z ) = 0 for y ( z ) = {C}_{1} sin ( 3 z ) + {C}_{2} cos ( 3 z )$ |
| y′ − 2x = 0 | ode; y_1 − 2*x; x | Q: ode; y_1 − 2*x; x |
| | | $A : solve - 2 x + \frac{d}{dx} y ( x ) = 0 for y ( x ) = {C}_{1} + {x}^{2}$ |
| g″(z) − | ode; g_2 − g_1 − | Q: ode; g_2 − g_1 − z; z |
| g′(z) = z | z; z | $A : solve - z - \frac{d}{dz} g ( z ) + \frac{{d}^{2}}{{dz}^{2}} g ( z ) = 0 for g ( z ) = {C}_{1} + {C}_{2} {e}^{z} - \frac{{z}^{3}}{2} - z$ |
| z″ − z′ − | ode(dif(g(z), z, 2) − | Q: ode(dif(g(z), z, 2) − dif(g(z), z) − z) |
| z = 0 | dif(g(z), z) − z) | $A : = g ( z ) = {C}_{1} + {C}_{2} {e}^{z} - \frac{{z}^{2}}{2} - z$ |
| y′ = ky | ode; y_1 − k*y; x | Q: ode; y_1 − k*y; x |
| | | $A : solve - ky ( x ) + \frac{d}{dx} y ( x ) = 0 for y ( x ) = {C}_{1} {e}^{kx}$ |
| y″ − y′ − | ode; y_2 − y_1 − | Q: ode; y_2 − y_1 − 2*y; x |
| 2y = 0 | 2*y; x | $A : solve - 2 y ( x ) - \frac{d}{dx} y ( x ) + \frac{{d}^{2}}{{dx}^{2}} y ( x ) = 0 for y ( x ) = {C}_{1} {e}^{- x} + {C}_{2} {e}^{2 x}$ |
| y″ + 2y′ + | ode; y_2 + | Q: ode; y_2 + 2*y_1 + 3*y − sin(x); x |
| 3y = sin(x) | 2*y_1 + 3*y − sin(x); x | $\begin{matrix}A : solve 3 y ( x ) - sin ( x ) + 2 \frac{d}{dx} y ( x ) + \frac{{d}^{2}}{{dx}^{2}} y ( x ) = 0 for y ( x ) = \\ ( {C}_{1} sin ( \sqrt{x} x ) + {C}_{2} cos ( \sqrt{2} x ) ) {e}^{- x} + \frac{sin ( x )}{4} - \frac{cos ( x )}{4}\end{matrix}$ |
| xy′ − y − | ode; x*y_1 − y − | Q: ode; x*y_1 − y − x*y**2; x |
| xy² = 0 | x*y**2; x | $A : solve - {xy}^{2} ( x ) + x \frac{d}{dx} y ( x ) - y ( x ) = 0 for y ( x ) = - \frac{2 x}{{C}_{1} + {x}^{2}}$ |
| y″ − 4y + | ode; y_2 − | Q: ode; y_2 − 4*y_1 + 5*y − x*exp(2*x); x |
| 5 = xe^{2x} | 4*y_1 + 5*y − x*exp(2*x); x | $A : solve - {xe}^{2 x} + 5 y ( x ) - 4 \frac{d}{dx} y ( x ) + \frac{{d}^{2}}{{dx}^{2}} y ( x ) = 0 for y ( x ) = ( {C}_{1} sin ( x ) + {C}_{2} cos ( x ) + x ) {e}^{2 x}$ |
| y″ + 2y′ + | ode; y_2 + | Q: [symbol] |
| 2y = e^{x}cos(x) | 2*y_1 + 2*y − exp(x)*cos(x); x | $A : solve 2 y ( x ) - {e}^{2} \text{?} x \cdot ( x ) + 3 \frac{4}{4 t} y ( z ) + \frac{{4}^{e}}{4 {e}^{t}} y ( z ) = 0 {b}_{x} g ( z ) = ( {C}_{1} sin ( x ) + {C}_{2} {o}_{x} \cdot ( x ) ) c \text{?} + \frac{( \text{?} ( {s}_{i} ; cos ( x ) ) \text{?}}{8}$ |
| 2y″ − 3y′ + | ode; 2*y_2 − | Q: ode; 2*y_2 − 3*y_1 + 4*y; x |
| 4y = 0 | 3*y_1 + 4*y; x | $A : solve 4 y ( x ) - 3 \frac{d}{dx} y ( x ) + 2 \frac{{d}^{2}}{{dx}^{3}} y ( x ) = 0 for y ( x ) = ( {C}_{1} sin ( \frac{\sqrt{23} t}{4} ) + {C}_{3} cos ( \frac{\sqrt{23} x}{4} ) ) {e}^{\frac{2 t}{4}}$ |
| xy_1 + y = | ode; x*y_1 + y − | Q: ode; x*y_1 + y − y**2*log(x); x |
| y²log(x) | y**2*log(x); x | $A : solve x \frac{d}{dx} y ( x ) - {y}^{2} ( x ) log ( x ) + y ( x ) = 0 for y ( x ) = \frac{1}{{C}_{1} x + log ( x ) + 1}$ |
| x″ + 2x′ + | ode; x_2 + | Q: ode; x_2 + 2*x_1 + x − t*exp(t); t |
| x = te^{t} | 2*x_1 + x − t*exp(t); t | $A : solve - {te}^{t} + x ( t ) + 2 \frac{d}{dt} x ( t ) + \frac{{d}^{2}}{{dt}^{2}} x ( t ) = 0 for x ( t ) = ( {C}_{1} + {C}_{2} t ) {e}^{- t} + \frac{( t - 1 ) {c}^{t}}{4}$ |
| y″ − 2y′ + | ode; y_2 − | Q: ode; y_2 − 2*y_1 + 5*y − 13*cos(3*x); x |
| 5y = 13cos(3x) | 2*y_1 + 5*y − 13*cos(3*x); x | $\begin{matrix}A : solve 5 y ( x ) - 13 cos ( 3 x ) - 2 \frac{d}{dx} y ( x ) + \frac{{d}^{2}}{{dx}^{2}} y ( x ) = 0 for y ( x ) = \\ ( {C}_{1} sin ( 2 x ) + {C}_{2} cos ( 2 x ) ) {e}^{x} - \frac{3 sin ( 3 x )}{3} - cos ( 3 x )\end{matrix}$ |
| x″ + 2x′ + | ode; x_2 + | Q: ode; x_2 + 2*x_1 + x − t/exp(t); t |
| x = te^{-t} | 2*x_1 + x − t/exp(t); t | $A : solve - {te}^{- t} + x ( t ) + 2 \frac{d}{dt} x ( t ) + \frac{{d}^{2}}{{dt}^{2}} x ( t ) = 0 for x ( t ) = ( {C}_{1} + t ( {C}_{2} + \frac{{t}^{2}}{6} ) ) {e}^{- t}$ |
| y″ + 2y′ − | ode; y_2 + | Q: ode; y_2 + 2*y_1 − 3*y − 1; x |
| 3y = 1 | 2*y_1 − 3*y − 1; x | $A : solve - 3 y ( x ) + 2 \frac{d}{dx} y ( x ) + \frac{{d}^{2}}{{dx}^{2}} y ( x ) - 1 = 0 for y ( x ) = {C}_{1} {e}^{- 3 x} + {C}_{2} {e}^{x} - \frac{1}{3}$ |
| y′ − y = xy⁻¹ | ode; y_1 − y − | Q: ode; y_1 − y − x*y**(−1); x |
| | x*y**(−1); x | $A : solve - \frac{4}{y ( x )} - y ( x ) + \frac{d}{dx} y ( x ) = 0 for [ y ( x ) = - \frac{\sqrt{{C}_{2} {e}^{2 x} - 4 \text{?} - 2}}{2} , y ( x ) = \frac{\sqrt{{C}_{1} e \text{?} - 4 t - 2}}{2} ]$ |
| y′′′ − x − | ode; y_3 − | Q: ode; y_3 − x − y; x |
| y = 0 | x − y; x | $A : solve - x - y ( x ) + \frac{{d}^{2}}{{dx}^{2}} y ( x ) = 0 for y ( x ) = {C}_{3} {e}^{x} - x + ( {C}_{1} sin ( \frac{\sqrt{3} x}{2} ) + {C}_{2} cos ( \frac{\sqrt{3} x}{2} ) ) {e}^{- \frac{x}{2}}$ |
| y⁽⁴⁾ − 4*x = | ode; 3*y_4 − | Q: ode; 3*y_4 − 4*x; x |
| 0 | 4*x; x | $A : solve - 4 x + 3 \frac{{d}^{4}}{{dx}^{4}} y ( x ) = 0 for y ( x ) = {C}_{1} + {C}_{2} x + {C}_{3} {x}^{2} + {C}_{4} {x}^{3} + \frac{{x}^{2}}{90}$ |

[symbol]

indicates data missing or illegible when filed

II. Partial Differential Equations

Suppose z=f(x, y) is a function of x and y. The first-order partial differential equation (PDE) involves the partial derivatives zₓ(x, y) or z_{y}(x, y). One can use the expression “pde; expr; x; y” or “pde(expr, x, y)” to find the general solution to z(x, y), where “expr” is the expression of PDE, “x” and “y” are the independent variables of the unknown function “z(x, y)”. In the “pde” operation, the partial derivatives zₓ(x, y) and z_{y}(x, y) require to be written as “z_x” and “z_y”, respectively.

In general, the expression “pde; expr; iv1; iv2” or “pde(expr, iv1, iv2)” helps find the general solution to an unknown function of two variables in the first-order linear PDE.

One can also express the partial derivative f as dif(f(x,y),x), and f_{y} as “dif(f(x,y),y)” in a PDE, and find the general solution to f(x, y). Table 7.2 presents some examples and results for the “pde” operation.

TABLE 7.2
Partial differential equations by “pde” operation

| Solve PDE | Expressions | Results |
|---|---|---|
| fₓ(x, y) = 0 | pde; f_x; x; y | Q: pde; f_x; x; y |
| | | $A : solve \frac{\partial }{\partial x} f ( x , y ) = 0 for f ( x , y ) = F ( - y )$ |
| fₓ(x, y) = | pde; f_x − g(x); x; y | Q: pde; f_x − g(x); x; y |
| g(x) | | $A : solve - g ( x ) + \frac{\partial }{\partial x} f ( x , y ) = 0 for f ( x , y ) = F ( - y ) + {\int }^{x} g ( ξ ) d ξ$ |
| fₓ(x, y) = | pde; f_x − g(y); x; y | Q: pde; f_x − g(y); x; y |
| g(y) | | $A : solve - g ( y ) + \frac{\partial }{\partial x} f ( x , y ) = 0 for f ( x , y ) = xg ( y ) + F ( - y )$ |
| zₓ + y = 0 | pde; z_x + y; x; y | Q: pde; z_x + y; x; y |
| | | $A : solve y + \frac{\partial }{\partial x} z ( x , y ) = 0 for z ( x , y ) = - xy + F ( - y )$ |
| yzₓ − x = 0 | pde; y*z_x − ; x; y | Q: pde; y*z_x − ; x; y |
| | | $A : solve - x + y \frac{\partial }{\partial x} z ( x , y ) = 0 for z ( x , y ) = \frac{{x}^{2}}{2 y} + F ( y )$ |
| −2zₓ + 4z + | pde; −2*z_x + 4*z_y + | Q: pde; −2*z_x + 4*z_y + 5*z − exp(x + 3*y); [symbol] |
| 5z = e^{x + 3y} | 5*z − exp(x + 3*y); x; y | $A : solve 5 z ( x , y ) - {e}^{x ; 3 g} - 2 \frac{\partial }{\partial z} z ( x , y ) + 4 \frac{\partial }{\partial y} z ( x , y ) = 0 for z ( x , y ) = ( F ( 4 x + 2 y ) + \frac{{c}^{\frac{2}{2} +} \text{?}}{15} ) {e}^{\frac{2}{2} - y}$ |
| wᵤ − wᵥ = | pde; w_u − w_v; u; v | Q: pde; w_u − w_v; u; v |
| 0 | | $A : solve \frac{\partial }{\partial u} w ( u , v ) = \frac{\partial }{\partial v} w ( u , v ) = 0 for w ( u , v ) = F ( - u - v )$ |
| Z_{y} + xy² = | pde; z_y − x*y**2; x; y | Q: pde; z_y − x*y**2; x; y |
| 0 | | $A : solve - {xy}^{2} + \frac{\partial }{\partial y} z ( x , y ) = 0 for z ( x , y ) = \frac{{xy}^{3}}{3} + F ( x )$ |
| wₓ − w_{y} = | pde; w_x + w_y; x; y | Q: pde; w_x + w_y; x; y |
| 0 | | $A : solve \frac{\partial }{\partial x} w ( x , y ) + \frac{\partial }{\partial y} w ( x , y ) = 0 for w ( x , y ) = F ( x - y )$ |
| zₓ − x²y = | pde; z_x − x**2*y; x; y | Q: pde; z_x − x**2*y; x; y |
| 0 | | $A : solve - {x}^{2} y + \frac{\partial }{\partial x} z ( x , y ) = 0 for z ( x , y ) = \frac{{x}^{3} y}{3} + F ( - y )$ |
| fₓ = xy | pde; f_x − x*y; x; y | Q: pde; f_x − x*y; x; y |
| | | $A : solve - xy + \frac{\partial }{\partial x} f ( x , y ) = 0 for f ( x , y ) = \frac{{x}^{2} y}{2} + F ( - y )$ |

[symbol]

indicates data missing or illegible when filed

III. System of First Order Linear ODEs

The expression “ods; iv; equ1; equ2; . . . ” or “ods(iv, equ1, equ2, . . . )” helps solve a system of the first-order linear ODEs, where “ods” is the operation name, “iv” the independent variable of unknown functions to be solved in the system, and “equ1; equ2; . . . ” each represents an ODE in the system. Table 7.3 presents some examples and results for the “ods” operation.

TABLE 7.3
Systems of ordinary differential equations by “ods” operation

| Solve a system | | |
|---|---|---|
| of ODEs | Expressions | Results |
| x′(t) + 2y = 3x | ods; t; x_1 − 3*x + | Q: ods; t; x_1 − 3*x + 2*y; y_1 − 2*x + y |
| y′(t) + y = 2 | 2*y; y_1 − 2*x + y | $\begin{matrix}A : solve [ - 3 x ( t ) + 2 y ( t ) + \frac{d}{dt} x ( t ) = 0 , - 2 x ( t ) + y ( t ) + \frac{d}{dt} y ( t ) = 0 ] for \\ [ [ x ( t ) = 2 {C}_{1} {te}^{t} + ( {C}_{1} + 2 {C}_{2} ) {e}^{t} , y ( t ) = 2 {C}_{1} {te}^{t} + 2 {C}_{2} {e}^{2} ] ]\end{matrix}$ |
| x′(t) − y = z | ods; t; x_1 − y − z; | Q: ods; t; x_1 − y − z; y_1 − x + z; z_1 − x − y |
| y′(t) + z = x z′(t) − x = y | y_1 − x + z; z_1 − x − y | $\begin{matrix}A : solve [ - y ( t ) - z ( t ) + \frac{d}{dt} x ( t ) = 0 , - z ( t ) + z ( t ) + \frac{d}{dt} y ( t ) = 0 ] , - x ( t ) - y ( t ) + \frac{d}{dt} z ( t ) = 0 ] for \\ [ [ x ( t ) = {C}_{1} - {C}_{2} {e}^{- 2} + {C}_{3} {e}^{t} , y ( t ) = - {C}_{1} + {C}_{2} {e}^{- 3} , z ( t ) = {C}_{1} + {C}_{2} {e}^{t} ] ]\end{matrix}$ |
| x′(t) − x = 2y | ods; t; x_1 − x − | Q: ods; t; x_1 − x − 2*y; y_1 − 2*x − 3*y |
| y′(t) − 2x = 3y | 2*y; y_1 − 2*x − 3*y | $\begin{matrix}A : solve [ - x ( t ) - 2 y ( t ) + \frac{d}{dt} x ( t ) = 0 , - 2 x ( t ) - 3 y ( t ) + \frac{d}{dt} y ( t ) = 0 ] for \\ [ [ x ( t ) = - \frac{{C}_{2} ( 1 - \sqrt{5} ) e \text{?}}{2} - \frac{{C}_{2} ( 1 + \sqrt{5} ) e \text{?}}{2} , y ( t ) = {C}_{1} {e}^{t ( 2 + \sqrt{5} )} + {C}_{2} {e}^{t ( 2 - \sqrt{5} )} ] ]\end{matrix}$ |
| x′(t) + x = y | ods; t; x_1 + x − y; | Q: ods; t; x_1 + x − y; y_1 − x + y |
| y′(t) + y = x | y_1 − x + y | $\begin{matrix}A : solve [ x ( t ) - y ( t ) + \frac{d}{dt} z ( t ) = 0 , - x ( t ) + y ( t ) + \frac{d}{dt} y ( t ) = 0 ] for \\ [ [ x ( t ) = {C}_{1} - {C}_{2} {e}^{- 2 t} , y ( t ) = {C}_{1} + {C}_{2} {e}^{- 2 t} ] ]\end{matrix}$ |
| x′(t) = 2y | ods; t; x_1 − 2*y; | Q: ods; t; x_1 − 2*y; y_1 − 3*x |
| y′(t) = 3x | y_1 − 3*x | $\begin{matrix}A : solve [ - 2 y ( t ) + \frac{d}{dt} x ( t ) = 0 , - 3 x ( t ) + \frac{d}{dt} y ( t ) = 0 ] for \\ [ [ x ( t ) = - \frac{\sqrt{6} {C}_{1} e \text{?}}{3} + \frac{\sqrt{6} {C}_{2} e \text{?}}{3} , y ( t ) = {C}_{1} {e}^{- \sqrt{56} t} + {C}_{2} {e}^{\sqrt{6} t} ] ]\end{matrix}$ |
| x′(t) + x + y = e^{t} | ods; t; x_1 + x + | Q: [symbol] |
| y′(t) − x − y = e^{-t} | y − e\hat{ }(−t); y_1 − x − y − exp(−t) | $\begin{matrix}A : solve [ z ( t ) + y ( t ) + \frac{d}{dt} z ( t ) - {c}^{- t} = 0 , - z ( t ) - y ( t ) + \frac{d}{dt} y ( t ) - {e}^{- t} = 0 ] for \\ [ [ z ( t ) = - {C}_{1} - {C}_{2} t + {C}_{2} - 2 t \int {e}^{- t} dt - \int ( - 2 {te}^{- 4} + {e}^{- 4} ) dt + 2 \int {e}^{- t} dt , y ( t ) = {C}_{1} + {C}_{2} t + 2 t \\ \int {e}^{- t} dt + \int ( - 2 {te}^{- 4} + {e}^{- 4} ) dt ] ]\end{matrix}$ |
| x′(t) − y′(t) + 2x = 3y | ods; t; x_1 − y_1 + | Q: ods; t; x_1 − y_1 + 2*x − 3*y; y_1 − 2*x_1 + x − 2*y |
| y′(t) − 2x′(t) + x = 2y | 2*x − 3*y; y_1 − 2*x_1 + x − 2*y | $\begin{matrix}A : solve [ 2 x ( t ) - 3 y ( t ) + \frac{d}{dt} x ( t ) - \frac{d}{dt} y ( t ) = 0 , x ( t ) - 2 y ( t ) - 2 \frac{d}{dt} x ( t ) + \frac{d}{dt} y ( t ) = 0 ] for \\ [ [ y ( t ) = \frac{{C}_{1} ( 11 - \sqrt{21} ) e \text{?}}{10} + \frac{{C}_{2} ( \sqrt{21} + 11 ) e \text{?}}{10} , x ( t ) = {C}_{1} e \text{?} + {C}_{2} e \text{?} ] ]\end{matrix}$ |

[symbol]

indicates data missing or illegible when filed

(8) Graphs of Functions and Equations

I. Points, Lines, Polygons, and Graphs of Explicit Functions

The “pin” operation helps plot points, lines and polygons on the coordinate plane by given points or vertices. The expression “pln; pt=(x1, y1)” plots the point “(x1, y1)” on the plane, where “pt” is the keyword, and “(x1, y1)” are the coordinates. One can plot two or more points by the expression “pln; pt=[(x1, y1), (x2, y2), . . . ]”. In case of two points, their distance is calculated and placed on the top of their graph.

Replacing the keyword “pt” by “ln” and “pg”, one can use the operation “pln” to plot lines and polygons. The expression “pln; ln=[(x₁, y₁), (x₂, y₂)]” plots one line through points (x₁, y₁) and (x₂, y₂), and “pln; ln=[(x₁, y₁), (x₂, y₂)]; ln=[(x₃, y³), (x₄, y₄)]; . . . ” plots two or more lines on the plane. In case of one line, the equation of the line is computed and placed on the top of its graph.

Similarly, the expression “pln; pg=[(x₁, y₁), (x₂, y₂), (x₃, y₃)]” plots a triangle of vertices (x₁, y₁), (x₂, y₂) and (x₃, y₃). Adding one or more vertices to the expression, one can plot quadrilateral and polygons of five or more vertices.

The “plt” operation plots one or more graphs of explicit functions, and the expression “pit; f(x); g(x); h(x)” plots three function graphs on the same plane, where “f(x)”, “g(x)” and “h(x)” are expressions of three distinct functions. Options of “itv=(a, b)” or “pt=[(x₁, y₁), (x₂, y₂), (x₃, y₃), . . . ]” can be added to the end for interested intervals or points for the graphs.

II. Plane Curves for Parametric and Implicit Equations

The operation “pc2” produces a graph of two parametric equations x=x(t) and y=y(t), and “imf” produces a graph of an implicit equation f(x, y)=0. Thus, the expression “pc2; x(t); y(t)” plots the 2D curve for the parametric equations x=x(t) and y=y(t).

One can add a specific interval “itv=(a, b)” to the end of the expression, where “itv” is the keyword for interval, and “(a, b)” is the interval [a, b] of “t”. So the expression becomes “pc2; x(t); y(t); itv=(a, b)”.

In a similar fashion, one can add particular points and lines of interests to the 2D curves. For one point, the expression becomes “pc2; x(t); y(t); pt=(x₀, y₀)”, and for two or more points, it is “pc2; x(t); y(t); pt=[(x₀, y₀), (x₁, y₁) . . . ]”.

To add one line, the expression is “pc2; x(t); y(t); ln=[(x₀, y₀), (x₁, y₁)]”. To add two or more lines, it becomes “pc2; x(t); y(t); ln=[(x₀, y₀), (x₁, y₁)]; ln=[(x₂, y₂), (x₃, y₃)]; . . . ”.

The expression “imf; f(x, y)” helps graph the implicit equation f(x, y)=0, where “y” is implicitly defined as a function of “x”, and “f(x, y)” is the implicit equation. To change the default interval, one can add “x₁; x₂” for the interval of “x” and “y₁; y₂” for “y” to the end, making the expression as “imf; f(x, y); x₁; x₂; y₁; y₂”.

Replacing the operation “imf” by “cnt”, one can obtain the contour curves for the implicit expression “f(x, y)”.

III. Graphs of Polar Functions

The operation “pol” is designed to plot graphs of explicit polar functions, so the expression “pol; f(x); g(x); h(x)” plots the curves of three polar functions, where “f(x); g(x); h(x)” are the expressions of three distinct polar functions, and “x” is the independent variable representing angles measured by radians. To change the default interval of “x” to [a, b], one can add “itv=(a, b)” to the end, making the expression as “pol; f(x); g(x); h(x); itv=(a, b)”.

IV. Vectors and Vector Fields

The operation “vc2” helps plot position vectors, and the expression “vc2; vt=(x,y)” plots a vector at standard position, where “vt” is the keyword, and “(x, y)” are the endpoints coordinates of the vector (position vector starts from the origin). The expression “vc2; vt=[(x₀, y₀), x₁, y₁)]” plots a vector <x₁, x₀, y₁, y₀>, and “vc2;vt=[(x₀, y₀), (x₁, y₁)], vt=[(x₂, y₂), (x₃, y₃)], . . . ” plots two or more vectors.

The operation “vf2” helps plot a vector field on the plane, and the expression “vf2; xcom; ycom” plots a field of (xcomp, ycomp), where “xcomp” and “ycomp” are component functions, and they can be functions of at most two variables.

V. Space Curves for Parametric Equations

The operation “pc3” is designed to graph a 3D curve for the three parametric equations x=x(t), y=y(t), and z=z(t), so the expression “pc3; x(t); y(t); z(t)” plots the curve for x=x(t), y=y(t) and z=z(t), where “x(t); y(t); z(t)” are the expression of each coordinate function. One can use “pc3; x(t); y(t); z(t); a; b” to change the default interval to [a, b] for parameter “t”.

VI. Space Surfaces for Functions and Parametric Equations

The operation “ps3” is designed to graph space surfaces parametrized by the three coordinate functions x=x(u, v), y=y(u, v) and z=z(u, v) with parameters u and v.

Thus, the expression “ps3; x(u, v); y(u, v); z(u, v)” plots surfaces for the parametric equations x=x(u, v), y=y(u, v) and z=z(u, v), where “x(u, v); y(u, v); z(u, v)” are the expression for each coordinate function, and “u; v” are two distinct parameters. To change the default intervals of parameters u and v, one needs to add “a; b” for the interval [a, b] of u, and “c; d” for the interval [c, d] of v to the end.

The operation “sf3” is designed to graph the surface of an explicit function z=f(x, y), so one can use “sf3; f(x, y)” to graph the surface of f(x, y). To change the default intervals for the two variables “x” and “y”, one can use “sf3; f(x, y); x₁; x₂; y₁; y₂”, where “x₁; x₂” represents interval [x₁, x₂] of “x”, and “y₁; y₂” for the interval [y₁, y₂] of “y”.

What is claimed is:

1. A non-programming user interface consisting of modules for computing and graphing user input expressions, and each module carrying out a class of distinct math operations, which include (1) solving equations, inequalities, and systems of equations; simplifying, expanding, factoring and comparing expressions; (2) finding limits of functions and verifying derivative formulas, limit definition and properties; (3) computing derivatives, partial derivatives, gradient vectors, intervals for monotonicity and concavity, critical and inflection points, implicit differentiation and related rates, directional derivatives, derivatives for composites of scalar and vector functions, and Hessian determinant for the second derivative test; (4) evaluating indefinite and definite integrals, numerical integration, Jacobian determinant, line and surface integrals; (5) finding finite and infinite sums, determining whether a series converges and convergence intervals, finding Taylor series, and approximating functions by Taylor polynomials; (6) computing and simplifying vector algebra, projection, and vector-valued function calculus such as derivatives, integrals, tangent and normal vectors, curl and divergence of vector fields; (7) solving ordinary differential equations, partial differential equations, and systems of ordinary equation systems; (8) graphing points, lines, and polygons, functions, polar functions, vectors and vector fields, implicit equations, and parametric equations for both two- and three-dimensional curves and space surfaces; wherein applying each module for its associated operations requires one short line of self-explaining input that consists of necessary elements such as module names (three characters, e.g., “lim”, “dif”, “int”, “vec”), expressions of functions and equations, variables, choices of values, and optional keywords (two characters) and related values; wherein applying each module for graphing requires a line of input to have: module names (three characters) indicating whether the graph is two- or three-dimensional and whether is for functions or equations; expressions for functions, implicit or parametric equations; optional keywords and related values for intervals; wherein users can access and interact with these modules in many different ways: (I) using a typical standalone personal computer (workstation or server) that has these modules installed, and has Windows 10, Unix or Linux, or Mac OS with an Intel or other similar processor of 2.50 GHz frequency (or greater) and 64 bit 4 GB (or greater) RAM access: (II) through an online web application (already created) with a computer, cell phone, smart phone, tablet or ipad, or other similar devices that have an access to the Internet.

2. The interface for claim 1 wherein each non-graphing module of those from (1) to (7), which are designed exclusively for computing user input expressions and will not produce any graph, can be applied in the following formats, depending on the needs and appropriateness of combining and composing different modules and math functions: (A) standalone; (B) linear combination; (C) combining with other modules and math functions (e.g., sine, logarithms, and exponentials); (D) composing with other modules and math functions, (E) combining and composing with other modules and math functions; wherein format (E), while not comprehensive, involves the following most commonly used operations: verifying properties by composing differentiation and integration modules; verifying fundamental theorems of calculus by composing differentiation and integration modules; determining improper integrals by limit and integration operations; determining critical points by solving equations related to first derivatives; determining extreme values by combining critical points and derivative tests operations; differentiating functions defined by integrals; differentiating and integrating infinite series; finding normal and binormal vectors; decomposing vectors (e.g., acceleration); computing curvatures using derivatives and vector operations; verifying properties of curl, divergences and Laplace operators.
